(19) United States
(12) Patent Application Publication
(10) Pub. No.: US 2026/0315851 A1
(43) Pub. Date: Oct. 15, 2026

(54) LONG-TERM FIRE RETARDANT CONCENTRATE AND METHODS OF USING THE SAME

(71) Applicant: Coulson Aviation (USA) Inc, Portland, OR (US)

(72) Inventors: Michael WHITE, Roseville, CA (US); Britton COULSON, Port Alberni (CA)

(21) Appl. No.: 19/643,180

(22) Filed: Apr. 9, 2026

Related U.S. Application Data
(60) Provisional application No. 63/789,028, filed on Apr. 15, 2025.

(51) Int. Cl. A62D 1/00

(52) U.S. Cl. CPC A62D 1/0035

(57) ABSTRACT

A fire retardant concentrate comprising a plurality of ammonium phosphates, a thickener, a corrosion inhibitor, a pigment, and a flow agent. Additionally, a fire retardant comprising a plurality of ammonium phosphates having a weight percent ranging from more than 82% to about 95%, a thickener having a weight percent ranging from more than 0.5% to less than 15%, a corrosion inhibitor having a weight percent ranging from more than 0.4% to about 2.0%, a pigment having a weight percent ranging from more than 0.5% to about 3.5%, and a flow agent having a weight percent ranging from more than 0.5% to about 3.0%, the weight percentages being measured relative to the total dry weight of the concentrate.

### CROSS-REFERENCE TO RELATED APPLICATION(S)

This application claims priority to U.S. Provisional Patent App. No. 63/789,028, filed Apr. 15, 2025, which is incorporated by reference herein in its entirety.

### FIELD

This disclosure generally relates to fire retardants for, e.g., controlling forest fires. More specifically, some embodiments relate to long-term fire retardant (LTFR) concentrates and ready-to-use (RTU) fire retardants that can be derived therefrom.

### BACKGROUND

When combatting forest fires, it can be beneficial to tailor the properties of a ready-to-use fire retardant based on, e.g., the intensity of the fire, the size of the fire, and the wind conditions.

### SUMMARY

Some embodiments described herein are directed to a long-term fire retardant concentrate comprising a plurality of ammonium phosphates, a thickener, a corrosion inhibitor, a pigment, and a flow agent.

Some embodiments described herein are directed to a long-term fire retardant concentrate comprising a plurality of ammonium phosphates, present in the concentrate in an amount having a weight percent ranging from more than 87% to less than 93% relative to a total dry weight of the concentrate, a thickener, present in the concentrate in an amount having a weight percent ranging from more than 2% to less than 7% relative to the total dry weight of the concentrate, a corrosion inhibitor, present in the concentrate in an amount having a weight percent ranging from more than 0.5% to less than 1.8% relative to the total dry weight of the concentrate, a pigment, present in the concentrate in an amount having a weight percent ranging from more than 1.5% to less than 3.2% relative to the total dry weight of the concentrate, and a flow agent, present in the concentrate in an amount having a weight percent ranging from more than 1.6% to less than 2.5% relative to the total dry weight of the concentrate.

Some embodiments described herein are directed to a long-term fire retardant concentrate comprising a plurality of ammonium phosphates, present in the concentrate in an amount having a weight percent of approximately 91.60% relative to a total dry weight of the concentrate, a thickener, present in the concentrate in an amount having a weight percent of approximately 2.95% relative to the total dry weight of the concentrate, a corrosion inhibitor, present in the concentrate in an amount having a weight percent of approximately 1.51% relative to the total dry weight of the concentrate, a pigment, present in the concentrate in an amount having a weight percent of approximately 1.76% relative to the total dry weight of the concentrate, and a flow agent, present in the concentrate in an amount having a weight percent of approximately 2.18% relative to the total dry weight of the concentrate.

Some embodiments described herein are directed to a method of using the long-term fire retardant concentrate to obtain a plurality of ready-to-use fire retardants that are compliant with a governing agency's currently-required properties for fire retardants.

Some embodiments described herein are directed to a method of producing a RTU fire retardant, the method comprising mixing a LTFR concentrate, according to some embodiments of the present disclosure, with water at a first mix ratio, a second mix ratio, or a third mix ratio to produce the RTU fire retardant, wherein each of the first, second, and third mix ratios are defined by an amount of concentrate, in pounds, per gallon of water, wherein the RTU fire retardant comprises: a viscosity ranging from 150 cP to less than 400 cP when the concentrate is mixed at the first mix ratio, a viscosity ranging from 400 cP to less than 800 cP when the concentrate is mixed at the second mix ratio, and a viscosity ranging from 800 cP to less than 1500 cP when the concentrate is mixed at the third mix ratio.

Some embodiments described herein are directed to a method of producing a RTU fire retardant, wherein the RTU fire retardant comprises: a plurality of ammonium phosphates in an amount having a weight percentage ranging from 9.3% to 10% relative to a total weight of the RTU fire retardant when a concentrate is mixed at a first mix ratio; a plurality of ammonium phosphates in an amount having a weight percentage ranging from 11% to 11.6% relative to the total weight of the RTU fire retardant when a concentrate is mixed at a second mix ratio; and a plurality of ammonium phosphates in an amount having a weight percentage ranging from 11.5% to 17.1% relative to the total weight of the RTU fire retardant when a concentrate is mixed at a third mix ratio.

Some embodiments described herein are directed to a method of producing a RTU fire retardant, wherein the RTU fire retardant comprises: a thickener in an amount having a weight percentage ranging from 0.3% to 0.8% relative to the total weight of the RTU fire retardant when a concentrate is mixed at a first mix ratio; a thickener in an amount having a weight percentage ranging from 0.3% to 0.9% relative to the total weight of the RTU fire retardant when a concentrate is mixed at a second mix ratio; and a thickener in an amount having a weight percentage ranging from 0.3% to 1.1% relative to the total weight of the RTU fire retardant when a concentrate is mixed at a third mix ratio.

Some embodiments described herein are directed to a method of producing a RTU fire retardant, wherein the RTU fire retardant comprises: a corrosion inhibitor in an amount having a weight percentage ranging from 0.07% to 0.15% relative to the total weight of the RTU fire retardant when a concentrate is mixed at a first mix ratio; a corrosion inhibitor in an amount having a weight percentage ranging from 0.08% to 0.19% relative to the total weight of the RTU fire retardant when a concentrate is mixed at a second mix ratio; and a corrosion inhibitor in an amount having a weight percentage ranging from 0.08% to 0.23% relative to the total weight of the RTU fire retardant when a concentrate is mixed at a third mix ratio.

Some embodiments described herein are directed to a method of producing a RTU fire retardant, wherein the RTU fire retardant comprises: a pigment in an amount having a weight percentage ranging from 0.18% to 0.33% relative to the total weight of the RTU fire retardant when a concentrate is mixed at a first mix ratio; a pigment in an amount having a weight percentage ranging from 0.22% to 0.38% relative to the total weight of the RTU fire retardant when a concentrate is mixed at a second mix ratio; and a pigment in an amount having a weight percentage ranging from 0.27% to 0.47% relative to the total weight of the RTU fire retardant when a concentrate is mixed at a third mix ratio.

Some embodiments described herein are directed to a method of producing a RTU fire retardant, wherein the RTU fire retardant comprises: a flow agent in an amount having a weight percentage ranging from 0.20% to 0.22% relative to the total weight of the RTU fire retardant when a concentrate is mixed at a first mix ratio; a flow agent in an amount having a weight percentage ranging from 0.22% to 0.27% relative to the total weight of the RTU fire retardant when a concentrate is mixed at a second mix ratio; and a flow agent in an amount having a weight percentage ranging from 0.23% to 0.24% relative to the total weight of the RTU fire retardant when a concentrate is mixed at a third mix ratio.

Some embodiments described herein are directed to a method of producing a RTU fire retardant, wherein a first mix ratio ranges from 0.95 to 1.06 pounds of concentrate per gallon of water, wherein a second mix ratio ranges from 1.15 to 1.20 pounds of concentrate per gallon of water, and wherein a third mix ratio ranges from 1.20 to 1.90 pounds of concentrate per gallon of water.

Some embodiments described herein are directed to a method of producing a first RTU fire retardant and a second RTU fire retardant, the method comprising: mixing a first predetermined amount of a concentrate, according to some embodiments of the present disclosure, with a first predetermined amount of water to produce the first RTU fire retardant, wherein a ratio of the first predetermined amount of concentrate to the first predetermined amount of water ranges from 0.9 to 1.1 pounds of concentrate per gallon of water, wherein the first RTU fire retardant comprises a first viscosity, and mixing a second predetermined amount of a concentrate, according to some embodiments of the present disclosure, with a second predetermined amount of water to produce the second RTU fire retardant, wherein a ratio of the second predetermined amount of concentrate to the second predetermined amount of water ranges from 1.2 to 1.9 pounds of concentrate per gallon of water, wherein the second RTU fire retardant comprises a second viscosity.

Some embodiments described herein are directed to a method of producing a first RTU fire retardant and a second RTU fire retardant, wherein a first viscosity is lower than a second viscosity.

Some embodiments described herein are directed to a method of producing a RTU fire retardant, the method comprising: determining, based on a parameter, a target viscosity for the RTU fire retardant; correlating the target viscosity with a target mix ratio for a LTFR concentrate; mixing the LTFR concentrate with water at the target mix ratio to obtain the RTU fire retardant; and verifying that a viscosity of the RTU fire retardant is approximately the target viscosity.

Some embodiments described herein are directed to a method of producing a RTU fire retardant, the method comprising: determining, based on a parameter, a target viscosity for the RTU fire retardant; correlating the target viscosity with a target mix ratio for a LTFR concentrate, according to some embodiments of the present disclosure; mixing the LTFR concentrate with water at the target mix ratio to obtain the RTU fire retardant; and verifying that a viscosity of the RTU fire retardant is approximately the target viscosity.

Some embodiments described herein are directed to a method of producing a RTU fire retardant wherein: a parameter includes one or more of a fire parameter, a weather parameter, an aircraft parameter, a drop pattern parameter, and a local environment parameter; the fire parameter includes one or more of an intensity, a direction of spread, a growth rate, and a size of the fire; the weather parameter includes one or more of a wind direction, a wind speed, a precipitation, a humidity, a fire weather index, a cloud coverage, a dew point, and an ambient temperature at a site of the fire; the aircraft parameter includes one or more of an aircraft type, an altitude, and an aircraft speed that the RTU fire retardant is to be applied from; the drop pattern parameter includes one or more of a desired amount and a desired coverage level of the RTU fire retardant; and the local environment parameter includes one or more of terrain, brush, and foliage data.

Some embodiments described herein are directed to a long-term fire retardant concentrate comprising a plurality of fire retardant salts, a thickener, a pigment, and a flow agent.

In some embodiments, the present disclosure is directed to a method of producing a ready-to-use (RTU) fire retardant, the method comprising:
determining, based on a parameter, a target property for the RTU fire retardant;
correlating the target property with a target mix ratio for a long term fire retardant (LTFR) concentrate;
mixing the LTFR concentrate with water at the target mix ratio to obtain the RTU fire retardant.

In some embodiments, the method further comprises verifying that the property of the RTU fire retardant is approximately the target property.

In some embodiments, the target property is selected from the group consisting of viscosity, density, refractive index, pH value, color, storage stability, combustion-retarding effectiveness, salt content, corrosion rate, pumpability, abrasiveness, and combinations thereof.

In some embodiments, the target property is selected from the group consisting of viscosity, density, refractive index, pH value, color, combustion-retarding effectiveness, salt content, corrosion rate, surface tension, and combinations thereof.

In some embodiments, the LTFR concentrate comprises:
one or more ammonium phosphates, present in the concentrate in an amount having a weight percent ranging from about 82% to about 95% relative to a total dry weight of the concentrate;
a thickener, present in the concentrate in an amount having a weight percent ranging from about 0.5% to about 15% relative to the total dry weight of the concentrate;
a corrosion inhibitor, present in the concentrate in an amount having a weight percent ranging from about 0.05% to about 5.0% relative to the total dry weight of the concentrate; and
a pigment, present in the concentrate in an amount having a weight percent ranging from about 0.5% to about 3.5% relative to the total dry weight of the concentrate.

In some embodiments, the LTFR concentrate comprises:
one or more ammonium phosphates, present in the concentrate in an amount having a weight percent ranging from about 65% to about 80% relative to a total dry weight of the concentrate;
a thickener, present in the concentrate in an amount having a weight percent ranging from about 0.25% to about 25% relative to the total dry weight of the concentrate;
a corrosion inhibitor, present in the concentrate in an amount having a weight percent ranging from about 0.05% to about 5.0% relative to the total dry weight of the concentrate; and
a pigment, present in the concentrate in an amount having a weight percent ranging from about 0.5% to about 3.5% relative to the total dry weight of the concentrate.

In some embodiments, the LTFR concentrate comprises:
one or more fire retardant salts, present in the concentrate in an amount having a weight percent ranging from about 85% to about 98% relative to a total dry weight of the concentrate;
a thickener, present in the concentrate in an amount having a weight percent ranging from about 0.05% to about 5% relative to the total dry weight of the concentrate;
a corrosion inhibitor, present in the concentrate in an amount having a weight percent ranging from about 0.01% to about 5% relative to the total dry weight of the concentrate; and
a pigment, present in the concentrate in an amount having a weight percent ranging from about 0.5% to about 5.0% relative to the total dry weight of the concentrate.

In some embodiments, the present disclosure is directed to a method of producing a ready-to-use (RTU) fire retardant, the method comprising:
determining, based on a parameter, a target property for the RTU fire retardant; and
adding an additional material to a first RTU fire retardant to prepare the RTU fire retardant;
wherein adding the additional material changes one or more properties of the first RTU fire retardant.

In some embodiments, the parameter comprises a fire parameter, a weather parameter, an aircraft parameter, a drop pattern parameter, a local environment parameter, a human feedback parameter, or combinations thereof;
the fire parameter comprises an intensity, a direction of spread, a growth rate, a size of the fire, or combinations thereof;
the weather parameter comprises a wind direction, a wind speed, a precipitation, a humidity, a fire weather index, a cloud coverage, a dew point, an ambient temperature at a site of the fire, a forecast, or combinations thereof;
the aircraft parameter comprises an aircraft type, an altitude, an aircraft speed that the RTU fire retardant is to be applied from, or combinations thereof;
the drop pattern parameter comprises a desired amount of the RTU fire retardant, a desired coverage level of the RTU fire retardant, or combinations thereof;
the local environment parameter comprises fuel moisture content, terrain, brush, foliage data, and combinations thereof; and
the human feedback parameter comprises feedback from an air attack, feedback from an incident command, feedback from observers, feedback from a pilot, feedback from a computer program or an algorithm, feedback from a radio operator, or combinations thereof.

In some embodiments, the present disclosure is directed to a method of producing a RTU fire retardant, the method comprising:
mixing a LTFR concentrate with water at a first mix ratio, a second mix ratio, or a third mix ratio to produce the RTU fire retardant, wherein each of the first, second, and third mix ratios are defined by an amount of concentrate, in pounds, per gallon of water,
wherein the RTU fire retardant comprises:
a viscosity ranging from 150 cP to less than 400 cP when the concentrate is mixed at the first mix ratio,
a viscosity ranging from 400 cP to less than 800 cP when the concentrate is mixed at the second mix ratio, and
a viscosity ranging from 800 cP to less than 1500 cP when the concentrate is mixed at the third mix ratio.

In some embodiments, the present disclosure is directed to a method of producing a first RTU fire retardant and a second RTU fire retardant, the method comprising:
mixing a first predetermined amount of an LTFR concentrate with a first predetermined amount of water at a first mix ratio to produce the first RTU fire retardant, wherein the first RTU fire retardant comprises a first property, and
mixing a second predetermined amount of the LTFR concentrate with a second predetermined amount of water at a second mix ratio to produce the second RTU fire retardant, wherein the second RTU fire retardant comprises a second property.

### BRIEF DESCRIPTION OF THE DRAWINGS

Embodiments of the present disclosure will be described in more detail with reference to the following Figure(s). Together with the description, the Figure(s) further serve to explain the principles of and to enable a person skilled in the relevant art(s) to make and use the disclosed embodiments. These Figure(s) are intended to be illustrative, not limiting. Although the disclosure is generally described in the context of these embodiments, it should be understood that it is not intended to limit the scope of the disclosure to these particular embodiments. In the Figure(s), like reference numbers indicate identical or functionally similar features.

FIG. 1 is a flowchart of a method of using a long-term fire retardant concentrate to obtain a plurality of ready-to-use fire retardants, according to embodiments disclosed herein.

FIG. 2 is a flowchart of a method of using a long-term fire retardant concentrate to obtain a plurality of ready-to-use fire retardants, according to embodiments disclosed herein.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, can be practiced without these specific details. The description and representation herein comport with standards used by those experienced or skilled in the art to most effectively convey the substance of their work to others skilled in the art. In some instances, well-known methods, procedures, components, and elements have not been described in detail to avoid unnecessarily obscuring aspects of the disclosure.

References in the specification to “one embodiment,” “an embodiment,” “an example embodiment,” “some embodiments,” etc., indicate that the embodiment described can include a particular feature, structure, or characteristic, but every embodiment may not necessarily include the particular feature, structure, or characteristic. Moreover, such phrases are not necessarily referring to the same embodiment. Further, this disclosure has been prepared such that when a particular feature, structure, or characteristic is described in connection with an embodiment, it is within the knowledge of one skilled in the art to apply such feature, structure, or characteristic in connection with other embodiments whether or not explicitly described.

The term “plurality” as used herein refers to one or more of a listed item, compound, ingredient, salt, solvent, fire retardant, fire retardant concentrate, etc. The term “plurality” can be used interchangeably with the phrases “one or more” and “at least one.”

The terms “RTU retardant(s),” “RTU,” and “RTU fire retardant(s)” as used herein are used interchangeably throughout the disclosure and each refer to ready-to-use fire retardant(s). The term “LTFR” as used herein refers to a long term fire retardant. In some embodiments, an “RTU fire retardant” as disclosed herein can comprise an LTFR, and vice versa. In some embodiments, the terms “RTU fire retardant” and “LTFR” can be used interchangeably.

The terms “LTFR concentrate(s)” and “concentrate” as used herein are used interchangeably throughout the disclosure and each refer to long term fire retardant concentrate(s). The LTFR concentrates as disclosed herein can be solid, or dry, concentrates (e.g., in powder form) or liquid concentrates. In some embodiments, the LTFR concentrates as disclosed herein can be converted to an RTU fire retardant and/or an LTFR, for example, by adding water to the LTFR concentrate. In some embodiments, an LTFR liquid concentrate can be prepared by adding water to an LTFR solid, or dry, concentrate (e.g., a powder concentrate). In some embodiments, an RTU fire retardant can be prepared by adding water to an LTFR liquid concentrate.

The term “dry weight of the concentrate”, and similar terms, as used herein refers to the weight of a concentrate after all water has been removed, or the weight of a concentrate without factoring in the weight of any water present in the concentrate. Thus, a liquid concentrate, for example, will have a weight, which includes the weight of the water present in the concentrate, and a dry weight, which does not include the weight of any water present in the concentrate. As another example, the weight of a liquid concentrate would be higher than the dry weight of the same liquid concentrate. In some aspects, the dry weight of the concentrate corresponds to the weight of the concentrate as a dry solid, e.g. a powder. In some aspects, the weight of a powder concentrate is the same as the dry weight of the powder concentrate.

The term “ammoniacal,” as used herein, when placed in front of nitrogen (i.e., “ammoniacal nitrogen”), and when referring to the nitrogen to phosphorus molar ratio (N/P), specifies that the amount of nitrogen used to determine the N/P ratio is only that nitrogen present in the ammonium phosphate. Thus, if other nitrogen is present in the LTFR concentrate or RTU fire retardant from other sources, this other nitrogen would not be considered when calculating the N/P ratio.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Where a range of numerical values comprising upper and lower values is recited herein, unless otherwise stated in specific circumstances, the range is intended to include the endpoints thereof, and all integers and fractions within the range.

The term “approximately” as used herein indicates the value of a given quantity that can vary based on a particular technology. Based on the particular technology, the term “approximately” can indicate a value of a given quantity that varies therein, for example, 1-15% of the value (e.g., ±1%, ±2%, ±5%, ±10%, ±15% of the value).

The ability to effectively and efficiently control the spread of a fire, e.g., a forest fire, is crucial to protecting the lives and property in the fire's path. One solution for controlling the spread of a forest fire is the aerial or ground-based application of a ready-to-use (“RTU”) fire retardant, which contains retardant salts that decrease the fire's intensity and slow its advance, even in the absence of water.

Typically, in order for an RTU fire retardant to be aerially applied, the RTU fire retardant must be approved by a governing agency—such as the United States Forest Service (“USFS”). The governing agency generally requires (among other things) that an RTU fire retardant be provided to an airbase in its liquid or powdered concentrate form (e.g., as an LTFR concentrate)—where it is then mixed with water at a specified mix ratio to obtain a ready-to-use (“RTU”) retardant having properties (e.g., viscosity, density, refractive index, pH value, color, storage stability, combustion-retarding effectiveness, salt content, corrosion rate, pumpability, abrasiveness, surface tension, or combinations thereof) that comply with the agency's requirements. The RTU retardant is then aerially applied (e.g., by fixed wing and/or rotary aircraft) to forest fires.

Present LTFR concentrates, however, suffer from a variety of deficiencies. For example, present LTFR concentrates are incapable of being diluted at more than one mix ratio to obtain a plurality of RTU retardants having differing viscosities or other properties. In part, this is because varying a present LTFR concentrate's mix ratio causes the resulting RTU retardant to have non-compliant properties.

The inability to produce a plurality of RTU retardants having differing physical or chemical properties, such as viscosities, from a single LTFR concentrate is detrimental to combatting the spread of fires—as different firefighting scenarios can call for the use of retardants of different viscosities. A grassland fire on a nearly-windless day, for example, is more effectively combatted with a RTU retardant having a lower viscosity than that used to combat, e.g., a fire in a tree line on a windy day. Accordingly, if a LTFR concentrate is only capable of producing a high-viscosity RTU retardant, the grassland fire cannot be controlled in the most effective manner with that particular LTFR concentrate. Notably, some governing agencies do not allow a particular airbase to have more than one LTFR concentrate on site—meaning that fire fighters cannot simply mix a plurality of LTFR concentrates to produce a plurality of RTU retardants having differing viscosities. Even if it were permitted, attempting to mix a plurality of LTFR concentrates to produce a plurality of RTU retardants would impose a logistical problem, given the amount of materials and mixing equipment that would be required.

It is therefore a goal of the present disclosure to provide a solution to the above-described issues.

### Methods for Preparing LTFR Concentrates and RTU Fire Retardants

Some embodiments of the present disclosure provide a LTFR concentrate that can be diluted at a plurality of mix ratios to obtain a plurality of RTU retardants having differing viscosities or other properties that are compliant with a governing agency's currently-required properties. In some embodiments, the LTFR concentrate can be diluted at a plurality of mix ratios to obtain a plurality of RTU retardants having differing viscosities or other properties that are adapted to different parameters, such as, for example, a fire parameter, a weather parameter, an aircraft parameter, a drop pattern parameter, and a local environment parameter as disclosed herein. Such embodiments include, for example, a plurality of ammonium phosphates, a thickener, a corrosion inhibitor, a pigment, and a flow agent. Some additional embodiments include, for example, one or more ammonium phosphates, a thickener, a corrosion inhibitor, a pigment, and a flow agent. Some additional embodiments include, for example, one or more ammonium phosphates, a thickener, and a pigment.

Some embodiments of the present disclosure provide a LTFR concentrate that can be diluted using a plurality of mass dilution factors (MDF) to obtain a plurality of RTU retardants having differing viscosities or other properties that are compliant with a governing agency's currently-required properties. In some embodiments, the LTFR concentrate that can be diluted using a plurality of mass dilution factors to obtain a plurality of RTU retardants having differing viscosities or other properties that are adapted to different parameters, such as, for example, a fire parameter, a weather parameter, an aircraft parameter, a drop pattern parameter, and a local environment parameter as disclosed herein. In some embodiments, the LTFR concentrate and/or the RTU retardant include, for example, a plurality of ammonium phosphates, a thickener, a corrosion inhibitor, a pigment, and a flow agent. In some embodiments, the LTFR concentrate and/or the RTU retardant include, for example, one or more ammonium phosphates, a thickener, a corrosion inhibitor, a pigment, and a flow agent. In some embodiments, the LTFR concentrate and/or the RTU retardant include, for example, one or more ammonium phosphates, a thickener, and a pigment.

Another embodiment of the present disclosure provides a LTFR concentrate that can be diluted to a RTU retardant, wherein the properties can be varied by the addition of at least one additional material. In some embodiments, this material can then dissolve or activate, and change the properties of the retardant in a way that improves the performance of the retardant for the conditions. In some embodiments, this addition can be to add more of a component already present within the LTFR concentrate, or to add a material that is not currently in the retardant. In some embodiments, the presence of this material can require mixing for a certain amount of time after addition, or it can activate rapidly after addition so that the LTFR concentrate or the RTU retardant has the new property prior to the retardant being loaded onto the aircraft, potentially in an in-line manner. In some embodiments, the addition of at least one additional material can provide a plurality of RTU retardants having differing viscosities or other properties that are adapted to different parameters, such as, for example, a fire parameter, a weather parameter, an aircraft parameter, a drop pattern parameter, and a local environment parameter as disclosed herein. In some embodiments, the additional material can be added to a LTFR concentrate. In some embodiments, the additional material can be added to a LTFR concentrate, and then water can be added to the LTFR concentrate to prepare an RTU fire retardant. In some embodiments, the additional material can be added to an RTU fire retardant.

In some embodiments, this added material can be a thickener, which can modify the viscosity of the retardant, which can also change the deposition of the materials or the way that the RTU retardant falls out of the aircraft and deposits on the ground. In some embodiments, the thickener is selected from erythritol, xylitol, propylene glycol, silica, aluminosilicates, ethylene glycol, propylene glycol, glycerol, glycol ethers, lecithin, colloidal oatmeal, stevia, neem powder, moringa leaf powder, chicory leaf powder, xanthan gum, cellulose, guar gum, hydroxypropyl guar gum, bentonite clay, attapulgite clay, or combinations thereof. In some embodiments, the added material can be a surfactant material that can change the surface tension of the retardant to better wet the fuel. In some embodiments, the surfactant is selected from anionic, cationic, or neutral molecules such as sodium lauryl sulfate, alkylbenzene sulfonates, alcohol ethoxylates, alkyl polyglycosides, sorbitan esters, quaternary ammonium compounds, cocamidopropyl betaine, cocamidopropyl hydroxysultaine, silicone oils, silicone polymers, sodium stearate, ethylene glycol, propylene glycol, glycerol, glycol ethers, or combinations thereof. In some embodiments, the added material can be a salt or organic material that can adjust the density of the retardant, which can change the deposition of the materials or the way that RTU retardant falls out of the aircraft and deposits on the ground. In some embodiments, the salt or organic material is selected from erythritol, xylitol, propylene glycol, sucrose, glucose, fructose, dextrose, sodium chloride, magnesium chloride, magnesium sulfate, sodium sulfate, sodium phosphates, urea, silica, aluminosilicates, sodium hydroxide, hydrochloric acid, ethylene glycol, propylene glycol, glycerol, glycol ethers, ethanol, methanol, or combinations thereof. In some embodiments, the added material can be a fire-retardant salt, which can change the refractive index of the retardant, and can improve the fire-retarding properties of the retardant. In some embodiments, the fire-retardant salt is selected from sodium chloride, magnesium chloride, magnesium sulfate, sodium sulfate, sodium phosphates, potassium carbonate, potassium bicarbonate, sodium bicarbonate, sodium carbonate, potassium citrate, ammonium phosphate, ammonium polyphosphate, or combinations thereof. In some embodiments, the added material can be water or another liquid to change the concentration of the components, which can change the corrosion rate, coverage on the ground, or deposition of the retardant. In some embodiments, the added material can be a pigment, dye, or fluorophore, which can change the color of the retardant, which can improve or change the ability to visualize the retardant after deposition on the ground. In some embodiments, the added material can be a phosphor, which can enable the visualization of the retardant with night vision goggles or other sensors. In some embodiments, the added material can be a corrosion inhibitor to change the corrosion performance of the RTU retardant.

In some embodiments, the retardant can be monitored after addition of the material to determine the changes in properties of the retardant to ensure that it has been incorporated into the retardant. In some embodiments, this can be performed by measuring the viscosity, density, refractive index, pH value, color, storage stability, combustion-retarding effectiveness, salt content, corrosion rate, pumpability, abrasiveness, surface tension, combinations thereof, or other property of interest to determine the new performance characteristic of the RTU retardant.

In some embodiments, the ratio of RTU retardant to additive can be controlled by the flow rate of the RTU retardant, the addition speed of the new additive, a combination of these parameters, or by another method that is understood by a person skilled in the art. In some embodiments, this can be accomplished by a metering pump adding a liquid component to the RTU retardant as it is being pumped onto an aircraft. In some embodiments, this can be accomplished by using the Venturi effect to draw a solid material through a small orifice to incorporate a solid material into the liquid stream. In some embodiments, this liquid can be then pumped directly onto the aircraft, or recirculated for a set amount of time to incorporate the additive fully. In some embodiments, this can be accomplished by dissolving or suspending the additive in a minimal volume of liquid to make a concentrate, then adding this concentrate using the Venturi effect or a metering pump to the RTU retardant to form a modified fire retardant.

Some embodiments of the present disclosure provide a method of mixing the LTFR concentrate to obtain a plurality of RTU retardants having differing viscosities that are compliant with the governing agency's currently-required properties. In some of such embodiments, the method includes determining, based on a parameter, a target viscosity for a RTU retardant, correlating the target viscosity with a target mix ratio, mixing a LTFR concentrate with water at the target mix ratio to obtain the RTU retardant. In some embodiments, the method further comprises verifying that a viscosity of the RTU retardant is approximately the target viscosity.

Some embodiments of the present disclosure provide a method of mixing the LTFR concentrate to obtain a plurality of RTU retardants having differing densities that are compliant with the governing agency's currently-required properties. In some of such embodiments, the method includes determining, based on a parameter, a target density for a RTU retardant, correlating the target density with a target mix ratio, mixing a LTFR concentrate with water at the target mix ratio to obtain the RTU retardant. In some embodiments, the method further comprises verifying that a density of the RTU retardant is approximately the target density.

Some embodiments of the present disclosure provide a method of mixing the LTFR concentrate to obtain a plurality of RTU retardants having differing refractive indices that are compliant with the governing agency's currently-required properties. In some of such embodiments, the method includes determining, based on a parameter, a target refractive index for a RTU retardant, correlating the target refractive index with a target mix ratio, mixing a LTFR concentrate with water at the target mix ratio to obtain the RTU retardant. In some embodiments, the method further comprises verifying that a refractive index of the RTU retardant is approximately the target refractive index.

Some embodiments of the present disclosure provide a method of mixing the LTFR concentrate to obtain a plurality of RTU retardants having differing pH values that are compliant with the governing agency's currently-required properties. In some of such embodiments, the method includes determining, based on a parameter, a target pH value for a RTU retardant, correlating the target pH value with a target mix ratio, mixing a LTFR concentrate with water at the target mix ratio to obtain the RTU retardant. In some embodiments, the method further comprises verifying that a pH value of the RTU retardant is approximately the target pH value.

Some embodiments of the present disclosure provide a method of mixing the LTFR concentrate to obtain a plurality of RTU retardants having differing colors that are compliant with the governing agency's currently-required properties. In some of such embodiments, the method includes determining, based on a parameter, a target color for a RTU retardant, correlating the target color with a target mix ratio, mixing a LTFR concentrate with water at the target mix ratio to obtain the RTU retardant. In some embodiments, the method further comprises verifying that a color of the RTU retardant is approximately the target color. Some embodiments of the present disclosure provide a method of mixing the LTFR concentrate to obtain a plurality of RTU retardants having differing properties that are compliant with the governing agency's currently-required properties. In some of such embodiments, the method includes determining, based on a parameter, a target property for a RTU retardant, correlating the target property with a target mix ratio for the LTFR concentrate, mixing a LTFR concentrate with water at the target mix ratio to obtain the RTU retardant. In some embodiments, the method further comprises verifying that the property of the RTU retardant is approximately the target property. In some embodiments, the property is selected from viscosity, density, refractive index, pH value, color, storage stability, combustion-retarding effectiveness, salt content, corrosion rate, pumpability, abrasiveness, surface tension, or combinations thereof. In some embodiments, the target property is viscosity.

In some embodiments, the parameter comprises a fire parameter, a weather parameter, an aircraft parameter, a drop pattern parameter, a local environment parameter, a human feedback parameter, or combinations thereof; the fire parameter comprises an intensity, a direction of spread, a growth rate, a size of the fire, or combinations thereof; the weather parameter comprises a wind direction, a wind speed, a precipitation, a humidity, a fire weather index, a cloud coverage, a dew point, an ambient temperature at a site of the fire, a forecast, or combinations thereof; the aircraft parameter comprises an aircraft type, an altitude, an aircraft speed that the RTU fire retardant is to be applied from, or combinations thereof; the drop pattern parameter comprises a desired amount of the RTU fire retardant, a desired coverage level of the RTU fire retardant, or combinations thereof; the local environment parameter comprises fuel moisture content, terrain, brush, foliage data, and combinations thereof; and the human feedback parameter comprises feedback from an air attack, feedback from an incident command, feedback from observers, feedback from a pilot, feedback from a computer program or an algorithm, feedback from a radio operator, or combinations thereof. In some embodiments, the human feedback parameter includes human or observer intuition.

In some embodiments, the methods disclosed herein further comprise adding an additional material to the RTU fire retardant, wherein adding the additional material changes one or more properties of the RTU fire retardant. In some embodiments, the additional material is selected from thickeners, pigments, fire retardant salts, organic materials, and combinations thereof. In some embodiments, the fire-retardant salts comprise ammonium phosphates, the organic materials comprise erythritol, urea, dextrose, or combinations thereof, and the thickeners comprise attapulgite, bentonite, montmorillonite, algin, collagen, casein, albumin, castor oil, cornstarch, arrowroot, yuca starch, colloidal oatmeal, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, casein, cetearyl alcohol, polyethylene glycol (PEG), monoethylene glycol, acrylic microgel, acrylic amide wax, polyvinyl pyrrolidone, polyvinyl acetate, polyvinyl alcohol, polyacrylic acid, polyacrylamide, alkali swellable emulsion thickeners (ASE), hydrophobically modified alkali swellable emulsion thickeners (HASE), or a combination thereof. In some embodiments, the one or more properties are selected from the group consisting of viscosity, density, refractive index, pH value, color, storage stability, combustion-retarding effectiveness, salt content, corrosion rate, pumpability, abrasiveness, surface tension, and combinations thereof. In some embodiments, the property is viscosity.

In some embodiments, the methods disclosed herein further comprise adding an additional material to an LTFR concentrate, wherein adding the additional material changes one or more properties of the LTFR concentrate, or changes one or more properties of an RTU fire retardant prepared by adding water to the LTFR concentrate. In some embodiments, the additional material is selected from thickeners, pigments, fire retardant salts, organic materials, and combinations thereof. In some embodiments, the fire-retardant salts comprise ammonium phosphates, the organic materials comprise erythritol, urea, dextrose, or combinations thereof, and the thickeners comprise attapulgite, bentonite, montmorillonite, algin, collagen, casein, albumin, castor oil, cornstarch, arrowroot, yuca starch, colloidal oatmeal, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, casein, cetearyl alcohol, polyethylene glycol (PEG), monoethylene glycol, acrylic microgel, acrylic amide wax, polyvinyl pyrrolidone, polyvinyl acetate, polyvinyl alcohol, polyacrylic acid, polyacrylamide, alkali swellable emulsion thickeners (ASE), hydrophobically modified alkali swellable emulsion thickeners (HASE), or a combination thereof. In some embodiments, the one or more properties are selected from the group consisting of viscosity, density, refractive index, pH value, color, storage stability, combustion-retarding effectiveness, salt content, corrosion rate, pumpability, abrasiveness, surface tension, and combinations thereof. In some embodiments, the property is viscosity.

Some embodiments of the present disclosure provide a method of producing a ready-to-use (RTU) fire retardant, the method comprising: determining, based on a parameter, a target property for the RTU fire retardant; and adding an additional material to a first RTU fire retardant to prepare the RTU fire retardant; wherein adding the additional material changes one or more properties of the first RTU fire retardant. In some embodiments, the method further comprises verifying that the property of the RTU fire retardant is approximately the target property. In some embodiments, the additional material is added to the first RTU fire retardant to prepare the RTU fire retardant and then the RTU fire retardant is loaded into a carrier, or the additional material is added to the first RTU fire retardant to prepare the RTU fire retardant while the RTU fire retardant is loaded into a carrier. In some embodiments, the carrier is an aircraft. In some embodiments, the carrier is a ground vehicle (e.g., a truck). In some embodiments, the additional material is added to the first RTU fire retardant to prepare the RTU fire retardant and then the RTU fire retardant is loaded into an aircraft, or the additional material is added to the first RTU fire retardant to prepare the RTU fire retardant while the RTU fire retardant is loaded into an aircraft. In some embodiments, the additional material is added to the first RTU fire retardant to prepare the RTU fire retardant and then the RTU fire retardant is loaded into an aircraft. In some embodiments, the process comprises 1) adding additional material to the first RTU fire retardant to prepare the RTU fire retardant, and 2) loading the RTU fire retardant into an aircraft. In some embodiments, the additional material is added to the first RTU fire retardant to prepare the RTU fire retardant while the RTU fire retardant is loaded into an aircraft. In some embodiments, the additional material is added to the first RTU fire retardant to prepare the RTU fire retardant at the same time as loading the RTU fire retardant into an aircraft. In some embodiments, the additional material is added to the first RTU fire retardant to prepare the RTU fire retardant while the RTU fire retardant is pumped into an aircraft. In a non-limiting example, the additional materials are added to or mixed with the first RTU fire retardant while the first RTU fire retardant is being pumped to an aircraft, wherein the resulting RTU fire retardant is prepared as it is being loaded into an aircraft. In some embodiments, the additional materials are added continuously to the first RTU fire retardant to prepare the RTU fire retardant. In some embodiments, the additional materials are added continuously to the first RTU fire retardant to prepare the RTU fire retardant while the RTU fire retardant is loaded into an aircraft. In some embodiments, the additional materials are added continuously to the first RTU fire retardant to prepare the RTU fire retardant, and the resulting RTU fire retardant is loaded into an aircraft as it is being prepared. In some embodiments, the first RTU fire retardant is loaded onto an aircraft, and then additional materials are added to the first RTU fire retardant to prepare the RTU fire retardant.

Some embodiments of the present disclosure provide a method of producing a ready-to-use (RTU) fire retardant, the method comprising: determining, based on a parameter, a target property for the RTU fire retardant; preparing a first LTFR concentrate (e.g., a dry concentrate or a liquid concentrate); adding an additional material to the first LTFR concentrate to prepare a second LTFR concentrate; and adding water to the second LTFR concentrate to prepare the RTU fire retardant; wherein adding the additional material changes one or more properties of the first LTFR concentrate and/or one or more properties of the RTU fire retardant. In some embodiments, the method further comprises verifying that the property of the RTU fire retardant is approximately the target property. In some embodiments, the additional material is added to the first LTFR concentrate to prepare the second LTFR concentrate, water is added to the second LTFR concentrate to prepare the RTU fire retardant, and then the RTU fire retardant is loaded into a carrier, or the additional material is added to the first LTFR concentrate to prepare the second LTFR concentrate, and water is added to the second LTFR concentrate to prepare the RTU fire retardant while the RTU fire retardant is loaded into a carrier. In some embodiments, the carrier is an aircraft. In some embodiments, the carrier is a ground vehicle (e.g., a truck). In some embodiments, the additional material is added to the first LTFR concentrate to prepare the second LTFR concentrate, and water is added to the second LTFR concentrate to prepare the RTU fire retardant, and then the RTU fire retardant is loaded into an aircraft, or the additional material is added to the first LTFR concentrate to prepare the second LTFR concentrate, and water is added to the second LTFR concentrate to prepare the RTU fire retardant while the RTU fire retardant is loaded into an aircraft. In some embodiments, the additional material is added to the first LTFR concentrate to prepare the second LTFR concentrate, and water is added to the second LTFR concentrate to prepare the RTU fire retardant and then the RTU fire retardant is loaded into an aircraft. In some embodiments, the process comprises 1) adding additional material to a first LTFR concentrate to prepare a second LTFR concentrate, 2) adding water to the second LTFR concentrate to prepare an RTU fire retardant, and 3) loading the RTU fire retardant into an aircraft. In some embodiments, the additional material is added to the first LTFR concentrate to prepare the second LTFR concentrate, and water is added to the second LTFR concentrate to prepare the RTU fire retardant while the RTU fire retardant is loaded into an aircraft. In some embodiments, the additional material is added to the first LTFR concentrate to prepare the second LTFR concentrate, and water is added to the second LTFR concentrate to prepare the RTU fire retardant at the same time as loading the RTU fire retardant into an aircraft. In some embodiments, the additional material is added to the first LTFR concentrate to prepare the second LTFR concentrate, and water is added to the second LTFR concentrate to prepare the RTU fire retardant while the RTU fire retardant is pumped into an aircraft. In a non-limiting example, the additional materials are added to or mixed with the first LTFR concentrate to prepare the second LTFR concentrate, water is then added to the second LTFR concentrate to prepare an RTU fire retardant while the first RTU fire retardant is being pumped to an aircraft as it is being prepared, i.e., wherein the resulting RTU fire retardant is prepared as it is being loaded into an aircraft. In some embodiments, the additional materials are added continuously to the first LTFR concentrate to prepare the second LTFR concentrate. In some embodiments, the water is added continuously to the second LTFR concentrate to prepare the RTU fire retardant In some embodiments, the additional materials are added continuously to the first LTFR concentrate to prepare the second LTFR concentrate, and water is added continuously to the second LTFR concentrate to prepare the RTU fire retardant, while the RTU fire retardant is loaded into an aircraft. In some embodiments, the additional materials are added continuously to the first LTFR concentrate to prepare the second LTFR concentrate, water is then added continuously to the second LTFR concentrate to prepare the RTU fire retardant, and the resulting RTU fire retardant is loaded into an aircraft as it is being prepared. In some embodiments, the first LTFR concentrate is loaded onto an aircraft, and then additional materials are added to the first LTFR concentrate to prepare the second LTFR concentrate, and water is then added to the second LTFR concentrate to prepare the RTU fire retardant. In some embodiments, the first LTFR concentrate is a dry, solid concentrate (e.g. powder). In some embodiments, the second LTFR concentrate is a dry, solid concentrate (e.g. powder). In some embodiments, the first LTFR concentrate is a liquid concentrate. In some embodiments, the second LTFR concentrate is a liquid concentrate.

Some embodiments of the present disclosure provide a method of producing a ready-to-use (RTU) fire retardant, the method comprising: determining, based on a parameter, a target property for the RTU fire retardant; preparing a first LTFR concentrate (e.g., a dry concentrate or a liquid concentrate); adding an additional material to the first LTFR concentrate to prepare a second LTFR concentrate; and adding water to the second LTFR concentrate to prepare the RTU fire retardant.

In some embodiments, the additional material is selected from thickeners, pigments, fire retardant salts, organic materials, and combinations thereof. In some embodiments, the fire-retardant salts comprise ammonium phosphates, the organic materials comprise erythritol, urea, dextrose, or combinations thereof, and the thickeners comprise attapulgite, bentonite, montmorillonite, algin, collagen, casein, albumin, castor oil, cornstarch, arrowroot, yuca starch, colloidal oatmeal, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, casein, cetearyl alcohol, polyethylene glycol (PEG), monoethylene glycol, acrylic microgel, acrylic amide wax, polyvinyl pyrrolidone, polyvinyl acetate, polyvinyl alcohol, polyacrylic acid, polyacrylamide, alkali swellable emulsion thickeners (ASE), hydrophobically modified alkali swellable emulsion thickeners (HASE), or a combination thereof. In some embodiments, the one or more properties are selected from the group consisting of viscosity, density, refractive index, pH value, color, storage stability, combustion-retarding effectiveness, salt content, corrosion rate, pumpability, abrasiveness, surface tension, and combinations thereof. In some embodiments, the property is viscosity.

Tables 1-9 and the tables in the Examples show LTFR concentrates according to some embodiments as well as example RTU retardants that can be obtained by diluting the LTFR concentrates at various mix ratios. Each of the example RTU retardants comply with a governing agency's (e.g., the USFS) currently-required properties (e.g., viscosity, density, refractive index, pH value, color, storage stability, combustion-retarding effectiveness, salt content, corrosion rate, pumpability, abrasiveness, surface tension, or combinations thereof) for RTU retardants. For conciseness, the USFS's current requirements for RTU retardants are incorporated herein by reference in its entirety. See Forest Service Specification FS 5100-304d, U.S. FOREST SERV. (Amend. May 6, 2021) (available at https://www.fs.usda.gov/rm/fire/wfcs/long_term_fire_retardants.php).

The ability to obtain a plurality of compliant RTU retardants by diluting the LTFR concentrate at various mix ratios can improve the functionality of the LTFR concentrate, as compared to present LTFR solutions. This is because the ability to obtain a plurality of compliant RTU retardants from a single LTFR concentrate provides the availability of an RTU retardant for a multitude of firefighting scenarios. By way of example, on a nearly-windless day, a fire can be most effectively combatted with the application of a low-viscosity RTU retardant-which can be obtained by mixing the LTFR concentrate at a first mix ratio. Later in the day, if the wind begins gusting, the fire can now be most effectively combatted the with application of a high-viscosity RTU retardant-which can be obtained by mixing the LTFR concentrate at a second mix ratio that is higher than the first mix ratio.

In some embodiments, the present disclosure is directed to a method of producing a RTU fire retardant, the method comprising: mixing a LTFR concentrate with water at a first mix ratio, a second mix ratio, or a third mix ratio to produce the RTU fire retardant, wherein each of the first, second, and third mix ratios are defined by an amount of concentrate, in pounds, per gallon of water, wherein the RTU fire retardant comprises: a viscosity ranging from 150 cP to less than 400 cP when the concentrate is mixed at the first mix ratio, a viscosity ranging from 400 cP to less than 800 cP when the concentrate is mixed at the second mix ratio, and a viscosity ranging from 800 cP to less than 2500 cP when the concentrate is mixed at the third mix ratio. In some embodiments, the RTU fire retardant comprises: a viscosity ranging from 150 cP to less than 400 cP when the concentrate is mixed at the first mix ratio, a viscosity ranging from 400 cP to less than 800 cP when the concentrate is mixed at the second mix ratio, and a viscosity ranging from 800 cP to less than 1500 cP when the concentrate is mixed at the third mix ratio. In some embodiments, the LTFR concentrate comprises one or more ammonium phosphates; a thickener; and a pigment. In some aspects, the LTFR concentrate further comprises a corrosion inhibitor, a flow agent, or a combination thereof. In some embodiments, the first mix ratio is lower than the second mix ratio, and the second mix ratio is lower than the third mix ratio.

In some embodiments, the present disclosure is directed to a method of producing a first RTU fire retardant and a second RTU fire retardant, the method comprising: mixing a first predetermined amount of an LTFR concentrate with a first predetermined amount of water at a first mix ratio to produce the first RTU fire retardant, wherein the first RTU fire retardant comprises a first property, and mixing a second predetermined amount of the LTFR concentrate with a second predetermined amount of water at a second mix ratio to produce the second RTU fire retardant, wherein the second RTU fire retardant comprises a second property. In some embodiments, the first mix ratio is less than the second mix ratio. In some embodiments, the second RTU fire retardant is converted to the first RTU fire retardant by adding water. In some embodiments, the first mix ratio is less than 1.5 pounds of concentrate per gallon of water, or less than 1.4 pounds of concentrate per gallon of water, or less than 1.3 pounds of concentrate per gallon of water, or less than 1.2 pounds of concentrate per gallon of water, or less than 1.1 pounds of concentrate per gallon of water, or less than 1.0 pounds of concentrate per gallon of water, or less than 0.9 pounds of concentrate per gallon of water, or less than 0.8 pounds of concentrate per gallon of water, or less than 0.7 pounds of concentrate per gallon of water. In some embodiments, the second mix ratio is 0.9 pounds or more of concentrate per gallon of water, or 1.0 pounds or more of concentrate per gallon of water, or 1.1 pounds or more of concentrate per gallon of water, or 1.2 pounds or more of concentrate per gallon of water, or 1.3 pounds or more of concentrate per gallon of water, or 1.4 pounds or more of concentrate per gallon of water, or 1.5 pounds or more of concentrate per gallon of water, or 1.7 pounds or more of concentrate per gallon of water, or 2.0 pounds or more of concentrate per gallon of water. In some embodiments, the first mix ratio is less than 1.1 pounds of concentrate per gallon of water, and wherein the second mix ratio is 1.1 pounds or more of concentrate per gallon of water. In some embodiments, the LTFR concentrate comprises: one or more ammonium phosphates, present in the concentrate in an amount having a weight percent ranging from about 82% to about 95% relative to a total dry weight of the concentrate; a thickener, present in the concentrate in an amount having a weight percent ranging from about 2% to about 15% relative to the total dry weight of the concentrate; a corrosion inhibitor, present in the concentrate in an amount having a weight percent ranging from about 0.05% to about 5.0% relative to the total dry weight of the concentrate; and a pigment, present in the concentrate in an amount having a weight percent ranging from about 0.5% to about 3.5% relative to the total dry weight of the concentrate.

In some embodiments, the property is selected from the group consisting of viscosity, density, refractive index, pH value, color, storage stability, combustion-retarding effectiveness, salt content, corrosion rate, pumpability, abrasiveness, surface tension, and combinations thereof. In some embodiments, the first property is a first viscosity and the second property is a second viscosity, and wherein the first viscosity is lower than the second viscosity.

Some embodiments of the present disclosure provide a method of producing a ready-to-use (RTU) fire retardant, the method comprising: determining, based on a parameter, a target property for the RTU fire retardant; correlating the target property with a target mix ratio for a long term fire retardant (LTFR) concentrate; and mixing the LTFR concentrate with water at the target mix ratio to obtain the RTU fire retardant. In some embodiments, the method further comprises verifying that the property of the RTU fire retardant is approximately the target property. In some embodiments, LTFR concentrate comprises: one or more ammonium phosphates; a thickener; and a pigment. In some embodiments, the LTFR concentrate further comprises one or more corrosion inhibitors, flow agents, anti-foaming agents, wetting agents, stability enhancers, surfactants, stabilizers, anti-spoilage additives, opacifiers, foaming agents, dedusters, biocide, buffers, or a combination thereof. In some embodiments, the LTFR concentrate comprises: one or more ammonium phosphates, present in the concentrate in an amount having a weight percent ranging from about 82% to about 95% relative to a total dry weight of the concentrate; a thickener, present in the concentrate in an amount having a weight percent ranging from about 0.5% to about 15% relative to the total dry weight of the concentrate; a corrosion inhibitor, present in the concentrate in an amount having a weight percent ranging from about 0.05% to about 5.0% relative to the total dry weight of the concentrate; and a pigment, present in the concentrate in an amount having a weight percent ranging from about 0.5% to about 3.5% relative to the total dry weight of the concentrate. In some embodiments, the LTFR concentrate comprises: one or more ammonium phosphates, present in the concentrate in an amount having a weight percent ranging from about 65% to about 80% relative to a total dry weight of the concentrate; a thickener, present in the concentrate in an amount having a weight percent ranging from about 0.25% to about 25% relative to the total dry weight of the concentrate; a corrosion inhibitor, present in the concentrate in an amount having a weight percent ranging from about 0.05% to about 5.0% relative to the total dry weight of the concentrate; and a pigment, present in the concentrate in an amount having a weight percent ranging from about 0.5% to about 3.5% relative to the total dry weight of the concentrate. In some embodiments, the LTFR concentrate comprises: one or more fire retardant salts, present in the concentrate in an amount having a weight percent ranging from about 85% to about 98% relative to a total dry weight of the concentrate; a thickener, present in the concentrate in an amount having a weight percent ranging from about 0.05% to about 5% relative to the total dry weight of the concentrate; a corrosion inhibitor, present in the concentrate in an amount having a weight percent ranging from about 0.01% to about 5% relative to the total dry weight of the concentrate; and a pigment, present in the concentrate in an amount having a weight percent ranging from about 0.5% to about 5.0% relative to the total dry weight of the concentrate. In some embodiments, the method further comprises adding water to the LTFR concentrate to prepare a liquid LTFR concentrate. In some embodiments, the method further comprises adding water to the liquid LTFR concentrate to prepare an RTU fire retardant.

In some embodiments, the parameter comprises a fire parameter, a weather parameter, an aircraft parameter, a drop pattern parameter, a local environment parameter, a human feedback parameter, or combinations thereof; the fire parameter comprises an intensity, a direction of spread, a growth rate, a size of the fire, or combinations thereof; the weather parameter comprises a wind direction, a wind speed, a precipitation, a humidity, a fire weather index, a cloud coverage, a dew point, an ambient temperature at a site of the fire, a forecast, or combinations thereof; the aircraft parameter comprises an aircraft type, an altitude, an aircraft speed that the RTU fire retardant is to be applied from, or combinations thereof; the drop pattern parameter comprises a desired amount of the RTU fire retardant, a desired coverage level of the RTU fire retardant, or combinations thereof; the local environment parameter comprises fuel moisture content, terrain, brush, foliage data, and combinations thereof; and the human feedback parameter comprises feedback from an air attack, feedback from an incident command, feedback from observers, feedback from a pilot, feedback from a computer program or an algorithm, feedback from a radio operator, or combinations thereof.

In some embodiments, the methods as disclosed herein further comprise adding water to one or more of the LTFR concentrates as disclosed herein to prepare a liquid LTFR concentrate. In some embodiments, the methods as disclosed herein further comprise adding water to a dry or solid LTFR concentrate (e.g. a powder concentrate) as disclosed herein to prepare a liquid LTFR concentrate. In some embodiments, the methods as disclosed herein further comprise adding water to a first liquid LTFR concentrate as disclosed herein to prepare a second liquid LTFR concentrate. In some embodiments, the methods as disclosed herein further comprise adding water to a liquid LTFR concentrate to prepare an RTU fire retardant.

### LTFR Concentrates and RTU Fire Retardants

As shown in the examples, the LTFR concentrate includes a plurality of ammonium phosphates. The plurality of ammonium phosphates is configured to retard a fire when applied, even in the absence of water. In some embodiments, the LTFR concentrate includes one or more ammonium phosphates. In some embodiments, the LTFR concentrate includes one ammonium phosphate. In some embodiments, the LTFR concentrate includes more than one ammonium phosphate. In some embodiments, the LTFR concentrate is a dry solid concentrate (e.g., a powder). In some embodiments, water can be added to the LTFR concentrate to prepare a liquid LTFR concentrate. In some embodiments, water can be added to the liquid LTFR concentrate to prepare an RTU fire retardant.

In some embodiments, the LTFR concentrate comprises: one or more ammonium phosphates; a thickener; and a pigment. In some embodiments, the LTFR concentrate further comprises a corrosion inhibitor, a flow agent, or a combination thereof.

In some embodiments, the LTFR concentrate comprises: one or more ammonium phosphates, present in the concentrate in an amount having a weight percent ranging from about 82% to about 95% relative to a total dry weight of the concentrate; a thickener, present in the concentrate in an amount having a weight percent ranging from about 0.5% to about 15% relative to the total dry weight of the concentrate; a corrosion inhibitor, present in the concentrate in an amount having a weight percent ranging from about 0.05% to about 5.0% relative to the total dry weight of the concentrate; and a pigment, present in the concentrate in an amount having a weight percent ranging from about 0.5% to about 3.5% relative to the total dry weight of the concentrate. In some embodiments, the LTFR concentrate further comprises a flow agent, present in the concentrate in an amount having a weight percent ranging from about 0.5% to about 3.0% relative to the total dry weight of the concentrate. In some embodiments, water can be added to the LTFR concentrate to prepare a liquid LTFR concentrate. In some embodiments, water can be added to the liquid LTFR concentrate to prepare an RTU fire retardant.

In some embodiments, the LTFR concentrate comprises: one or more ammonium phosphates, present in the concentrate in an amount having a weight percent ranging from about 65% to about 80% relative to a total dry weight of the concentrate; a thickener, present in the concentrate in an amount having a weight percent ranging from about 0.25% to about 25% relative to the total dry weight of the concentrate; a corrosion inhibitor, present in the concentrate in an amount having a weight percent ranging from about 0.05% to about 5.0% relative to the total dry weight of the concentrate; and a pigment, present in the concentrate in an amount having a weight percent ranging from about 0.5% to about 3.5% relative to the total dry weight of the concentrate. In some embodiments, water can be added to the LTFR concentrate to prepare a liquid LTFR concentrate. In some embodiments, water can be added to the liquid LTFR concentrate to prepare an RTU fire retardant.

In some embodiments, the plurality of ammonium phosphates includes at least two ammonium phosphates. For example, in some embodiments, the plurality of ammonium phosphates can include three or four ammonium phosphates. In some embodiments, the plurality of ammonium phosphates can include ammonium orthophosphate, ammonium pyrophosphate, ammonium tripolyphosphate, ammonium tetrapolyphosphate, ammonium polyphosphate having an average chain length less than 20, or combinations thereof. In some embodiments, the plurality of ammonium phosphates can include monoammonium orthophosphate (MAP) and diammonium orthophosphate (DAP). In some embodiments, the plurality of ammonium phosphates only includes MAP and DAP.

As shown in Table 1, in some embodiments, the plurality of ammonium phosphates is present in the concentrate in an amount having a weight percentage of approximately 91.60% relative to a total dry weight of the concentrate. In some embodiments, this amount of ammonium phosphates allows the concentrate to be diluted at various mix ratios to obtain a plurality of RTU retardants, each containing a weight percentage of ammonium phosphates relative to the total weight of the RTU retardant that meets a governing agency's requirements. Additionally, in some embodiments, this amount of ammonium phosphates (among other things) results in each of the plurality of RTU retardants having other properties (e.g., viscosity, density, refractive index, pH value, color, storage stability, combustion-retarding effectiveness, salt content, corrosion rate, pumpability, abrasiveness, surface tension, or combinations thereof) that meet a governing agency's requirements.

In some embodiments, the plurality of ammonium phosphates is present in the concentrate in an amount having a weight percentage ranging from 88% to 93% relative to the total dry weight of the concentrate. In some embodiments, the plurality of ammonium phosphates can be present in the concentrate in an amount having a weight percentage ranging from 90% to 92% relative to the total dry weight of the concentrate. In some embodiments, the plurality of ammonium phosphates can be present in the concentrate in an amount having a weight percentage ranging from 91% to 92% relative to the total dry weight of the concentrate. In some embodiments, the plurality of ammonium phosphates is present in an amount having a weight percentage less than 93% relative to the dry weight of the concentrate. In some embodiments, the plurality of ammonium phosphates is present in an amount having a weight percentage more than 87% relative to the total dry weight of the concentrate.

In some embodiments, the one or more ammonium phosphates are present in the concentrate in an amount having a weight percent ranging from about 10% to about 99% relative to a total dry weight of the concentrate. In some embodiments, the one or more ammonium phosphates are present in the concentrate in an amount having a weight percent ranging from about 65% to about 80% relative to a total dry weight of the concentrate. In some embodiments, the one or more ammonium phosphates are present in the concentrate in an amount having a weight percent ranging from about 82% to about 95% relative to a total dry weight of the concentrate. In some embodiments, the one or more ammonium phosphates are present in the concentrate in an amount having a weight percent of about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 99%, or any value in between one or more of the preceding values, relative to a total dry weight of the concentrate.

As shown in Table 1, the LTFR concentrate can include a thickener. In some embodiments, the thickener increases the viscosity of the LTFR concentrate and RTU retardants derived from the concentrate.

In some embodiments, the thickener can include a polyurethane, a polyvinyl alcohol, an acrylic polymer, a gum, a cellulosic, a sulfonate, a saccharide, a clay, an organosilicone, a protein, or a combination thereof. In some embodiments, the thickener can include, but is not limited to, latex, styrene, butadiene, polyvinyl alcohol, attapulgite, bentonite, montmorillonite, algin, collagen, casein, albumin, castor oil, cornstarch, arrowroot, yuca starch, colloidal oatmeal, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, casein, cetearyl alcohol, polyethylene glycol (PEG), monoethylene glycol, acrylic microgel, acrylic amide wax, polyvinyl pyrrolidone, polyvinyl acetate, polyvinyl alcohol, polyacrylic acid, polyacrylamide, alkali swellable emulsion thickeners (ASE), hydrophobically modified alkali swellable emulsion thickeners (HASE), or a combination thereof.

In some embodiments, the thickener can include a first thickening agent and a second thickening agent. In some embodiments, the first thickening agent can increase a viscosity of the LTFR concentrate, whereas the second thickening agent can stabilize an additive present in the LTFR concentrate. The first thickening agent can include gum(s) and/or a clay, or a combination thereof. The second thickening agent can include gum(s), a cellulosic, an acrylic polymer, a clay, a low shear stabilizer, and/or a gelling agent, or combinations thereof.

In some embodiments, the thickener can impart little or no change to the viscosity of a RTU retardant (e.g., after the LTFR concentrate is mixed with water) until the thickener is activated. In some embodiments, the thickener is activated via a concentration of salt, a temperature of the RTU retardant, a shear force on the RTU retardant, a change in pH of the RTU retardant, and/or an addition of another component, such as an activator. In some embodiments, the activator can include an acid (e.g., a phosphoric acid), a base (e.g., a sodium hydroxide), a calcium salt (e.g., a calcium sulfate), or combinations thereof. In some embodiments, the acid or the base of the activator can activate a cationic or anionic thickener. In some embodiments, the calcium salt of the activator can activate a polymer (e.g., sodium alginate) of the thickener.

As shown in Table 1, in some embodiments, the thickener is present in the concentrate in an amount having a weight percentage of approximately 2.95% relative to a total dry weight of the concentrate. In some embodiments, this amount of thickener allows the concentrate to be diluted at various mix ratios to obtain a plurality of RTU retardants, each containing a weight percentage of thickener relative to the total weight of the RTU retardant, per a governing agency's requirements. Additionally, in some embodiments, this amount of thickener (among other things) results in each of the plurality of RTU retardants having other properties (e.g., viscosity, density, refractive index, pH value, color, storage stability, combustion-retarding effectiveness, salt content, corrosion rate, pumpability, abrasiveness, surface tension, or combinations thereof), per a governing agency's requirements.

In some embodiments, the thickener is present in the concentrate in an amount having a weight percentage ranging from 2.7% to 6.7% relative to the total dry weight of the concentrate. In some embodiments, the thickener can be present in the concentrate in an amount having a weight percentage ranging from 2.25% to 3.75% relative to the total dry weight of the concentrate. In some embodiments, the thickener can be present in the concentrate in an amount having a weight percentage ranging from 2.5% to 3.5% relative to the total dry weight of the concentrate. In some embodiments, the thickener is present in an amount having a weight percentage less than 7% relative to the dry weight of the concentrate. In some embodiments, the thickener is present in an amount having a weight percentage more than 2% relative to the total dry weight of the concentrate.

In some embodiments, the thickener is present in the concentrate in an amount having a weight percent ranging from about 0.05% to about 30% relative to the total dry weight of the concentrate. In some embodiments, the thickener is present in the concentrate in an amount having a weight percent ranging from about 0.05% to about 5% relative to the total dry weight of the concentrate. In some embodiments, the thickener is present in the concentrate in an amount having a weight percent ranging from about 0.25% to about 25% relative to the total dry weight of the concentrate. In some embodiments, the thickener is present in the concentrate in an amount having a weight percent ranging from about 0.5% to about 15% relative to the total dry weight of the concentrate. In some embodiments, the thickener is present in the concentrate in an amount having a weight percent ranging from about 2% to about 25% relative to the total dry weight of the concentrate. In some embodiments, the thickener is present in the concentrate in an amount having a weight percent ranging from about 2% to about 15% relative to the total dry weight of the concentrate. In some embodiments, the thickener is present in the concentrate in an amount having a weight percent of about 0.05%, about 0.1%, about 0.2%, about 0.25%, about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, about 5%, about 10%, about 15%, about 20%, about 25%, about 30%, or any value in between one or more of the preceding values, relative to a total dry weight of the concentrate.

As shown in Table 1, or any of the other Tables disclosed herein, for example, the LTFR concentrate can include a corrosion inhibitor. In some embodiments, the corrosion inhibitor prevents corrosion of metallic substances in the LTFR concentrate, or RTU retardants derived from the LTFR concentrate, when, e.g., the concentrate or the RTU retardants are in storage.

In some embodiments, the corrosion inhibitor includes a sodium selenite, sodium stearate, sodium benzoate, sodium fluoride, sodium phosphate, sodium fumarate dibasic, magnesium phosphate, benzotriazole derivatives, sodium salts of benzotriazole derivatives, aqueous mixtures of benzotriazole derivatives, benzotriazole-5-carboxcylic acid, benzotriazole, butyl benzotriazole, sodium butyl benzotriazole, tolytriazole derivatives, sodium salts of tolytriazole derivatives, aqueous mixtures of tolytriazole derivatives, tetrathydro tolytriazole, tolytriazole, hydrogenated tolyltriazole and/or mixtures thereof, sodium tolytriazole, sodium tolytriazole (50% solution), 3-hydroxyphenyl-4-phenyl-5-mercapto-1,2,4-triazole (HPMT), 3-aminophenyl-4-phenyl-5-mercapto-1,2,4-triazole (APMT), 3,4-diphenyl-5-mercapto-1,2,4-triazole (DPMT), 3-cinnamyl-4-phenyl-5-mercapto-1,2,4-triazole (CPMT), 1,8-napthalaldehydic acid, octadecylphosphonic acid, sodium dodecyl sulfonate (SDBS), Wintrol® BBT-25Na, Wintrol® BBT, Wintrol® THT-T, Wintrol® THT-35PG, Wintrol® THT-50K, Wintrol® SAM-H90, Wintrol SB 25Na, Wintrol® SAM-H38Na, Wintrol® SAM-H40(0S), Wintrol® SAM-B90, berberine, pyrrolidine benzylic, catechin, lysergic acid, carmine, fast green, aniline, vanillin, triethanolamine, low freeze grade triethanolamine (85% TEA and 15% water), diethanolamine, methyldiethanolamine, tris(hydroxymethyl)aminomethane, p-chloroaniline, p-nitroaniline, p-methoxyaniline, p-methylaniline, p-cumate Na, sodium silicate, sodium tungstate, sodium molybdate, sodium molybdate dihydrate, disodium molbdate, disodium molybdate dihydrate, ammonium molybdate, a biopolymer (such as rhamsan gum, xanthan gum, diutan gum, or welan gum), sodium silicofluoride (SSF), or a dimercaptothiadiazole (DMTD), or a combination thereof.

As shown in Table 1, or any of the other Tables disclosed herein, in some embodiments, the corrosion inhibitor is present in the concentrate in an amount having a weight percentage of approximately 1.51% relative to a total dry weight of the concentrate. In some embodiments, this amount of corrosion inhibitor allows the concentrate to be diluted at various mix ratios to obtain a plurality of RTU retardants, each containing a weight percentage of corrosion inhibitor relative to the total weight of the RTU retardant, per a governing agency's requirements. Additionally, in some embodiments, this amount of corrosion inhibitor (among other things) also results in each of the plurality of RTU retardants having other properties (e.g., viscosity, density, refractive index, pH value, color, storage stability, combustion-retarding effectiveness, salt content, corrosion rate, pumpability, abrasiveness, surface tension, or combinations thereof), per a governing agency's requirements.

In some embodiments, the corrosion inhibitor is present in the concentrate in an amount having a weight percentage ranging from approximately 0.6% to 1.7% relative to the total dry weight of the concentrate. In some embodiments, the corrosion inhibitor can be present in the concentrate in an amount having a weight percentage ranging from 1.3% to 1.7% relative to the total dry weight of the concentrate. In some embodiments, the corrosion inhibitor can be present in the concentrate in an amount having a weight percentage ranging from 1.4% to 1.6% relative to the total dry weight of the concentrate. In some embodiments, the corrosion inhibitor is present in an amount having a weight percentage less than 1.8% relative to the dry weight of the concentrate. In some embodiments, the corrosion inhibitor is present in an amount having a weight percentage more than 0.5% relative to the total dry weight of the concentrate.

In some embodiments, the corrosion inhibitor is present in the concentrate in an amount having a weight percent ranging from about 0.01% to about 10% relative to the total dry weight of the concentrate. In some embodiments, the corrosion inhibitor is present in the concentrate in an amount having a weight percent ranging from about 0.01% to about 5.0% relative to the total dry weight of the concentrate. In some embodiments, the corrosion inhibitor is present in the concentrate in an amount having a weight percent ranging from about 0.05% to about 5.0% relative to the total dry weight of the concentrate. In some embodiments, the corrosion inhibitor is present in the concentrate in an amount having a weight percent ranging from about 0.4% to about 2.0% relative to the total dry weight of the concentrate. In some embodiments, the corrosion inhibitor is present in the concentrate in an amount of about 0.01%, about 0.05%, about 0.1%, about 0.2%, about 0.3%, about 0.4%, about 0.5%, about 1.0%, about 1.5%, about 2.0%, about 2.5%, about 3.0%, about 3.5%, about 4.0%, about 4.5%, about 5.0%, about 6.0%, about 7.0%, about 8.0%, about 9.0%, about 10.0%, or any value in between one or more of the preceding values, relative to a total dry weight of the concentrate.

As shown in Table 1, for example, the LTFR concentrate can include a pigment. In some embodiments, the pigment improves visibility of a RTU retardant, derived from the concentrate, after the RTU retardant has been applied.

In some embodiments, the pigment includes a C.I. Basic Red I dye, 6BL dye, Basic Violet II dye, C.I. Basic Violet 11:1 (tetrachlorozincate), C.I. Basic Red 1:1, Basic Yellow 40, acid fuchsin, basic fuchsin, new fuchsin, acid red 1, acid red 4, acid red 8, acid red 18, acid red 27, acid red 37, acid red 88, acid red 97, acid red 114, acid red 151, acid red 183, acid red 183, fast red violet 1B base, solvent red, Rhodamine B, Rhodamine 6G, Rhodamine 123, Rhodamine 110 chloride, erythrosine B, Basacryl red, Phloxine B, rose Bengal, direct red 80, direct red 80, Sudan red 7B, Congo red, neutral red, Fluorescent Red Mega 480, Fluorescent red 610, Fluorescent red 630, Fluorescent Red Mega 520, Pylaklor Red S-361, Pylaklor Scarlet LX-6364A Pylam Bright Red LX-1895 Pylam Coral LX-1801, FD&C Red #3, FD&C Red #4, FD&C Red #40, FD&C Red #4 Lake, D&C Red #33, or a D&C Red #33 Lake, or a combination thereof. In some embodiments, the pigment can include an organic pigment, such as a fluorescent pigment. In some embodiments, the pigment can include an encapsulated-dye pigment. In some embodiments, the pigment can be a luminescent pigment (e.g., a “glow-in-the-dark” pigment), which can enable visualization of the fire retardant in low ambient light. In some embodiments, the luminescent pigment can emit visible light or near-infrared light to enable visualization by eye or night vision goggles, respectively. In some embodiments, the luminescent pigment can include a fluorophore. In some embodiments, the flourophore can include CH1055, Cy7 and/or Cy7.5, or combinations thereof. In some embodiments, the luminescent pigment can include a phosphorescent material. In some embodiments, the phosphorescent material can include strontium aluminate-based inorganic phosphors and/or zinc sulfide phosphors, or combinations thereof. In some embodiments, the luminescent pigment may require excitation prior to use, for example, excitation via a UV or blue light in a dip tank or in an internal tank of an aircraft applying a RTU retardant. In some embodiments, the luminescent pigment can be excited after it has been applied to a fire via a UV or blue light spotlight or laser that is mounted on the aircraft.

As shown in Table 1, in some embodiments, the pigment is present in the concentrate in an amount having a weight percentage of approximately 1.76% relative to a total dry weight of the concentrate. In some embodiments, this amount of pigment allows the concentrate to be diluted at various mix ratios to obtain a plurality of RTU retardants, each containing a weight percentage of pigment relative to the total weight of the RTU retardant, per a governing agency's requirements. Additionally, in some embodiments, this amount of pigment (among other things) also results in each of the plurality of RTU retardants having other properties (e.g., viscosity, density, refractive index, pH value, color, storage stability, combustion-retarding effectiveness, salt content, corrosion rate, pumpability, abrasiveness, surface tension, or combinations thereof), per a governing agency's requirements.

In some embodiments, the pigment is present in the concentrate in an amount having a weight percentage ranging from 1.7% to 3.1% relative to the total dry weight of the concentrate. In some embodiments, the pigment can be present in the concentrate in an amount having a weight percentage ranging from 1.6% to 2.0% relative to the total dry weight of the concentrate. In some embodiments, the pigment can be present in the concentrate in an amount having a weight percentage ranging from 1.7% to 1.9% relative to the total dry weight of the concentrate. In some embodiments, the pigment is present in an amount having a weight percentage less than 3.2% relative to the dry weight of the concentrate. In some embodiments, the pigment is present in an amount having a weight percentage more than 1.5% relative to the total dry weight of the concentrate.

In some embodiments, the pigment is present in the concentrate in an amount having a weight percent ranging from about 0.1% to about 10% relative to the total dry weight of the concentrate. In some embodiments, the pigment is present in the concentrate in an amount having a weight percent ranging from about 0.1% to about 5.0% relative to the total dry weight of the concentrate. In some embodiments, the pigment is present in the concentrate in an amount having a weight percent ranging from about 0.5% to about 5.0% relative to the total dry weight of the concentrate. In some embodiments, the pigment is present in the concentrate in an amount having a weight percent ranging from about 0.5% to about 3.5% relative to the total dry weight of the concentrate. In some embodiments, the pigment is present in the concentrate in an amount of about 0.1%, about 0.5%, about 1.0%, about 1.5%, about 2.0%, about 2.5%, about 3.0%, about 3.5%, about 4.0%, about 4.5%, about 5.0%, about 6.0%, about 7.0%, about 8.0%, about 9.0%, about 10%, or any value in between one or more of the preceding values, relative to a total dry weight of the concentrate.

As shown in Table 1, for example, the LTFR concentrate can include a flow agent. In some embodiments, the flow agent is configured to reduce caking of the LTFR concentrate and RTU retardants derived therefrom.

In some embodiments, the flow agent can include a magnesium phosphate, tricalcium phosphate, micronized silica, or combinations thereof.

As shown in Table 1, in some embodiments, the flow agent is present in the concentrate in an amount having a weight percentage of approximately 2.18% relative to a total dry weight of the concentrate. In some embodiments, this amount of flow agent allows the concentrate to be diluted at various mix ratios to obtain a plurality of RTU retardants, each containing a weight percentage of flow agent relative to the total weight of the RTU retardant, per a governing agency's requirements. Additionally, in some embodiments, this amount of flow agent (among other things) also results in each of the plurality of RTU retardants having other properties (e.g., viscosity, density, refractive index, pH value, color, storage stability, combustion-retarding effectiveness, salt content, corrosion rate, pumpability, abrasiveness, surface tension, or combinations thereof), per a governing agency's requirements.

In some embodiments, the flow agent is present in the concentrate in an amount having a weight percentage ranging from 1.7% to 2.2% relative to the total dry weight of the concentrate. In some embodiments, the flow agent can be present in the concentrate in an amount having a weight percentage ranging from 2.0% to 2.4% relative to the total dry weight of the concentrate. In some embodiments, the flow can be present in the concentrate in an amount having a weight percentage ranging from 2.1% to 2.3% relative to the total dry weight of the concentrate. In some embodiments, the flow agent is present in an amount having a weight percentage less than 2.5% relative to the dry weight of the concentrate. In some embodiments, the pigment is present in an amount having a weight percentage more than 1.6% relative to the total dry weight of the concentrate.

In some embodiments, the flow agent is present in the concentrate in an amount having a weight percent ranging from about 0.01% to about 10% relative to the total dry weight of the concentrate. In some embodiments, the flow agent is present in the concentrate in an amount having a weight percent ranging from about 0.5% to about 3.0% relative to the total dry weight of the concentrate. In some embodiments, the flow agent is present in the concentrate in an amount of about 0.01%, about 0.05%, about 0.1%, about 0.5%, about 1.0%, about 1.5%, about 2.0%, about 2.5%, about 3.0%, about 3.5%, about 4.0%, about 4.5%, about 5.0%, about 6.0%, about 7.0%, about 8.0%, about 9.0%, about 10%, or any value in between one or more of the preceding values, relative to a total dry weight of the concentrate.

In some embodiments, the LTFR concentrate further comprises an additional material selected from the groups consisting of urea, erythritol, polyvinylpyrrolidine, EDTA, dextrose, tris(hydroxymethyl)aminomethane, triethanol amine, and combinations thereof. In some embodiments, the LTFR concentrate further comprises an additional material selected from the groups consisting of urea, erythritol, and combinations thereof. In some embodiments, the additional material is urea. In some embodiments, the additional material is erythritol. In some embodiments, the additional material is polyvinylpyrrolidine. In some embodiments, the additional material is EDTA. In some embodiments, the additional material is dextrose. In some embodiments, the additional material is tris(hydroxymethyl)aminomethane.

In some embodiments, the LTFR concentrate comprises: one or more fire retardant salts, present in the concentrate in an amount having a weight percent ranging from about 20% to about 98% relative to a total dry weight of the concentrate; a thickener, present in the concentrate in an amount having a weight percent ranging from about 1% to about 5% relative to the total dry weight of the concentrate; a corrosion inhibitor, present in the concentrate in an amount having a weight percent ranging from about 0.1% to about 0.7% relative to the total dry weight of the concentrate; and a pigment, present in the concentrate in an amount having a weight percent ranging from about 0.5% to about 3.5% relative to the total dry weight of the concentrate. In some embodiments, the one or more fire retardant salts are present in the concentrate in an amount having a weight percent ranging from about 70% to about 99% relative to a total dry weight of the concentrate. In some embodiments, the one or more fire retardant salts are selected from the group consisting of magnesium oxide, calcium chloride, a bicarbonate, a magnesium sulfate, a potassium salt, and combinations thereof. In some embodiments, the LTFR concentrate is a liquid concentrate. In some embodiments, the LTFR concentrate is a dry solid concentrate (e.g. a powder concentrate). In some embodiments, water is added to the dry solid LTFR concentrate (e.g. a powder) to prepare a liquid LTFR concentrate. In some embodiments, water is added to the dry solid LTFR concentrate (e.g. a powder) to prepare a liquid LTFR concentrate, wherein the liquid LTFR concentrate comprises one or more fire retardant salts in an amount ranging from about 10% by weight to about 50% by weight relative to a total weight of the liquid LTFR concentrate. In some embodiments, water can be added to the liquid LTFR concentrate to prepare an RTU fire retardant.

In some embodiments, the LTFR concentrate comprises: one or more fire retardant salts, present in the concentrate in an amount having a weight percent ranging from about 85% to about 98% relative to a total dry weight of the concentrate; a thickener, present in the concentrate in an amount having a weight percent ranging from about 0.05% to about 5% relative to the total dry weight of the concentrate; a corrosion inhibitor, present in the concentrate in an amount having a weight percent ranging from about 0.01% to about 5% relative to the total dry weight of the concentrate; and a pigment, present in the concentrate in an amount having a weight percent ranging from about 0.5% to about 5.0% relative to the total dry weight of the concentrate. In some embodiments, the LTFR concentrate comprises: one or more fire retardant salts, present in the concentrate in an amount having a weight percent ranging from about 90% to about 98% relative to a total dry weight of the concentrate; a thickener, present in the concentrate in an amount having a weight percent ranging from about 1% to about 5% relative to the total dry weight of the concentrate; a corrosion inhibitor, present in the concentrate in an amount having a weight percent ranging from about 0.1% to about 0.7% relative to the total dry weight of the concentrate; and a pigment, present in the concentrate in an amount having a weight percent ranging from about 0.5% to about 3.5% relative to the total dry weight of the concentrate. In some embodiments, the one or more fire retardant salts are present in the concentrate in an amount having a weight percent ranging from about 70% to about 99% relative to a total dry weight of the concentrate. In some embodiments, the one or more fire retardant salts are selected from the group consisting of magnesium oxide, calcium chloride, a bicarbonate, a magnesium sulfate, a potassium salt, and combinations thereof. In some embodiments, the LTFR concentrate is a dry solid concentrate (e.g. a powder concentrate). In some embodiments, water is added to the dry solid LTFR concentrate (e.g. a powder) to prepare a liquid LTFR concentrate. In some embodiments, water is added to the dry solid LTFR concentrate (e.g. a powder) to prepare a liquid LTFR concentrate, wherein the liquid LTFR concentrate comprises one or more fire retardant salts in an amount ranging from about 10% by weight to about 50% by weight relative to a total weight of the liquid LTFR concentrate. In some embodiments, water can be added to the liquid LTFR concentrate to prepare an RTU fire retardant.

In some embodiments, as mentioned above, and as shown in Table 1, a plurality of RTU retardants that comply with a governing agency's requirements can be derived from the LTFR concentrate by diluting the concentrate at various mix ratios-thereby providing the availability of an RTU retardant for a multitude of firefighting scenarios.

In some embodiments, as shown in Table 1, and the other Tables as disclosed herein, a first RTU retardant can be derived from the LTFR concentrate by mixing the concentrate with water at a first mix ratio, the first mix ratio being defined by an amount of the concentrate, in pounds, per gallon of water. In some embodiments, the first mix ratio can be approximately 0.95 pounds of concentrate per gallon of water. In some embodiments, the first mix ratio can range from 0.95 to 1.06 pounds of concentrate per gallon of water. In some embodiments, the mix ratio can range from 0.85 to 1.05 pounds of concentrate per gallon of water. In some embodiments, the first mix ratio can range from 0.9 to 1 pounds of concentrate per gallon of water. In some embodiments, the first mix ratio can be greater than 0.75 pounds of concentrate per gallon of water. In some embodiments, the first mix ratio can be less than 1.15 pounds of concentrate per gallon of water.

In some embodiments, the first RTU retardant can have a viscosity ranging from 150 cP to less than 400 cP.

In some embodiments, as shown in Table 1, the first RTU retardant can include diluted amounts of the plurality of ammonium phosphates, the thickener, the corrosion inhibitor, the pigment, and the flow agent. In some embodiments, the plurality of ammonium phosphates, the thickener, the corrosion inhibitor, the pigment, and the flow agent can be present in the first RTU retardant in an amount having a weight percentage of approximately those shown under “RTU 1” in Table 1, relative to the total weight of the retardant. In some embodiments, the plurality of ammonium phosphates can be present in the first RTU retardant in an amount having a weight percentage ranging from 9.3% to 10% relative to the total weight of the retardant. In some embodiments, the thickener can be present in the first RTU retardant in an amount having a weight percentage ranging from 0.3% to 0.8% relative to the total weight of the retardant. In some embodiments, the corrosion inhibitor can be present in the first RTU retardant in an amount having a weight percentage ranging from 0.07% to 0.15% relative to the total weight of the retardant. In some embodiments, the pigment can be present in the first RTU retardant in an amount having a weight percentage ranging from 0.18% to 0.33% relative to the total weight of the retardant. In some embodiments, the flow agent can be present in the first RTU retardant in an amount having a weight percentage ranging from 0.20% to 0.22% relative to the total weight of the retardant.

In some embodiments, as shown in Table 1, a second RTU retardant can be derived from the LTFR concentrate by mixing the concentrate with water at a second mix ratio, the second mix ratio being defined by an amount of the concentrate, in pounds, per gallon of water. In some embodiments, the second mix ratio can be approximately 1.20 pounds of concentrate per gallon of water. In some embodiments, the second mix ratio can range from 1.1 to 1.3 pounds of concentrate per gallon of water. In some embodiments, the second mix ratio can range from 1.15 to 1.25 pounds of concentrate per gallon of water. In some embodiments, the second mix ratio can be greater than 1.0 pounds of concentrate per gallon of water. In some embodiments, the second mix ratio can be less than 1.4 pounds of concentrate per gallon of water.

In some embodiments, the second RTU retardant can have a viscosity ranging from 400 cP to less than 800 cP.

In some embodiments, as shown in Table 1, the second RTU retardant can include diluted amounts of the plurality of ammonium phosphates, the thickener, the corrosion inhibitor, the pigment, and the flow agent. In some embodiments, the plurality of ammonium phosphates, the thickener, the corrosion inhibitor, the pigment, and the flow agent can be present in the second RTU retardant in an amount having a weight percentage of approximately those shown under “RTU 2” in Table 1, relative to the total weight of the retardant. In some embodiments, the plurality of ammonium phosphates can be present in the second RTU retardant in an amount having a weight percentage ranging from 11% to 11.6% relative to the total weight of the retardant. In some embodiments, the thickener can be present in the second RTU retardant in an amount having a weight percentage ranging from 0.3% to 0.9% relative to the total weight of the retardant. In some embodiments, the corrosion inhibitor can be present in the second RTU retardant in an amount having a weight percentage ranging from 0.08% to 0.19% relative to the total weight of the retardant. In some embodiments, the pigment can be present in the second RTU retardant in an amount having a weight percentage ranging from 0.22% to 0.38% relative to the total weight of the retardant. In some embodiments, the flow agent can be present in the second RTU retardant in an amount having a weight percentage ranging from 0.23% to 0.27% relative to the total weight of the retardant.

In some embodiments, as shown in Table 1, a third RTU retardant can be derived from the LTFR concentrate by mixing the concentrate with water at a third mix ratio, the third mix ratio being defined by an amount of the concentrate, in pounds, per gallon of water. In some embodiments, the third mix ratio can be approximately 1.50 pounds of concentrate per gallon of water. In some embodiments, the third mix ratio can range from 1.20 to 1.90 pounds of concentrate per gallon of water. In some embodiments, the third mix ratio can range from 1.4 to 1.6 pounds of concentrate per gallon of water. In some embodiments, the third mix ratio can range from 1.45 to 1.55 pounds of concentrate per gallon of water. In some embodiments, the third mix ratio can be greater than 1.3 pounds of concentrate per gallon of water. In some embodiments, the third mix ratio can be less than 1.7 pounds of concentrate per gallon of water.

In some embodiments, the third RTU retardant can have a viscosity ranging from 800 cP to less than 5000 cP. In some embodiments, the third RTU retardant can have a viscosity ranging from 800 cP to less than 1500 cP.

In some embodiments, as shown in Table 1, the third RTU retardant can include diluted amounts of the plurality of ammonium phosphates, the thickener, the corrosion inhibitor, the pigment, and the flow agent. In some embodiments, the plurality of ammonium phosphates, the thickener, the corrosion inhibitor, the pigment, and the flow agent can be present in the third RTU retardant in an amount having a weight percentage of approximately those shown under “RTU 3” in Table 1, relative to the total weight of the retardant. In some embodiments, the plurality of ammonium phosphates can be present in the third RTU retardant in an amount having a weight percentage ranging from 11.5% to 17.1% relative to the total weight of the retardant. In some embodiments, the thickener can be present in the third RTU retardant in an amount having a weight percentage ranging from 0.3% to 1.1% relative to the total weight of the retardant. In some embodiments, the corrosion inhibitor can be present in the third RTU retardant in an amount having a weight percentage ranging from 0.08% to 0.23% relative to the total weight of the retardant. In some embodiments, the pigment can be present in the third RTU retardant in an amount having a weight percentage ranging from 0.27% to 0.47% relative to the total weight of the retardant. In some embodiments, the flow agent can be present in the second RTU retardant in an amount having a weight percentage ranging from 0.23% to 0.24% relative to the total weight of the retardant.

TABLE 1

| Component | RTU 1 | RTU 2 | RTU 3 | Concentrate |
|---|---|---|---|---|
| Ammonium | 9.36% | 11.52% | 13.96% | 91.60% |
| Phosphates | | | | |
| Thickener | 0.30% | 0.37% | 0.45% | 2.95% |
| Corrosion Inh. | 0.15% | 0.19% | 0.23% | 1.51% |
| Pigment | 0.18% | 0.22% | 0.27% | 1.76% |
| Flow Agent | 0.22% | 0.27% | 0.33% | 2.18% |
| Mix Ratio | 0.95 | 1.20 | 1.50 | — |
| (lb conc./gallon | | | | |
| water) | | | | |
| DF (lb RTU/lb conc) | 9.78 | 7.95 | 6.56 | — |

Tables 2-5 show LTFR concentrates according to some embodiments as well as example RTU retardants obtained by diluting the LTFR concentrates at various mix ratios. Each of the example RTU retardants are formulated to comply with a governing agency's (e.g., the USFS's) currently-required properties (e.g., viscosity, density, refractive index, pH value, color, storage stability, combustion-retarding effectiveness, salt content, corrosion rate, pumpability, abrasiveness, surface tension, or combinations thereof) for RTU retardants.

In some embodiments, as shown in Tables 2-5, the LTFR concentrates include a plurality of ammonium phosphates, a thickener, a corrosion inhibitor, a pigment, and a flow agent. In some embodiments, the plurality of ammonium phosphates, thickener, corrosion inhibitor, pigment, and flow agent can be any of those described with respect to Table 1 above.

As shown in Tables 2-5, in some embodiments, the plurality of ammonium phosphates is present in the concentrate in an amount having a weight percentage of approximately 88.05%, 90.28%, or 91.71% relative to a total dry weight of the concentrate. In some embodiments, the plurality of ammonium phosphates can be present in an amount ranging from 88% to 92%, 89% to 92%, or 90% to 91% relative to the total dry weight of the concentrate. In some embodiments, the plurality of ammonium phosphates can be present in an amount having a weight percentage greater than 87% and/or less than 93% relative to the total dry weight of the concentrate.

As shown in Tables 2-5, in some embodiments, the thickener is present in the concentrate in an amount having a weight percentage of approximately 2.76%, 4.17%, or 6.64% relative to a total dry weight of the concentrate. In some embodiments, the thickener can be present in an amount ranging from 2.7% to 6.7% relative to the total dry weight of the concentrate. In some embodiments, the thickener can be present in an amount ranging from 2.25% to 3.25% or 2.5% to 3% relative to the total dry weight of the concentrate. In some embodiments, the thickener can be present in an amount ranging from 3.25% to 4.75% or 3.5% to 4.5% relative to the total dry weight of the concentrate. In some embodiments, the thickener can be present in an amount ranging from 6.25% to 6.75% or 6% to 7% relative to the total dry weight of the concentrate. In some embodiments, the thickener can be present in an amount having a weight percentage greater than 2% and/or less than 7% relative to the total dry weight of the concentrate.

As shown in Tables 2-5, in some embodiments, the corrosion inhibitor is present in the concentrate in an amount having a weight percentage of approximately 0.62% or 0.65% relative to a total dry weight of the concentrate. In some embodiments, the corrosion inhibitor can be present in an amount ranging from 0.6% to 1.6%, 0.5% to 0.9%, or 0.6% to 0.8% relative to the total dry weight of the concentrate. In some embodiments, the corrosion inhibitor can be present in an amount having a weight percentage greater than 0.4% and/or less than 1% relative to the total dry weight of the concentrate.

As shown in Tables 2-5, in some embodiments, the pigment is present in the concentrate in an amount having a weight percentage of approximately 2.92%, 3.04%, or 3.06% relative to a total dry weight of the concentrate. In some embodiments, the pigment can be present in an amount ranging from 1.7% to 3.1%, 2.8% to 3.2%, or 2.9% to 3.1% relative to the total dry weight of the concentrate. In some embodiments, the pigment can be present in an amount having a weight percentage greater than 2.7% and/or less than 3.3% relative to the total dry weight of the concentrate.

As shown in Tables 2-5, in some embodiments, the flow agent is present in the concentrate in an amount having a weight percentage of approximately 1.77%, 1.84%, or 1.85% relative to a total dry weight of the concentrate. In some embodiments, the flow agent can be present in an amount ranging from 1.7% to 2.2%, 1.7% to 2.1%, or 1.8% to 2.0% relative to the total dry weight of the concentrate. In some embodiments, the flow agent can be present in an amount having a weight percentage greater than 1.6% and/or less than 2.3% relative to the total dry weight of the concentrate.

As mentioned above, in some embodiments, and as shown in Tables 2-5, a plurality of RTU retardants that comply with a governing agency's requirements can be derived from the LTFR concentrate by diluting the concentrate at various mix ratios-thereby providing the availability of an RTU retardant for a multitude of firefighting scenarios.

In some embodiments, as shown in Tables 2-5, a first RTU retardant can be derived from the LTFR concentrate by mixing the concentrate with water at a first mix ratio, the first mix ratio being defined by an amount of the concentrate, in pounds, per gallon of water. In some embodiments, the first mix ratio can be approximately 1.01, 1.02, or 1.06 pounds of concentrate per gallon of water. In some embodiments, the first mix ratio can range from 0.95 to 1.06 pounds of concentrate per gallon of water. In some embodiments, the first mix ratio can range from 0.8 to 1.2 pounds of concentrate per gallon of water. In some embodiments, the first mix ratio can range from 0.9 to 1.1 pounds of concentrate per gallon of water. In some embodiments, the first mix ratio can be greater than 0.7 pounds of concentrate per gallon of water. In some embodiments, the first mix ratio can be less than 1.2 pounds of concentrate per gallon of water.

In some embodiments, the first RTU retardant can have a viscosity ranging from 150 cP to less than 400 cP.

In some embodiments, as shown in Tables 2-5, the first RTU retardant can include diluted amounts of the plurality of ammonium phosphates, the thickener, the corrosion inhibitor, the pigment, and the flow agent. In some embodiments, the plurality of ammonium phosphates, the thickener, the corrosion inhibitor, the pigment, and the flow agent can be present in the first RTU retardant in an amount having a weight percentage of approximately those shown under “RTU 1” in Tables 2-5, relative to the total weight of the retardant.

In some embodiments, as shown in Tables 2-5, a second RTU retardant can be derived from the LTFR concentrate by mixing the concentrate with water at a second mix ratio, the second mix ratio being defined by an amount of the concentrate, in pounds, per gallon of water. In some embodiments, the second mix ratio can be approximately 1.15 or 1.20 pounds of concentrate per gallon of water. The second mix ratio can range from 1.1 to 1.3 pounds of concentrate per gallon of water. The second mix ratio can range from 1.15 to 1.20 pounds of concentrate per gallon of water. In some embodiments, the second mix ratio can be greater than 1.0 pounds of concentrate per gallon of water. In some embodiments, the second mix ratio can be less than 1.3 pounds of concentrate per gallon of water.

In some embodiments, the second RTU retardant can have a viscosity ranging from 400 cP to less than 800 cP.

In some embodiments, as shown in Tables 2-5, the second RTU retardant can include diluted amounts of the plurality of ammonium phosphates, the thickener, the corrosion inhibitor, the pigment, and the flow agent. In some embodiments, the plurality of ammonium phosphates, the thickener, the corrosion inhibitor, the pigment, and the flow agent can be present in the second RTU retardant in an amount having a weight percentage of approximately those shown under “RTU 2” in Tables 2-5, relative to the total weight of the retardant.

In some embodiments, as shown in Tables 2-5, a third RTU retardant can be derived from the LTFR concentrate by mixing the concentrate with water at a third mix ratio, the third mix ratio being defined by an amount of the concentrate, in pounds, per gallon of water. In some embodiments, the third mix ratio can be approximately 1.20, 1.50, or 1.90 pounds of concentrate per gallon of water. In some embodiments, the third mix ratio can range from 1.2 to 1.9 pounds of concentrate per gallon of water. In some embodiments, the third mix ratio can range from 1.1 to 1.3, 1.4 to 1.6, or 1.8 to 2 pounds of concentrate per gallon of water. In some embodiments, the third mix ratio can range from 1.15 to 1.25, 1.45 to 1.55, or 1.85 to 1.95 pounds of concentrate per gallon of water. In some embodiments, the third mix ratio can be greater than 1 pounds of concentrate per gallon of water. In some embodiments, the third mix ratio can be less than 2 pounds of concentrate per gallon of water.

In some embodiments, the third RTU retardant can have a viscosity ranging from 800 cP to less than 5000 cP. In some embodiments, the third RTU retardant can have a viscosity ranging from 800 cP to less than 1500 cP.

In some embodiments, as shown in Tables 2-5, the third RTU retardant can include diluted amounts of the plurality of ammonium phosphates, the thickener, the corrosion inhibitor, the pigment, and the flow agent. In some embodiments, the plurality of ammonium phosphates, the thickener, the corrosion inhibitor, the pigment, and the flow agent can be present in the third RTU retardant in an amount having a weight percentage of approximately those shown under “RTU 3” in Tables 2-5, relative to the total weight of the retardant.

TABLE 2

| Component | RTU 1 | RTU 2 | RTU 3 | Concentrate |
|---|---|---|---|---|
| Ammonium | 9.75% | 11.35% | 13.75% | 90.28% |
| Phosphates | | | | |
| Thickener | 0.45% | 0.52% | 0.63% | 4.17% |
| Corrosion Inh. | 0.07% | 0.08% | 0.10% | 0.65% |
| Pigment | 0.33% | 0.38% | 0.47% | 3.06% |
| Flow Agent | 0.20% | 0.23% | 0.28% | 1.85% |
| Mix Ratio | 1.01 | 1.20 | 1.50 | — |
| (lb conc./gallon | | | | |
| water) | | | | |
| DF (lb RTU/lb conc) | 9.26 | 7.95 | 6.56 | |

TABLE 3

| Component | RTU 1 | RTU 2 | RTU 3 | Concentrate |
|---|---|---|---|---|
| Ammonium | 9.92% | 11.07% | 13.42% | 88.05% |
| Phosphates | | | | |
| Thickener | 0.75% | 0.83% | 1.01% | 6.64% |
| Corrosion Inh. | 0.07% | 0.08% | 0.09% | 0.62% |
| Pigment | 0.33% | 0.37% | 0.44% | 2.92% |
| Flow Agent | 0.20% | 0.22% | 0.27% | 1.77% |
| Mix Ratio | 1.06 | 1.20 | 1.50 | — |
| (lb conc./gallon | | | | |
| water) | | | | |
| DF (lb RTU/lb conc) | 8.87 | 7.95 | 6.56 | |

TABLE 4

| Component | RTU 1 | RTU 2 | RTU 3 | Concentrate |
|---|---|---|---|---|
| Ammonium | 9.99% | 11.11% | 11.53% | 91.71% |
| Phosphates | | | | |
| Thickener | 0.30% | 0.33% | 0.35% | 2.76% |
| Corrosion Inh. | 0.07% | 0.08% | 0.08% | 0.65% |
| Pigment | 0.33% | 0.37% | 0.38% | 3.04% |
| Flow Agent | 0.20% | 0.22% | 0.23% | 1.84% |
| Mix Ratio | 1.02 | 1.15 | 1.20 | — |
| (lb conc./gallon | | | | |
| water) | | | | |
| DF (lb RTU/lb conc) | 9.18 | 8.26 | 7.95 | |

TABLE 5

| Component | RTU 1 | RTU 2 | RTU 3 | Concentrate |
|---|---|---|---|---|
| Ammonium | 9.99% | 11.11% | 17.01% | 91.71% |
| Phosphates | | | | |
| Thickener | 0.30% | 0.33% | 0.51% | 2.76% |
| Corrosion Inh. | 0.07% | 0.08% | 0.12% | 0.65% |
| Pigment | 0.33% | 0.37% | 0.56% | 3.04% |
| Flow Agent | 0.20% | 0.22% | 0.34% | 1.84% |
| Mix Ratio | 1.02 | 1.15 | 1.90 | — |
| (lb conc./gallon | | | | |
| water) | | | | |
| DF (lb RTU/lb conc) | 9.18 | 8.26 | 5.39 | |

Tables 6-8 show LTFR concentrates according to some embodiments as well as example RTU retardants obtained by diluting the LTFR concentrates at various mix ratios. Each of the example RTU retardants are formulated to comply with a governing agency's (e.g., the USFS's) currently-required properties (e.g., viscosity, density, refractive index, pH value, color, storage stability, combustion-retarding effectiveness, salt content, corrosion rate, pumpability, abrasiveness, surface tension, or combinations thereof) for RTU retardants.

In some embodiments, as shown in Tables 6-8, the LTFR concentrates include a plurality of ammonium phosphates, a thickener, a corrosion inhibitor, a pigment, and a flow agent. In some embodiments, the plurality of ammonium phosphates, thickener, corrosion inhibitor, pigment, and flow agent can be any of those described with respect to Tables 1-5 above.

As shown in Tables 6-8, in some embodiments, the plurality of ammonium phosphates is present in the concentrate in an amount having a weight percentage of approximately 88.29%, 90.53%, or 91.96% relative to a total dry weight of the concentrate. The plurality of ammonium phosphates can be present in an amount ranging from 88% to 92%, 89% to 92%, or 90% to 91% relative to the total dry weight of the concentrate. In some embodiments, the plurality of ammonium phosphates can be present in an amount having a weight percentage greater than 87% and/or less than 93% relative to the total dry weight of the concentrate.

As shown in Tables 6-8, in some embodiments, the thickener is present in the concentrate in an amount having a weight percentage of approximately 2.77%, 4.18%, or 6.65% relative to a total dry weight of the concentrate. In some embodiments, the thickener can be present in an amount ranging from 2.7% to 6.7% relative to the total dry weight of the concentrate. In some embodiments, the thickener can be present in an amount ranging from 2.25% to 3.25% or 2.5% to 3% relative to the total dry weight of the concentrate. In some embodiments, the thickener can be present in an amount ranging from 3.25% to 4.75% or 3.5% to 4.5% relative to the total dry weight of the concentrate. In some embodiments, the thickener can be present in an amount ranging from 6.25% to 6.75% or 6% to 7% relative to the total dry weight of the concentrate. In some embodiments, the thickener can be present in an amount having a weight percentage greater than 2% and/or less than 7% relative to the total dry weight of the concentrate.

As shown in Tables 6-8, in some embodiments, the corrosion inhibitor is present in the concentrate in an amount having a weight percentage of approximately 0.62% or 0.65% relative to a total dry weight of the concentrate. In some embodiments, the corrosion inhibitor can be present in an amount ranging from 0.6% to 1.6%, 0.5% to 0.9%, or 0.6% to 0.8% relative to the total dry weight of the concentrate. In some embodiments, the corrosion inhibitor can be present in an amount having a weight percentage greater than 0.4% and/or less than 1% relative to the total dry weight of the concentrate.

As shown in Tables 6-8, in some embodiments, the pigment is present in the concentrate in an amount having a weight percentage of approximately 2.93%, 3.05%, or 3.06% relative to a total dry weight of the concentrate. In some embodiments, the pigment can be present in an amount ranging from 1.7% to 3.1%, 2.8% to 3.2%, or 2.9% to 3.1% relative to the total dry weight of the concentrate. In some embodiments, the pigment can be present in an amount having a weight percentage greater than 2.7% and/or less than 3.3% relative to the total dry weight of the concentrate.

As shown in Tables 6-8, in some embodiments, the flow agent is present in the concentrate in an amount having a weight percentage of approximately 1.77%, 1.85%, or 1.86% relative to a total dry weight of the concentrate. In some embodiments, the flow agent can be present in an amount ranging from 1.7% to 2.2%, 1.7% to 2.1%, or 1.8% to 2.0% relative to the total dry weight of the concentrate. In some embodiments, the flow agent can be present in an amount having a weight percentage greater than 1.6% and/or less than 2.3% relative to the total dry weight of the concentrate

As mentioned above, as shown in Tables 6-8, a plurality of RTU retardants that comply with a governing agency's requirements can be derived from the LTFR concentrate by diluting the concentrate at various mix ratios-thereby providing the availability of an RTU retardant for a multitude of firefighting scenarios.

In some embodiments, as shown in Tables 6-8, a first RTU retardant can be derived from the LTFR concentrate by mixing the concentrate at a first mix ratio, the first mix ratio being defined by an amount of the concentrate, in pounds, per gallon of water. In some embodiments, the first mix ratio can be approximately 1.01, 1.02, or 1.06 pounds of concentrate per gallon of water. In some embodiments, the first mix ratio can range from 0.95 to 1.06 pounds of concentrate per gallon of water. In some embodiments, the first mix ratio can range from 0.8 to 1.2 pounds of concentrate per gallon of water. In some embodiments, the first mix ratio can range from 0.9 to 1.1 pounds of concentrate per gallon of water. In some embodiments, the first mix ratio can be greater than 0.7 pounds of concentrate per gallon of water. In some embodiments, the first mix ratio can be less than 1.2 pounds of concentrate per gallon of water.

In some embodiments, the first RTU retardant can have a viscosity ranging from 150 cP to less than 400 cP.

In some embodiments, as shown in Tables 6-8, the first RTU retardant can include diluted amounts of the plurality of ammonium phosphates, the thickener, the corrosion inhibitor, the pigment, and the flow agent. In some embodiments, the plurality of ammonium phosphates, the thickener, the corrosion inhibitor, the pigment, and the flow agent can be present in the first RTU retardant in an amount having a weight percentage of approximately those shown under “RTU 1” in Tables 6-8, relative to the total weight of the retardant.

In some embodiments, as shown in Tables 6-8, a second RTU retardant can be derived from the LTFR concentrate by mixing the concentrate with water at a second mix ratio, the second mix ratio being defined by an amount of the concentrate, in pounds, per gallon of water. In some embodiments, the second mix ratio can be approximately 1.27, 1.48, or 2.31 pounds of concentrate per gallon of water. In some embodiments, the second mix ratio can range from 1.2 to 2.4 pounds of concentrate per gallon of water. In some embodiments, the second mix ratio can range from 1.2 to 1.4, 1.4 to 1.6, or 2.2 to 2.4 pounds of concentrate per gallon of water. In some embodiments, the second mix ratio can range from 1.25 to 1.35, 1.45 to 1.55, or 2.25 to 2.35 pounds of concentrate per gallon of water. In some embodiments, the second mix ratio can be greater than 1 pound of concentrate per gallon of water. In some embodiments, the second mix ratio can be less than 2.5 pounds of concentrate per gallon of water.

In some embodiments, the second RTU retardant can have a viscosity ranging from 800 cP to less than 5000 cP. In some embodiments, the second RTU retardant can have a viscosity ranging from 800 cP to less than 1500 cP.

In some embodiments, as shown in Tables 6-8, the second RTU retardant can include diluted amounts of the plurality of ammonium phosphates, the thickener, the corrosion inhibitor, the pigment, and the flow agent. In some embodiments, the plurality of ammonium phosphates, the thickener, the corrosion inhibitor, the pigment, and the flow agent can be present in the second RTU retardant in an amount having a weight percentage of approximately those shown under “RTU 2” in Tables 6-8, relative to the total weight of the retardant.

TABLE 6

| Component | RTU 1 | RTU 2 | Concentrate |
|---|---|---|---|
| Ammonium | 9.75% | 11.91% | 90.53% |
| Phosphates | | | |
| Thickener | 0.45% | 0.55% | 4.18% |
| Corrosion Inh. | 0.07% | 0.08% | 0.65% |
| Pigment | 0.33% | 0.41% | 3.06% |
| Flow Agent | 0.20% | 0.24% | 1.86% |
| Mix Ratio (lb | 1.01 | 1.27 | |
| conc./gallon water) | | | |
| DF (lb RTU/lb conc) | 9.26 | 7.58 | |

TABLE 7

| Component | RTU 1 | RTU 2 | Concentrate |
|---|---|---|---|
| Ammonium | 9.95% | 13.27% | 88.29% |
| Phosphates | | | |
| Thickener | 0.75% | 1.00% | 6.65% |
| Corrosion Inh. | 0.07% | 0.10% | 0.62% |
| Pigment | 0.33% | 0.44% | 2.93% |
| Flow Agent | 0.20% | 0.26% | 1.77% |
| Mix Ratio (lb | 1.06 | 1.48 | |
| conc./gallon water) | | | |
| DF (lb RTU/lb conc) | 8.85 | 6.64 | |

TABLE 8

| Component | RTU 1 | RTU 2 | Concentrate |
|---|---|---|---|
| Ammonium | 9.95% | 19.90% | 91.96% |
| Phosphates | | | |
| Thickener | 0.30% | 0.60% | 2.77% |
| Corrosion Inh. | 0.07% | 0.14% | 0.65% |
| Pigment | 0.33% | 0.66% | 3.05% |
| Flow Agent | 0.20% | 0.40% | 1.85% |
| Mix Ratio (lb | 1.02 | 2.31 | |
| conc./gallon water) | | | |
| DF (lb RTU/lb conc) | 9.22 | 4.61 | |

Table 9 shows example RTU retardants that may be obtained by diluting embodiments of the LTFR concentrates disclosed herein at various mix ratios. In some embodiments, each of the example RTU retardants can be formulated to comply with a governing agency's (e.g., the USFS's) currently-required properties (e.g., viscosity, density, refractive index, pH value, color, storage stability, combustion-retarding effectiveness, salt content, corrosion rate, pumpability, abrasiveness, surface tension, or combinations thereof) for RTU retardants. In some embodiments, as shown in Table 9, the example RTU retardants can include diluted amounts of the plurality of ammonium phosphates, the thickener, the corrosion inhibitor, the pigment, and the flow agent. In some embodiments, the plurality of ammonium phosphates, the thickener, the corrosion inhibitor, the pigment, and the flow agent can be present in the example RTU retardants in an amount having a weight percentage of approximately those shown in Table 9, relative to the total weight of the retardant.

TABLE 9

| | Ammonium | | Corrosion | | Flow | | | | | |
|---|---|---|---|---|---|---|---|---|---|---|
| RTU | Phosphates | Thickener | Inhibitor | Pigment | Agent | Water | RI | Viscosity | Density | pH |
| 1 | 10.22% | 0.40% | 0.05% | 0.12% | 0.05% | 89.15% | 12.3 | 418 | 1.0525 | 6.7 |
| 2 | 10.07% | 0.40% | 0.05% | 0.12% | 0.05% | 89.31% | 11.6 | 424 | 1.0465 | 6.31 |
| 3 | 9.80% | 0.40% | 0.05% | 0.12% | 0.05% | 89.58% | 10.6 | 432 | 1.0416 | 5.98 |
| 4 | 9.66% | 0.40% | 0.05% | 0.12% | 0.05% | 89.73% | 10.1 | 422 | 1.0427 | 5.66 |
| 5 | 9.50% | 0.40% | 0.05% | 0.12% | 0.05% | 89.87% | 9.5 | 432 | 1.0416 | 5.22 |
| 6 | 9.90% | 0.42% | 0.05% | 0.30% | 0.05% | 85.58% | 14.5 | 448 | 1.0471 | 6.22 |
| 7 | 13.73% | 0.58% | 0.07% | 0.42% | 0.07% | 80.00% | 19.7 | 822 | 1.0684 | 6.19 |
| 8 | 9.90% | 0.42% | 0.05% | 0.30% | 0.05% | 85.58% | 14.2 | 478 | 1.053 | 6.16 |
| 9 | 13.73% | 0.58% | 0.07% | 0.42% | 0.07% | 80.00% | 20.2 | 870 | 1.085 | 6.04 |
| 10 | 13.20% | 0.65% | 0.07% | 0.40% | 0.07% | 85.60% | 14.4 | 1506 | 1.056 | 6.06 |
| 11 | 9.88% | 0.60% | 0.00% | 0.33% | 0.10% | 89.10% | 10.8 | 412 | 1.048 | 6.09 |
| 12 | 9.88% | 0.68% | 0.04% | 0.33% | 0.10% | 88.98% | 10.5 | 830 | 1.0589 | 6.03 |
| 13 | 9.88% | 0.70% | 0.05% | 0.00% | 0.10% | 89.27% | 11.3 | 1000 | 1.0584 | 6.02 |
| 14 | 9.88% | 0.60% | 0.05% | 0.00% | 0.10% | 89.37% | 11.3 | 464 | 1.0581 | 6.03 |
| 15 | 9.88% | 0.40% | 0.05% | 0.00% | 0.10% | 89.57% | 11 | 170 | 1.0576 | 6.01 |
| 16 | 9.88% | 0.50% | 0.05% | 0.00% | 0.10% | 89.47% | 11.1 | 394 | 1.0578 | 6.02 |
| 17 | 9.88% | 0.45% | 0.05% | 0.00% | 0.10% | 89.52% | 11.1 | 316 | 1.0577 | 6.01 |
| 18 | 10.25% | 0.40% | 0.05% | 0.18% | 0.10% | 85.97% | 15 | 482 | 1.0366 | 6.58 |
| 19 | 9.90% | 0.60% | 0.61% | 0.30% | 0.10% | 88.49% | 12.3 | 650 | 1.065 | 6.06 |
| 20 | 9.55% | 0.60% | 0.61% | 0.30% | 0.10% | 88.84% | 10.7 | 508 | 1.0604 | 5.4 |
| 21 | 9.85% | 0.60% | 0.91% | 0.30% | 0.03% | 88.32% | 11.7 | 700 | 1.0641 | 6.05 |
| 22 | 9.81% | 0.60% | 0.91% | 0.30% | 0.03% | 88.36% | 11.5 | 686 | 1.0638 | 5.99 |
| 23 | 9.77% | 0.60% | 0.91% | 0.30% | 0.03% | 88.40% | 11.7 | 750 | 1.0648 | 5.92 |

In any of the embodiments discussed above or throughout the disclosure, the LTFR concentrate can be a powdered or liquid concentrate.

In any of the embodiments discussed above or throughout the disclosure, the plurality of ammonium phosphates can be replaced with a plurality of fire retardant salts. In any of the embodiments discussed above or throughout the disclosure, the plurality of ammonium phosphates can be replaced with one or more fire retardant salts. In any of the embodiments discussed above or throughout the disclosure, one or more ammonium phosphates can be replaced with one or more fire retardant salts. In some embodiments, the plurality of ammonium phosphates can be replaced with one fire retardant salt. In some embodiments, one or more ammonium phosphates can be replaced with one fire retardant salt. In some embodiments, the plurality of ammonium phosphates can be replaced with more than one fire retardant salt. In some embodiments, one or more ammonium phosphates can be replaced with more than one fire retardant salt. In some embodiments, the plurality of fire retardant salts, or the one or more fire retardant salts, can be selected from the group of a magnesium sulfate, a magnesium chloride, a magnesium oxide, a calcium chloride, an ammonium sulfate, a carbonate, a bicarbonate, and/or a potassium salt of a carboxylic acid, or combinations thereof. In some embodiments, the plurality of fire retardant salts, or the one or more fire retardant salts, can be selected from the group of MgCl₂, MgCl₂(H₂O)ₓ, where x is 1, 2, 4, 6, 8, or 12, CaCl₂, CaCl₂(H₂O)ₓ, where x is 1, 2, 4, or 6, MgBr₂, CaBr2, NH₄Cl, MgCO₃, Mg₃(PO4)₂, Mg₅(CO₃)₄(OH)₂(H2O)₄, Mg₃(PO₄)₂(H₂O)₈, CaCO₃, Ca₃(PO₄)₂, Mg₃Ca(CO₃)₄, Ca₃(PO₄)₂(H₂O)₂, Na₂CO₃, NaHCO₃, NaₓK_{y}CO₃ where x and y are 0 to 1, K₂CO₃, KHCO₃, monopotassium citrate, dipotassium citrate, tripotassium citrate, potassium acetate, (NH₄)₂SO₄, K₂SO₄, MgSO₄, MgSO₄(H₂O)ₓ, where x is 1, 2, 3, 4, 5, 6, 7, 9, 10 or 11, K₂Mg(SO₄)₂(H₂O)ₓ, where x is 4 or 6, Na₂SO₄, Na₂SO₄(H₂O)ₓ, where x is 7 or 10, MgCO₃(H₂O)ₓ, where x is 2, 3, or 5, Mg(PO₄HNH₄)₂, NaPO₄HNH₄, NaPO₄HNH₄(H₂O)ₓ, where x=1, 2, 3, or 4, Na₂HPO₄, Na₂HPO₄(H₂O)ₓ, where x=2, 7, 8, or 12, NaH₂PO₄, NaH₂PO₄(H₂O)ₓ, where x=1 or 2, Na₃PO₄, Na₅P₃O₁₀, Na₂P₃O₁₀ (H₂O)₆, Ca(H₂PO₄)₂, Ca(H₂PO₄)₂(H₂O)₁, CaHPO₄, CaHPO₄(H₂O)ₓ, where x=1 or 2, Ca₃(PO₄)₂, Ca₈H₂(PO₄)₆·5H₂O, Ca₂P₂O₇, Ca₂P₂O₇(H₂O)ₓ, where x=2 or 4, Ca₅(P₃O₁₀)₂, Ca₅(PO₄)₃(OH), Ca₁₀(PO₄)₆(OH, F, Cl, Br)₂, Ca₄(PO₄)₂·O, KH₂PO₄, K₂HPO₄, K₂HPO₄(H₂O)ₓ, where x=3 or 6, K₃PO₄, and/or K₃PO₄(H₂O) x, where x=3, 7, or 9, or combinations thereof.

In any of the embodiments discussed above or throughout the disclosure, the LTFR concentrate can include anti-foaming agents, wetting agents, stability enhancers, surfactants, stabilizers, anti-spoilage additives, opacifiers, foaming agents, dedusters, biocide, and/or buffers.

In any of the embodiments discussed above or throughout the disclosure, the LTFR concentrate can include a plurality of ammonium phosphates present in the concentrate in an amount having a weight percentage ranging from 50% to 99%. In any of the embodiments discussed above or throughout the disclosure, the LTFR concentrate can include a thickener present in the concentrate in an amount having a weight percentage ranging from 0.1% to 10%. In any of the embodiments discussed above or throughout the disclosure, the LTFR concentrate can include a corrosion inhibitor present in the concentrate in an amount having a weight percentage ranging from 0.1% to 10%. In any of the embodiments discussed above or throughout the disclosure, the LTFR concentrate can include a pigment present in the concentrate in an amount having a weight percentage ranging from 0.1% to 10%. In any of the embodiments discussed above or throughout the disclosure, the LTFR concentrate can include a flow agent present in the concentrate in an amount having a weight percentage ranging from 0.1% to 10%.

In some embodiments, the LTFR concentrate is a liquid concentrate. In some embodiments, the liquid LTFR concentrate comprises one or more ammonium phosphates, present in the concentrate in an amount having a weight percent ranging from about 10% to about 60%, or about 10% to about 50%, relative to a total weight of the concentrate; a thickener, present in the concentrate in an amount having a weight percent ranging from about 0.05% to about 10% relative to the total weight of the concentrate; a corrosion inhibitor, present in the concentrate in an amount having a weight percent ranging from about 0.01% to about 3.0% relative to the total weight of the concentrate; and a pigment, present in the concentrate in an amount having a weight percent ranging from about 0.1% to about 3.0% relative to the total weight of the concentrate. In some embodiments, the one or more ammonium phosphates is present in the concentrate in an amount having a weight percent ranging from about 30% to about 40% relative to a total weight of the concentrate. In some embodiments, water can be added to the liquid LTFR concentrate to prepare an RTU fire retardant.

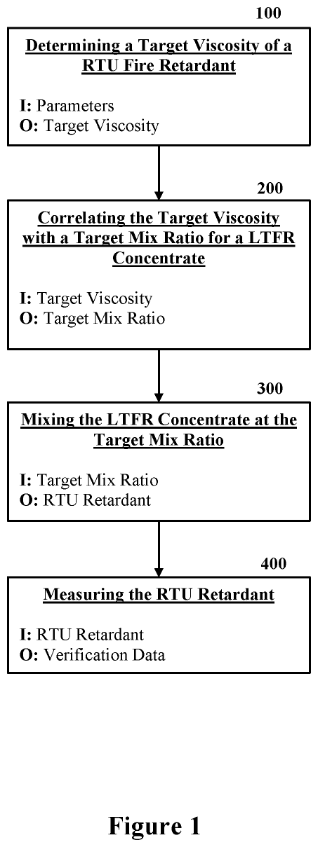

FIG. 1 shows an example method of using the LTFR concentrates discussed above with respect to Tables 1-5 and Tables 6-9, and throughout the disclosure, to obtain a plurality of RTU retardants that have different viscosities and are compliant with a governing agency's (e.g., the USFS) currently-required properties. As mentioned above, the ability to obtain a plurality of RTU retardants (from a single LTFR concentrate) that have different viscosities and are compliant with an agency's requirements provides the availability of an RTU retardant for a multitude of firefighting scenarios.

As shown in FIG. 1, in some embodiments, the method includes a determining step 100. In some embodiments, the determining step 100 can include determining, for example, based on at least one parameter, a target viscosity of a RTU retardant that is effective for combatting a fire (e.g., forest fire). In some embodiments, the at least one parameter can include, for example, a fire parameter (e.g., the intensity, direction of spread, growth rate, and/or the size of the fire); a weather parameter (e.g., a wind direction, wind speed, precipitation, humidity, fire weather index, cloud coverage, dew point, and/or ambient temperature at the site of the fire); an aircraft parameter (e.g., an aircraft type, altitude, and/or an aircraft speed that that the retardant is to be applied from); a drop pattern parameter (e.g., a desired amount and/or a desired coverage level of the retardant); and/or a local environment parameter (e.g., terrain and/or brush/foliage data). In some embodiments, the parameter is communicated by an individual viewing the fire. In some embodiments, the parameter is communicated by a ground-based weather station. In some embodiments, the ground-based weather station can include an imaging device (e.g., a camera, thermal camera, infrared camera, multispectral sensor, and/or synthetic aperture radar) configured to measure the parameter. In some embodiments, the parameter is communicated by an aircraft. In some embodiments, the aircraft can include an imaging device (e.g., a camera, thermal camera, infrared camera, multispectral sensor, and/or synthetic aperture radar) configured to measure the parameter. In some embodiments, determining step 100 is performed by a computer. In some embodiments, the computer includes an AI tool that is configured to receive the at least one parameter and determine the target viscosity. In some embodiments, determining step 100 includes determining a plurality of target viscosities for a plurality of RTU retardants that are effective for combatting a forest fire. Those skilled in the relevant art(s) will appreciate additional parameters, communication sources, etc., that can be used in determining step 100—including those disclosed in U.S. Patent Application No. 63/783,631, filed Apr. 4, 2025, which is incorporated herein in its entirety by reference.

In some embodiments, the method as shown in FIG. 1 includes a correlating step 200. In some embodiments, the correlating step 200 can include correlating the target viscosity with a target mix ratio for a LTFR concentrate. In some embodiments, the target mix ratio is selected such that, when the LTFR concentrate is mixed at approximately the target mix ratio, a viscosity of a RTU retardant derived therefrom is approximately the target viscosity. In some embodiments, correlating step 200 is performed by a computer. In some embodiments, correlating step 200 includes correlating a plurality of target viscosities with a plurality of target mix ratios.

In some embodiments, the method as shown in FIG. 1 includes a mixing step 300. In some embodiments, the mixing step 300 can include mixing a LTFR concentrate at the target mix ratio of correlating step 200 to obtain a RTU retardant having approximately the target viscosity of determining step 100. In some embodiments, the mixing step 300 can include combining the LTFR concentrate and water at the targeted mix ratio using a proportioning valve. In some embodiments, a plurality of proportioning valves can be used. In some embodiments, the LTFR concentrate and water are separately stored in tanks prior to mixing with the proportioning valve(s). In some embodiments, the proportioning valve(s) are configured to vary a head pressure of the LTFR concentrate and water, in their respective tanks, as LTFR concentrate and the water are mixed. In some embodiments, a sensor can sense one or more properties (e.g., viscosity, density, refractivity) of the resulting RTU retardant shortly after it is mixed and provide feedback to the proportioning valve(s), which can vary the head pressure of the LTFR concentrate and/or the water in response. In some embodiments, the sensor is an in-line refractometer. In some embodiments, mixing step 300 includes mixing the LTFR concentrate at a plurality of target mixing ratios.

In some embodiments, the method as shown in FIG. 1 includes a verifying step 400. In some embodiments, the verifying step 400 can include measuring the viscosity of the RTU concentrate to confirm that the viscosity is approximately the target viscosity from determining step 100. Verifying step 400 can also include measuring other properties (e.g., viscosity, density, refractive index, pH value, color, storage stability, combustion-retarding effectiveness, salt content, corrosion rate, pumpability, abrasiveness, surface tension, or combinations thereof) to confirm compliance with a governing agency's requirements for RTU retardants. In some embodiments, the properties of the RTU retardant can be measured by the sensor discussed above. In some embodiments, the measured properties are transmitted (e.g., wired or wirelessly) to a firefighting authority, such as a governing agency. In some embodiments, verifying step 400 includes measuring the properties of a plurality of RTU retardants. In some embodiments, verifying step 400 includes storing verification data, the verification data corresponding to measured properties of the RTU retardant.

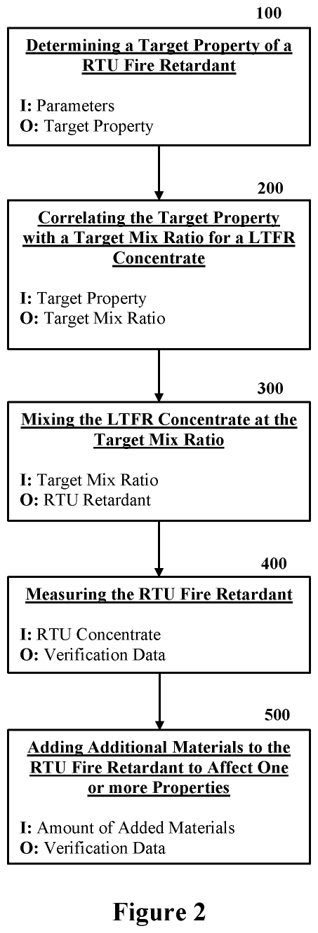

FIG. 2 shows an example method of using the LTFR concentrates discussed above with respect to Tables 1-5 and Tables 6-9, and throughout the disclosure, to obtain a plurality of RTU retardants that have different properties (e.g., viscosity) and are compliant with a governing agency's (e.g., the USFS's) currently-required values for the properties. As mentioned above, the ability to obtain a plurality of RTU retardants (from a single LTFR concentrate) that have different properties (e.g., viscosities) and are compliant with an agency's requirements provides the availability of an RTU retardant for a multitude of firefighting scenarios.

As shown in FIG. 2, in some embodiments, the method includes a determining step 100. In some embodiments, the determining step 100 can include determining, for example, based on at least one parameter, a target property (e.g., viscosity) of a RTU retardant that is effective for combatting a fire (e.g., forest fire). In some embodiments, the at least one parameter can include, for example, a fire parameter (e.g., the intensity, direction of spread, growth rate, and/or the size of the fire); a weather parameter (e.g., a wind direction, wind speed, precipitation, humidity, fire weather index, cloud coverage, dew point, and/or ambient temperature at the site of the fire); an aircraft parameter (e.g., an aircraft type, altitude, and/or an aircraft speed that that the retardant is to be applied from); a drop pattern parameter (e.g., a desired amount and/or a desired coverage level of the retardant); and/or a local environment parameter (e.g., terrain and/or brush/foliage data). In some embodiments, the parameter is communicated by an individual viewing the fire. In some embodiments, the parameter is communicated by a ground-based weather station. In some embodiments, the ground-based weather station can include an imaging device (e.g., a camera, thermal camera, infrared camera, multispectral sensor, and/or synthetic aperture radar) configured to measure the parameter. In some embodiments, the parameter is communicated by an aircraft. In some embodiments, the aircraft can include an imaging device (e.g., a camera, thermal camera, infrared camera, multispectral sensor, and/or synthetic aperture radar) configured to measure the parameter. In some embodiments, determining step 100 is performed by a computer. In some embodiments, the computer includes an AI tool that is configured to receive the at least one parameter and determine the target property (e.g., viscosity). In some embodiments, determining step 100 includes determining a plurality of target properties (e.g., viscosities) for a plurality of RTU retardants that are effective for combatting a forest fire. Those skilled in the relevant art(s) will appreciate additional parameters, communication sources, etc., that can be used in determining step 100—including those disclosed in U.S. Patent Application No. 63/783,631, filed Apr. 4, 2025, which is incorporated herein in its entirety by reference.

In some embodiments, the method as shown in FIG. 2 includes a correlating step 200. In some embodiments, the correlating step 200 can include correlating the target property (e.g., viscosity) with a target mix ratio for a LTFR concentrate. In some embodiments, the target mix ratio is selected such that, when the LTFR concentrate is mixed at approximately the target mix ratio, a property (e.g., viscosity) of a RTU retardant derived therefrom is approximately the target property (e.g., viscosity). In some embodiments, correlating step 200 is performed by a computer. In some embodiments, correlating step 200 includes correlating a plurality of target properties (e.g., viscosities) with a plurality of target mix ratios.

In some embodiments, the method as shown in FIG. 2 includes a mixing step 300. In some embodiments, the mixing step 300 can include mixing a LTFR concentrate at the target mix ratio of correlating step 200 to obtain a RTU retardant having approximately the target property (e.g., viscosity) of determining step 100. In some embodiments, the mixing step 300 can include combining the LTFR concentrate and water at the targeted mix ratio using a proportioning valve. In some embodiments, a plurality of proportioning valves can be used. In some embodiments, the LTFR concentrate and water are separately stored in tanks prior to mixing with the proportioning valve(s). In some embodiments, the proportioning valve(s) are configured to vary a head pressure of the LTFR concentrate and water, in their respective tanks, as LTFR concentrate and the water are mixed. In some embodiments, a sensor can sense one or more properties (e.g., viscosity, density, refractive index, pH value, color, storage stability, combustion-retarding effectiveness, salt content, corrosion rate, pumpability, abrasiveness, surface tension, or combinations thereof) of the resulting RTU retardant shortly after it is mixed and provide feedback to the proportioning valve(s), which can vary the head pressure of the LTFR concentrate and/or the water in response. In some embodiments, the sensor is an in-line refractometer. In some embodiments, mixing step 300 includes mixing the LTFR concentrate at a plurality of target mixing ratios.

In some embodiments, the method as shown in FIG. 2 includes a verifying step 400. In some embodiments, the verifying step 400 can include measuring the property (e.g., viscosity) of the RTU concentrate to confirm that the property (e.g., viscosity) is approximately at the target value for the property (e.g., viscosity) from determining step 100. Verifying step 400 can also include measuring other properties (e.g., viscosity, density, refractive index, pH value, color, storage stability, combustion-retarding effectiveness, salt content, corrosion rate, pumpability, abrasiveness, surface tension, or combinations thereof) to confirm compliance with a governing agency's requirements for RTU retardants. In some embodiments, the properties of the RTU retardant can be measured by the sensor discussed above. In some embodiments, the measured properties are transmitted (e.g., wired or wirelessly) to a firefighting authority, such as a governing agency. In some embodiments, verifying step 400 includes measuring the properties of a plurality of RTU retardants. In some embodiments, verifying step 400 includes storing verification data, the verification data corresponding to measured properties of the RTU retardant.

In some embodiments, the method shown in FIG. 2 includes an additional step 500, wherein additional materials are added to the RTU fire retardant to affect or modulate one or more properties of the RTU fire retardant (e.g., viscosity, density, refractive index, pH value, color, storage stability, combustion-retarding effectiveness, salt content, corrosion rate, pumpability, abrasiveness, surface tension, or combinations thereof). In some embodiments, the additional materials can include, for example, one or more thickeners, pigments, fire retardant salts, organic materials, and combinations thereof. In some embodiments, the fire retardant salts can include, for example, ammonium phosphates, magnesium oxide, calcium chloride, a bicarbonate, a magnesium sulfate, a potassium salt, and combinations thereof. In some embodiments, the added materials affect the viscosity, density, or pH of the RTU fire retardant. In some embodiments, step 500 is optional. In some embodiments, step 500 is required to obtain an RTU fire retardant with properties as required by a firefighting authority, such as a governing agency. In some embodiments, step 500 is not required to obtain an RTU fire retardant with properties as required by a firefighting authority, such as a governing agency. In some embodiments, the method as shown in FIG. 2 can include an additional verifying step performed, e.g., after step 500. In some embodiments, the additional verifying step can include measuring properties (e.g., viscosity, density, refractive index, pH, value, color, storage stability, combustion-retarding effectiveness, salt content, corrosion rate, pumpability, abrasiveness, surface tension, or combinations thereof) of the RTU concentrate to confirm compliance with a governing agency's requirements for RTU retardants.

The present disclosure also provides the following numbered embodiments.

Embodiment 1: A fire retardant concentrate comprising:
a plurality of ammonium phosphates;
a thickener;
a corrosion inhibitor;
a pigment; and
a flow agent.

Embodiment 2. A fire retardant concentrate comprising:
a plurality of ammonium phosphates, present in the concentrate in an amount having a weight percent ranging from more than 87% to less than 93% relative to a total dry weight of the concentrate;
a thickener, present in the concentrate in an amount having a weight percent ranging from more than 2% to less than 7% relative to the total dry weight of the concentrate;
a corrosion inhibitor, present in the concentrate in an amount having a weight percent ranging from more than 0.5% to less than 1.8% relative to the total dry weight of the concentrate;
a pigment, present in the concentrate in an amount having a weight percent ranging from more than 1.5% to less than 3.2% relative to the total dry weight of the concentrate; and
a flow agent, present in the concentrate in an amount having a weight percent ranging from more than 1.6% to less than 2.5% relative to the total dry weight of the concentrate.

Embodiment 3. A fire retardant concentrate comprising:
a plurality of ammonium phosphates, present in the concentrate in an amount having a weight percent of approximately 91.60% relative to a total dry weight of the concentrate;
a thickener, present in the concentrate in an amount having a weight percent of approximately 2.95% relative to the total dry weight of the concentrate;
a corrosion inhibitor, present in the concentrate in an amount having a weight percent of approximately 1.51% relative to the total dry weight of the concentrate;
a pigment, present in the concentrate in an amount having a weight percent of approximately 1.76% relative to the total dry weight of the concentrate; and
a flow agent, present in the concentrate in an amount having a weight percent of approximately 2.18% relative to the total dry weight of the concentrate.

Embodiment 4. A method of producing a RTU fire retardant, the method comprising:
mixing the concentrate of any of embodiments 1-3 with water at a first mix ratio, a second mix ratio, or a third mix ratio to produce the RTU fire retardant, wherein each of the first, second, and third mix ratios are defined by an amount of concentrate, in pounds, per gallon of water,
wherein the RTU fire retardant comprises:
a viscosity ranging from 150 cP to less than 400 cP when the concentrate is mixed at the first mix ratio,
a viscosity ranging from 400 cP to less than 800 cP when the concentrate is mixed at the second mix ratio, and
a viscosity ranging from 800 cP to less than 1500 cP when the concentrate is mixed at the third mix ratio.

Embodiment 5. The method of embodiment 4, wherein the RTU fire retardant comprises:
the plurality of ammonium phosphates in an amount having a weight percentage ranging from 9.3% to 10% relative to a total weight of the RTU fire retardant when the concentrate is mixed at the first mix ratio;
the plurality of ammonium phosphates in an amount having a weight percentage ranging from 11% to 11.6% relative to the total weight of the RTU fire retardant when the concentrate is mixed at the second mix ratio; and
the plurality of ammonium phosphates in an amount having a weight percentage ranging from 11.5% to 17.1% relative to the total weight of the RTU fire retardant when the concentrate is mixed at the third mix ratio.

Embodiment 6. The method according to any of embodiments 4 or 5, wherein the RTU fire retardant comprises:
the thickener in an amount having a weight percentage ranging from 0.3% to 0.8% relative to the total weight of the RTU fire retardant when the concentrate is mixed at the first mix ratio;
the thickener in an amount having a weight percentage ranging from 0.3% to 0.9% relative to the total weight of the RTU fire retardant when the concentrate is mixed at the second mix ratio; and
the thickener in an amount having a weight percentage ranging from 0.3% to 1.1% relative to the total weight of the RTU fire retardant when the concentrate is mixed at the third mix ratio.

Embodiment 7. The method according to any of embodiments 4-6, wherein the RTU fire retardant comprises:
the corrosion inhibitor in an amount having a weight percentage ranging from 0.07% to 0.15% relative to the total weight of the RTU fire retardant when the concentrate is mixed at the first mix ratio;
the corrosion inhibitor in an amount having a weight percentage ranging from 0.08% to 0.19% relative to the total weight of the RTU fire retardant when the concentrate is mixed at the second mix ratio; and
the corrosion inhibitor in an amount having a weight percentage ranging from 0.08% to 0.23% relative to the total weight of the RTU fire retardant when the concentrate is mixed at the third mix ratio.

Embodiment 8. The method according to any of embodiments 4-7, wherein the RTU fire retardant comprises:
the pigment in an amount having a weight percentage ranging from 0.18% to 0.33% relative to the total weight of the RTU fire retardant when the concentrate is mixed at the first mix ratio;
the pigment in an amount having a weight percentage ranging from 0.22% to 0.38% relative to the total weight of the RTU fire retardant when the concentrate is mixed at the second mix ratio; and
the pigment in an amount having a weight percentage ranging from 0.27% to 0.47% relative to the total weight of the RTU fire retardant when the concentrate is mixed at the third mix ratio.

Embodiment 9. The method according to any of embodiments 4-8, wherein the RTU fire retardant comprises:
the flow agent in an amount having a weight percentage ranging from 0.20% to 0.22% relative to the total weight of the RTU fire retardant when the concentrate is mixed at the first mix ratio;
the flow agent in an amount having a weight percentage ranging from 0.22% to 0.27% relative to the total weight of the RTU fire retardant when the concentrate is mixed at the second mix ratio; and
the flow agent in an amount having a weight percentage ranging from 0.23% to 0.24% relative to the total weight of the RTU fire retardant when the concentrate is mixed at the third mix ratio.

Embodiment 10. The method according to any of embodiments 4-9, wherein the first mix ratio ranges from 0.95 to 1.06 pounds of concentrate per gallon of water,
wherein the second mix ratio ranges from 1.15 to 1.20 pounds of concentrate per gallon of water, and
wherein the third mix ratio ranges from 1.20 to 1.90 pounds of concentrate per gallon of water.

Embodiment 11. A method of producing a first RTU fire retardant and a second RTU fire retardant, the method comprising:
mixing a first predetermined amount of the concentrate of any of embodiments 1-3 with a first predetermined amount of water to produce the first RTU fire retardant, wherein a ratio of the first predetermined amount of concentrate to the first predetermined amount of water ranges from 0.9 to 1.1 pounds of concentrate per gallon of water, wherein the first RTU fire retardant comprises a first viscosity, and
mixing a second predetermined amount of the concentrate of any of embodiments 1-3 with a second predetermined amount of water to produce the second RTU fire retardant, wherein a ratio of the second predetermined amount of concentrate to the second predetermined amount of water ranges from 1.2 to 1.9 pounds of concentrate per gallon of water, wherein the second RTU fire retardant comprises a second viscosity.

Embodiment 12. The method of embodiment 11, wherein the first viscosity is lower than the second viscosity.

Embodiment 13. A method of producing a RTU fire retardant, the method comprising:
determining, based on a parameter, a target viscosity for the RTU fire retardant;
correlating the target viscosity with a target mix ratio for a LTFR concentrate;
mixing the LTFR concentrate with water at the target mix ratio to obtain the RTU fire retardant; and
verifying that a viscosity of the RTU fire retardant is approximately the target viscosity.

Embodiment 14. The method of embodiment 13, wherein the LTFR concentrate is the concentrate of any of embodiments 1-3.

Embodiment 15. The method according to any of embodiments 13 or 14, wherein:
the parameter includes one or more of a fire parameter, a weather parameter, an aircraft parameter, a drop pattern parameter, and a local environment parameter,
the fire parameter includes one or more of an intensity, a direction of spread, a growth rate, and a size of the fire,
the weather parameter includes one or more of a wind direction, a wind speed, a precipitation, a humidity, a fire weather index, a cloud coverage, a dew point, and an ambient temperature at a site of the fire,
the aircraft parameter includes one or more of an aircraft type, an altitude, and an aircraft speed that the RTU fire retardant is to be applied from,
the drop pattern parameter includes one or more of a desired amount and a desired coverage level of the RTU fire retardant, and
the local environment parameter includes one or more of terrain, brush, and foliage data.

Embodiment 16. A fire retardant concentrate comprising:
a plurality of fire retardant salts;
a thickener;
a pigment; and
a flow agent.

Embodiment 17. A method of producing a ready-to-use (RTU) fire retardant, the method comprising:
determining, based on a parameter, a target property for the RTU fire retardant;
correlating the target property with a target mix ratio for a long term fire retardant (LTFR) concentrate; and
mixing the LTFR concentrate with water at the target mix ratio to obtain the RTU fire retardant.

Embodiment 18. The method of embodiment 17, further comprising verifying that the property of the RTU fire retardant is approximately the target property.

Embodiment 19. The method of embodiment 17, wherein the target property is selected from the group consisting of viscosity, density, refractive index, pH value, color, combustion-retarding effectiveness, salt content, corrosion rate, surface tension, and combinations thereof.

Embodiment 20. The method of embodiment 19, wherein the target property is viscosity.

Embodiment 21. The method of any one of embodiments 17-20, wherein LTFR concentrate comprises:
one or more ammonium phosphates;
a thickener; and
a pigment.

Embodiment 22. The method of embodiment 21, wherein the LTFR concentrate further comprises one or more corrosion inhibitors, flow agents, anti-foaming agents, wetting agents, stability enhancers, surfactants, stabilizers, anti-spoilage additives, opacifiers, foaming agents, dedusters, biocide, buffers, or a combination thereof.

Embodiment 23. The method of any one of embodiments 17-22, wherein the LTFR concentrate comprises:
one or more ammonium phosphates, present in the concentrate in an amount having a weight percent ranging from about 82% to about 95% relative to a total dry weight of the concentrate;
a thickener, present in the concentrate in an amount having a weight percent ranging from about 0.5% to about 15% relative to the total dry weight of the concentrate;
a corrosion inhibitor, present in the concentrate in an amount having a weight percent ranging from about 0.05% to about 5.0% relative to the total dry weight of the concentrate; and
a pigment, present in the concentrate in an amount having a weight percent ranging from about 0.5% to about 3.5% relative to the total dry weight of the concentrate.

Embodiment 24. The method of embodiment 23, further comprising adding water to the LTFR concentrate to prepare a liquid LTFR concentrate.

Embodiment 25. The method of any one of embodiments 17-24, wherein the LTFR concentrate comprises:
one or more ammonium phosphates, present in the concentrate in an amount having a weight percent ranging from about 65% to about 80% relative to a total dry weight of the concentrate;
a thickener, present in the concentrate in an amount having a weight percent ranging from about 0.25% to about 25% relative to the total dry weight of the concentrate;
a corrosion inhibitor, present in the concentrate in an amount having a weight percent ranging from about 0.05% to about 5.0% relative to the total dry weight of the concentrate; and
a pigment, present in the concentrate in an amount having a weight percent ranging from about 0.5% to about 3.5% relative to the total dry weight of the concentrate.

Embodiment 26. The method of embodiment 25, wherein the LTFR concentrate further comprises an additional material selected from the groups consisting of urea, erythritol, and combinations thereof.

Embodiment 27. The method of any one of embodiments 17-26, wherein the LTFR concentrate comprises:
one or more fire retardant salts, present in the concentrate in an amount having a weight percent ranging from about 85% to about 98% relative to a total dry weight of the concentrate;
a thickener, present in the concentrate in an amount having a weight percent ranging from about 0.05% to about 5% relative to the total dry weight of the concentrate;
a corrosion inhibitor, present in the concentrate in an amount having a weight percent ranging from about 0.01% to about 5% relative to the total dry weight of the concentrate; and
a pigment, present in the concentrate in an amount having a weight percent ranging from about 0.5% to about 5% relative to the total dry weight of the concentrate.

Embodiment 28. The method of embodiment 27, wherein the one or more fire retardant salts are selected from the group consisting of magnesium oxide, calcium chloride, a bicarbonate, a magnesium sulfate, a potassium salt, and combinations thereof.

Embodiment 29. The method of any one of embodiments 17-27, further comprising adding an additional material to the RTU fire retardant, wherein adding the additional material changes one or more properties of the RTU fire retardant.

Embodiment 30. The method of embodiment 29, wherein the added material is selected from thickeners, pigments, fire retardant salts, organic materials, and combinations thereof.

Embodiment 31. The method of embodiment 30, wherein the fire retardant salts comprise ammonium phosphates, the organic materials comprise erythritol, urea, dextrose, or combinations thereof, and the thickeners comprise attapulgite, bentonite, montmorillonite, algin, collagen, casein, albumin, castor oil, cornstarch, arrowroot, yuca starch, colloidal oatmeal, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, casein, cetearyl alcohol, polyethylene glycol (PEG), monoethylene glycol, acrylic microgel, acrylic amide wax, polyvinyl pyrrolidone, polyvinyl acetate, polyvinyl alcohol, polyacrylic acid, polyacrylamide, alkali swellable emulsion thickeners (ASE), hydrophobically modified alkali swellable emulsion thickeners (HASE), or a combination thereof.

Embodiment 32. The method of embodiment 29, wherein the one or more properties are selected from the group consisting of viscosity, density, refractive index, pH value, color, combustion-retarding effectiveness, salt content, corrosion rate, surface tension, and combinations thereof.

Embodiment 33. The method of embodiment 32, wherein the property is viscosity.

Embodiment 34. A method of producing a ready-to-use (RTU) fire retardant, the method comprising:
determining, based on a parameter, a target property for the RTU fire retardant; and
adding an additional material to a first RTU fire retardant to prepare the RTU fire retardant;
wherein adding the additional material changes one or more properties of the first RTU fire retardant.

Embodiment 35. The method of Embodiment 34, further comprising verifying that the property of the RTU fire retardant is approximately the target property.

Embodiment 36. The method of Embodiment 34, wherein the additional material is added to the first RTU fire retardant to prepare the RTU fire retardant and then the RTU fire retardant is loaded into an aircraft, or wherein the additional material is added to the first RTU fire retardant to prepare the RTU fire retardant while the RTU fire retardant is loaded into an aircraft.

Embodiment 37. The method of embodiment 34, wherein the added material is selected from thickeners, pigments, fire retardant salts, organic materials, or combinations thereof.

Embodiment 38. The method of embodiment 37, wherein the fire retardant salts comprise ammonium phosphates, the organic materials comprise erythritol, urea, dextrose, or combinations thereof, and the thickeners comprise attapulgite, bentonite, montmorillonite, algin, collagen, casein, albumin, castor oil, cornstarch, arrowroot, yuca starch, colloidal oatmeal, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, casein, cetearyl alcohol, polyethylene glycol (PEG), monoethylene glycol, acrylic microgel, acrylic amide wax, polyvinyl pyrrolidone, polyvinyl acetate, polyvinyl alcohol, polyacrylic acid, polyacrylamide, alkali swellable emulsion thickeners (ASE), hydrophobically modified alkali swellable emulsion thickeners (HASE), or combinations thereof.

Embodiment 39. The method of embodiment 34, wherein the one or more properties are selected from the group consisting of viscosity, density, refractive index, pH value, color, combustion-retarding effectiveness, salt content, corrosion rate, surface tension, and combinations thereof.

Embodiment 40. The method of embodiment 39, wherein the property is viscosity.

Embodiment 41. The method according to any of embodiments 17-40, wherein:
the parameter comprises a fire parameter, a weather parameter, an aircraft parameter, a drop pattern parameter, a local environment parameter, a human feedback parameter, or combinations thereof
the fire parameter comprises an intensity, a direction of spread, a growth rate, a size of the fire, or combinations thereof;
the weather parameter comprises a wind direction, a wind speed, a precipitation, a humidity, a fire weather index, a cloud coverage, a dew point, an ambient temperature at a site of the fire, a forecast, or combinations thereof;
the aircraft parameter comprises an aircraft type, an altitude, an aircraft speed that the RTU fire retardant is to be applied from, or combinations thereof;
the drop pattern parameter comprises a desired amount of the RTU fire retardant, a desired coverage level of the RTU fire retardant, or combinations thereof;
the local environment parameter comprises fuel moisture content, terrain, brush, foliage data, and combinations thereof; and
the human feedback parameter comprises feedback from an air attack, feedback from an incident command, feedback from observers, feedback from a pilot, feedback from a computer program or an algorithm, feedback from a radio operator, or combinations thereof.

Embodiment 42. A method of producing a first RTU fire retardant and a second RTU fire retardant, the method comprising:
mixing a first predetermined amount of an LTFR concentrate with a first predetermined amount of water at a first mix ratio to produce the first RTU fire retardant, wherein the first RTU fire retardant comprises a first property, and
mixing a second predetermined amount of the LTFR concentrate with a second predetermined amount of water at a second mix ratio to produce the second RTU fire retardant, wherein the second RTU fire retardant comprises a second property.

Embodiment 43. The method of embodiment 42, wherein the first mix ratio is less than the second mix ratio.

Embodiment 44. The method of embodiment 42, wherein the second RTU fire retardant is converted to the first RTU fire retardant by adding water.

Embodiment 45. The method of any one of embodiments 42-44, wherein the property is selected from the group consisting of viscosity, density, refractive index, pH value, color, combustion-retarding effectiveness, salt content, corrosion rate, surface tension, and combinations thereof.

Embodiment 46. The method of any one of embodiments 42-45, wherein the first property is a first viscosity and the second property is a second viscosity, and wherein the first viscosity is lower than the second viscosity.

Embodiment 47. The method of any one of embodiments 42-46, wherein the LTFR concentrate comprises:
one or more ammonium phosphates, present in the concentrate in an amount having a weight percent ranging from about 82% to about 95% relative to a total dry weight of the concentrate;
a thickener, present in the concentrate in an amount having a weight percent ranging from about 0.5% to about 15% relative to the total dry weight of the concentrate;
a corrosion inhibitor, present in the concentrate in an amount having a weight percent ranging from about 0.05% to about 5.0% relative to the total dry weight of the concentrate; and
a pigment, present in the concentrate in an amount having a weight percent ranging from about 0.5% to about 3.5% relative to the total dry weight of the concentrate.

Embodiment 48. The method of embodiment 47, wherein the LTFR concentrate further comprises a flow agent, present in the concentrate in an amount having a weight percent ranging from about 0.5% to about 3.0% relative to the total dry weight of the concentrate.

Embodiment 49. The method of embodiment 47, wherein the LTFR concentrate further comprises one or more corrosion inhibitors, flow agents, anti-foaming agents, wetting agents, stability enhancers, surfactants, stabilizers, anti-spoilage additives, opacifiers, foaming agents, dedusters, biocide, buffers, or a combination thereof.

### EXAMPLES

The present disclosure is further explained in the following by referring to Examples. However, the examples do not limit the present disclosure and the examples can be modified within the scope of the present disclosure. Unless otherwise indicated, percent (%) values indicate percent by weight (wt %) of the entire composition (i.e., LTFR concentrate or RTU fire retardant).

In the following Examples, the following abbreviations are used.
MAP: Monoammonium Orthophosphate
DAP: Diammonium Orthophosphate
APP: Ammonium Polyphosphate
DSM: Disodium Molybdate
TTA: Tolyltriazole
BTA: Benzotriazole
CMC: carboxymethyl cellulose
PVP: Polyvinyl Pyrrolidone
HPGG: Hydroxypropyl Guar Gum
TEA: Triethanolamine
MgO: Magnesium Oxide
EDTA: Ethylenediamine Tetraacetic Acid
SDBS: Sodium Dodecyl Benzene sulfonate
HEC: Hydroxyethyl Cellulose
TRIS: tris(hydroxymethyl)aminomethane
AMO: ammonium molybdate
STS: sodium thiosulfate
KHCO₃: Potassium bicarbonate
CaCl₂): Calcium chloride
MR: Mix Ratio (pounds of concentrate per gallon of water)
MDF: Mass Dilution Factor (mass of RTU per mass of concentrate)
N/P: ammoniacal nitrogen to phosphorus ratio

### Example 1: Adding Additional Materials to RTU Fire Retardants to Affect Properties

### Example 1A

LTFR Concentrate A was prepared by adding the ingredients in the amounts listed in Table 10 below. RTU Fire Retardant A (RTU A) was then prepared by adding water using the mass dilution factor (MDF) and in the amount listed in Table 10.

100 parts RTU A was then mixed with 0.5 parts xanthan gum (XG) to obtain the RTU fire retardant RTU A+XG. The final amounts of each ingredient in percent by weight for RTU A+XG are shown in Table 10, along with a viscosity value.

100 parts RTU A was then mixed with 1.1 parts hydroxyethyl cellulose (HEC) to obtain the RTU fire retardant RTU A+HEC. The final amounts of each ingredient in percent by weight for RTU A+HEC are shown in Table 10, along with a viscosity value.

TABLE 10

| | LTFR | | RTU A + | RTU A + |
|---|---|---|---|---|
| Component | Conc A | RTU A | XG | HEC |
| MAP | 62.800% | 6.55% | 6.52% | 6.48% |
| DAP | 30.681% | 3.20% | 3.18% | 3.17% |
| Xanthan gum | 2.876% | 0.300% | 0.299% | 0.297% |
| Pigment | 2.876% | 0.300% | 0.299% | 0.297% |
| Anti-foam | 0.288% | 0.030% | 0.030% | 0.030% |
| DSM | 0.479% | 0.050% | 0.050% | 0.049% |
| Xanthan Gum | 0% | 0% | 0.498% | 0% |
| Hydroxyethyl | 0% | 0% | 0.0% | 1.088% |
| Cellulose | | | | |
| Water | 0% | 89.57% | 89.12% | 88.60% |
| Total | 100.0% | 100.0% | 100.0% | 100.0% |
| MDF | | 9.59 | | |
| Viscosity (cP) | | 270 | 1200 | 1150 |

The results in Table 10 show that the viscosity of RTU A was adjusted (i.e., increased) by adding the specified amounts of xanthan gum or hydroxyethyl cellulose.

### Example 1B

LTFR Concentrate B was prepared by adding the ingredients in the amounts listed in Table 11 below. RTU Fire Retardant B (RTU B) was then prepared by adding water using the mass dilution factor (MDF) and in the amount listed in Table 11.

100 parts RTU B was then mixed with 0.5 parts hydroxypropyl guar gum (HPGG) to obtain the RTU fire retardant RTU B+HPGG. The final amounts of each ingredient in percent by weight for RTU B+HPGG are shown in Table 11, along with a viscosity value.

100 parts RTU B was then mixed with 0.75 parts hydroxyethyl cellulose (HEC) to obtain the RTU fire retardant RTU B+HEC. The final amounts of each ingredient in percent by weight for RTU B+HEC are shown in Table 11, along with a viscosity value.

100 parts RTU B was then mixed with 0.15 parts phosphorescent pigment (PIG) to obtain the RTU fire retardant RTU B+PIG. The final amounts of each ingredient in percent by weight for RTU B+PIG are shown in Table 11, along with a viscosity value.

TABLE 11

| | | | RTU | RTU | RTU |
|---|---|---|---|---|---|
| | LTFR | | B + | B + | B + |
| Component | Conc B | RTU B | HPGG | HEC | PIG |
| MAP | 49.130% | 5.65% | 5.62% | 5.61% | 5.64% |
| DAP | 36.957% | 4.25% | 4.23% | 4.22% | 4.24% |
| Hydroxypropyl | 3.478% | 0.400% | 0.398% | 0.397% | 0.399% |
| guar gum | | | | | |
| Pigment | 2.609% | 0.300% | 0.299% | 0.298% | 0.300% |
| Sodium Sulfate | 6.957% | 0.800% | 0.796% | 0.794% | 0.799% |
| DSM | 0.870% | 0.100% | 0.100% | 0.099% | 0.100% |
| Hydroxypropyl | 0% | 0% | 0.498% | 0% | 0% |
| Guar Gum | | | | | |
| Hydroxyethyl | 0% | 0% | 0% | 0.744% | 0% |
| Cellulose | | | | | |
| Phosphorescent | 0% | 0% | 0% | 0% | 0.150% |
| Pigment | | | | | |
| Water | 0% | 88.50% | 88.06% | 87.84% | 88.37% |
| Total | 100.0% | 100.0% | 100.0% | 100.0% | 100.0% |
| MDF | | 8.70 | | | |
| Viscosity (cP) | | 140 | 1380 | 1200 | 150 |

The results in Table 11 show that the viscosity of RTU B was adjusted (i.e., increased) by adding the specified amounts of hydroxypropyl guar gum, hydroxyethyl cellulose, or pigment.

### Example 1C

LTFR Concentrate C was prepared by adding the ingredients in the amounts listed in Table 12 below. RTU Fire Retardant C (RTU C) was then prepared by adding water using the mass dilution factor (MDF) and in the amount listed in Table 12.

100 parts RTU C was then mixed with 1.0 parts monoammonium phosphate (MAP) to obtain the RTU fire retardant RTU C+MAP. The final amounts of each ingredient in percent by weight for RTU C+MAP are shown in Table 12, along with a viscosity value, a density, a refractive index, and a pH value.

100 parts RTU C was then mixed with 3.0 parts erythritol (ERY) to obtain the RTU fire retardant RTU C+ERY. The final amounts of each ingredient in percent by weight for RTU C+ERY are shown in Table 12, along with a viscosity value, a density, a refractive index, and a pH value.

100 parts RTU C was then mixed with 2.0 parts dextrose (DEX) to obtain the RTU fire retardant RTU C+DEX. The final amounts of each ingredient in percent by weight for RTU C+DEX are shown in Table 12, along with a viscosity value, a density, a refractive index, and a pH value.

100 parts RTU C was then mixed with 1.5 parts urea to obtain the RTU fire retardant RTU C+Urea. The final amounts of each ingredient in percent by weight for RTU C+Urea are shown in Table 12, along with a viscosity value, a density, a refractive index, and a pH value.

TABLE 12

| | LTFR | | RTU C + | RTU C + | RTU C + | RTU C + |
|---|---|---|---|---|---|---|
| Component | Conc C | RTU C | MAP | ERY | DEX | Urea |
| MAP | 50.133% | 5.65% | 5.59% | 5.49% | 5.54% | 5.57% |
| DAP | 37.711% | 4.25% | 4.21% | 4.13% | 4.17% | 4.19% |
| Hydroxypropyl guar | 3.993% | 0.450% | 0.446% | 0.437% | 0.441% | 0.443% |
| gum | | | | | | |
| Pigment | 2.662% | 0.300% | 0.297% | 0.291% | 0.294% | 0.296% |
| Sodium Sulfate | 4.437% | 0.500% | 0.495% | 0.485% | 0.490% | 0.493% |
| DSM | 0.887% | 0.100% | 0.099% | 0.097% | 0.098% | 0.099% |
| TTA | 0.089% | 0.010% | 0.010% | 0.010% | 0.010% | 0.010% |
| BTA | 0.089% | 0.010% | 0.010% | 0.010% | 0.010% | 0.010% |
| MAP | 0% | 0% | 0.99% | 0% | 0% | 0% |
| Erythritol | 0% | 0% | 0% | 2.91% | 0% | 0% |
| Dextrose | 0% | 0% | 0% | 0% | 1.96% | 0% |
| Urea | 0% | 0 | 0 | 0 | 0 | 1.48% |
| Water | 0% | 88.73% | 87.85% | 86.15% | 86.99% | 87.42% |
| Total | 100.0% | 100% | 100% | 100% | 100% | 100% |
| MDF | | 8.87 | | | | |
| Viscosity (cP) | | 195 | 193.5 | 195.5 | 195 | 194 |
| Density (g/mL) | | 1.064 | 1.069 | 1.071 | 1.0614 | 1.0576 |
| Refractive Index (% | | 12.50% | 12.60% | 14.40% | 13.00% | 13.60% |
| Brix) | | | | | | |
| pH | | 6.1 | 5.98 | 6.06 | 6.07 | 6.1 |

The results in Table 12 show the effects on the viscosity, density, refractive index, and pH of RTU C by adding the specified amounts of monoammonium phosphate, erythritol, dextrose, or urea.

### Example 1D

LTFR Concentrate RR was prepared by adding the ingredients in the amounts listed in Table 27 below. RTU Fire Retardant RR (RTU RR) was then prepared by adding water using the mass dilution factor (MDF) and in the amount listed in Table 27.

100 parts RTU RR was then mixed with 0.75 parts carboxymethyl cellulose (CMC) to obtain the RTU fire retardant RTU RR+CMC. The final amounts of each ingredient in percent by weight for RTU RR+CMC are shown in Table 27, along with a viscosity value, a density, a refractive index, and a pH value.

TABLE 27

| | LTFR | | RTU RR + |
|---|---|---|---|
| Component | Conc RR | RTU RR | CMC |
| KHCO₃ | 92.421% | 10.00% | 9.926% |
| Xanthan Gum | 3.882% | 0.420% | 0.417% |
| Pigment | 2.773% | 0.300% | 0.298% |
| Anti-foam | 0.462% | 0.050% | 0.050% |
| DSM | 0.185% | 0.020% | 0.020% |
| BTA | 0.277% | 0.030% | 0.030% |
| CMC | 0% | 0% | 0.744% |
| Water | 0% | 89.18% | 88.52% |
| Total | 100.0% | 100% | 100% |
| MDF | | 9.24 | |
| Viscosity (cP) | | 422 | 1482 |
| Density (g/mL) | | 1.0403 | 1.0534 |
| Refractive Index (% | | 7.8% | 8.4% |
| Brix) | | | |
| pH | | 8.24 | 8.34 |

The results in Table 27 show the effects on the viscosity, density, refractive index, and pH of RTU RR by adding the specified amounts of carboxymethyl cellulose (CMC).

### Example 1E

LTFR Concentrate SS was prepared by adding the ingredients in the amounts listed in Table 28 below. RTU Fire Retardant SS (RTU SS) was then prepared by adding water using the mass dilution factor (MDF) and in the amount listed in Table 28.

100 parts RTU SS was then mixed with 0.75 parts hydroxyethyl cellulose (HEC) to obtain the RTU fire retardant RTU SS+HEC. The final amounts of each ingredient in percent by weight for RTU SS+HEC are shown in Table 28, along with a viscosity value, a density, a refractive index, and a pH value.

TABLE 28

| | LTFR | | RTU SS + |
|---|---|---|---|
| Component | Conc SS | RTU SS | HEC |
| CaCl₂ | 89.888% | 12.00% | 11.911% |
| Hydroxypropyl guar | 3.371% | 0.450% | 0.447% |
| gum | | | |
| Pigment | 2.247% | 0.300% | 0.298% |
| Sodium Thiosulfate | 3.745% | 0.500% | 0.496% |
| DSM | 0.749% | 0.100% | 0.099% |
| HEC | 0% | 0% | 0.744% |
| Water | 0% | 86.65% | 86.00% |
| Total | 100.0% | 100% | 100% |
| MDF | | 7.49 | |
| Viscosity (cP) | | 330 | 6520 |
| Density (g/mL) | | 1.0905 | 1.0842 |
| Refractive Index (% | | 14.90% | 15.20% |
| Brix) | | | |
| pH | | 7.12 | 7.24 |

The results in Table 28 show the effects on the viscosity, density, refractive index, and pH of RTU SS by adding the specified amounts of hydroxyethyl cellulose (HEC).

### Example 1F

LTFR Concentrate TT was prepared by adding the ingredients in the amounts listed in Table 29 below. RTU Fire Retardant TT (RTU TT) was then prepared by adding water using the mass dilution factor (MDF) and in the amount listed in Table 29.

100 parts RTU TT was then mixed with 0.50 parts carboxymethyl cellulose (CMC) to obtain the RTU fire retardant RTU TT+CMC. The final amounts of each ingredient in percent by weight for RTU TT+CMC are shown in Table 29, along with a viscosity value, a density, a refractive index, and a pH value.

TABLE 29

| Component | LTFR Conc TT | RTU TT | RTU TT + CMC |
|---|---|---|---|
| APP | 92.42% | 10.00% | 9.950% |
| Xanthan Gum | 3.882% | 0.420% | 0.418% |
| Pigment | 2.773% | 0.300% | 0.299% |
| Anti-foam | 0.462% | 0.050% | 0.050% |
| DSM | 0.185% | 0.020% | 0.020% |
| BTA | 0.277% | 0.030% | 0.030% |
| CMC | 0% | 0% | 0.498% |
| Water | 0% | 89.18% | 88.74% |
| Total | 100.0% | 100% | 100% |
| MDF | | 9.24 | |
| Viscosity (cP) | | 500 | 1058 |
| Density (g/mL) | | 1.042 | 1.0427 |
| Refractive Index | | 6.00% | 7.10% |
| (% Brix) | | | |
| pH | | 5.57 | 5.55 |

The results in Table 29 show the effects on the viscosity, density, refractive index, and pH of RTU TT by adding the specified amounts of carboxymethyl cellulose (CMC).

### Example 2: Preparation of RTU Fire Retardants Using Mass Dilution Factors and Mix Ratios

### Example 2A

LTFR Concentrate D was prepared by adding the ingredients in the amounts listed in Table 13A below. High Viscosity RTU Fire Retardant D (HV RTU D) and medium viscosity RTU Fire Retardant D (MV RTU D) were then prepared by adding water in the amounts listed in Table 13A using the mass dilution factors (MDF) and the mix ratios listed in Table 13B.

TABLE 13A

| Component | LTFR Conc D | HV RTU D | MV RTU D |
|---|---|---|---|
| MAP | 60.648% | 8.01% | 6.55% |
| DAP | 29.630% | 3.91% | 3.20% |
| Xanthan gum | 4.167% | 0.55% | 0.45% |
| Pigment | 2.778% | 0.37% | 0.30% |
| Flow Agent | 0.926% | 0.12% | 0.10% |
| Anti-foam | 0.926% | 0.12% | 0.10% |
| Iron Oxide | 0.278% | 0.04% | 0.03% |
| Triazole 1 | 0.185% | 0.02% | 0.02% |
| Triazole 2 | 0.185% | 0.02% | 0.02% |
| DSM | 0.278% | 0.04% | 0.03% |
| Dilution Water | 0% | 86.80% | 89.20% |
| Total | 100.0% | 100.0% | 100.0% |

TABLE 13B

| Parameter | HV RTU D | MV RTU D | |
|---|---|---|---|
| Mass Dilution Factor | 7.58 | 9.26 | lbs RTU/lb conc |
| Mix Ratio | 1.27 | 1.01 | lbs conc/gal water |
| N/P | 1.299 | 1.299 | |
| DAP Eq. | 13.10% | 10.72% | |
| Viscosity | 666 | 506 | cP |
| pH | 5.80 | 5.83 | |
| Density | 1.0388 | 1.0457 | g/mL |
| Refractive Index | 12.80 | 10.70 | % Brix |

The results in Table 13B show how using a higher mix ratio and a lower mass dilution factor results in an RTU fire retardant having a higher viscosity.

### Example 2B

LTFR Concentrate E was prepared by adding the ingredients in the amounts listed in Table 14A below. High Viscosity RTU Fire Retardant E (HV RTU E) and medium viscosity RTU Fire Retardant E (MV RTU E) were then prepared by adding water in the amounts listed in Table 14A using the mass dilution factors (MDF) and the mix ratios listed in Table 14B.

TABLE 14A

| Component | LTFR Conc E | HV RTU E | MV RTU E |
|---|---|---|---|
| MAP | 52.995% | 11.50% | 5.75% |
| DAP | 38.710% | 8.40% | 4.20% |
| CMC | 2.765% | 0.600% | 0.300% |
| Pigment | 2.765% | 0.600% | 0.300% |
| Flow Agent | 0.922% | 0.200% | 0.100% |
| Anti-foam | 0.922% | 0.200% | 0.100% |
| Iron Oxide | 0.276% | 0.060% | 0.030% |
| Triazole 1 | 0.184% | 0.040% | 0.020% |
| Triazole 2 | 0.184% | 0.040% | 0.020% |
| DSM | 0.276% | 0.060% | 0.030% |
| Dilution Water | 0% | 78.30% | 89.15% |
| Total | 100.0% | 100.0% | 100.0% |

TABLE 14B

| Parameter | HV RTU E | MV RTU E | |
|---|---|---|---|
| Mass Dilution Factor | 4.61 | 9.22 | lbs RTU/lb conc |
| Mix Ratio | 2.31 | 1.02 | lbs conc/gal water |
| N/P | 1.389 | 1.389 | |
| DAP Eq. | 21.60% | 10.80% | |
| Viscosity | 488.0 | 35.5 | cP |
| pH | 5.89 | 6.01 | |
| Density | 1.114 | 1.0666 | g/mL |
| Refractive Index | 19.70 | 11.90 | % Brix |

The results in Table 14B show how using a higher mix ratio and a lower mass dilution factor results in an RTU fire retardant having a higher viscosity.

### Example 2C

LTFR Concentrate F was prepared by adding the ingredients in the amounts listed in Table 15A below. High Viscosity RTU Fire Retardant F (HV RTU F) and medium viscosity RTU Fire Retardant F (MV RTU F) were then prepared by adding water in the amounts listed in Table 15A using the mass dilution factors (MDF) and the mix ratios listed in Table 15B.

TABLE 15A

| Component | LFTR Conc F | HV RTU F | MV RTU F |
|---|---|---|---|
| MAP | 50.885% | 7.67% | 5.75% |
| DAP | 37.168% | 5.60% | 4.20% |
| Guar Gum | 6.637% | 1.000% | 0.750% |
| Pigment | 2.655% | 0.400% | 0.300% |
| Flow Agent | 0.885% | 0.133% | 0.100% |
| Anti-foam | 0.885% | 0.133% | 0.100% |
| Iron Oxide | 0.265% | 0.040% | 0.030% |
| Triazole 1 | 0.177% | 0.027% | 0.020% |
| Triazole 2 | 0.177% | 0.027% | 0.020% |
| DSM | 0.265% | 0.040% | 0.030% |
| Dilution Water | 0% | 84.93% | 88.70% |
| Total | 100.0% | 100.0% | 100.0% |

TABLE 15B

| Parameter | HV RTU F | MV RTU F | |
|---|---|---|---|
| Mass Dilution Factor | 6.64 | 8.85 | lbs RTU/lb conc |
| Mix Ratio | 1.48 | 1.06 | lbs conc/gal water |
| N/P | 1.389 | 1.389 | |
| DAP Eq. | 14.40% | 10.80% | |
| Viscosity | 2380 | 470 | cP |
| pH | 6.00 | 6.00 | |
| Density | 1.0655 | 1.0561 | g/mL |
| Refractive Index | 15.10 | 11.70 | % Brix |

The results in Table 15B show how using a higher mix ratio and a lower mass dilution factor results in an RTU fire retardant having a higher viscosity.

### Example 2D

LTFR Concentrate G was prepared by adding the ingredients in the amounts listed in Table 16A below. High Viscosity RTU Fire Retardant G (HV RTU G) and medium viscosity RTU Fire Retardant G (MV RTU G) were then prepared by adding water in the amounts listed in Table 16A using the mass dilution factors (MDF) and the mix ratios listed in Table 16B.

TABLE 16A

| Component | LTFR Conc G | HV RTU G | MV RTU G |
|---|---|---|---|
| MAP | 39.182% | 7.84% | 5.65% |
| DAP | 29.473% | 5.89% | 4.25% |
| Urea | 25.659% | 5.132% | 3.70% |
| Xanthan Gum | 2.913% | 0.583% | 0.420% |
| Pigment | 2.080% | 0.416% | 0.300% |
| Anti-foam | 0.347% | 0.069% | 0.050% |
| DSM | 0.208% | 0.042% | 0.030% |
| Benzotriazole | 0.139% | 0.028% | 0.020% |
| Dilution Water | 0% | 80.00% | 85.58% |
| Total | 100.0% | 100.0% | 100.0% |

TABLE 16B

| Parameter | HV RTU G | MV RTU G | |
|---|---|---|---|
| Mass Dilution Factor | 5.00 | 6.93 | lbs RTU/lb conc |
| Mix Ratio | 2.09 | 1.41 | lbs conc/gal water |
| N/P | 1.396 | 1.396 | |
| DAP Eq. | 14.89% | 10.74% | |
| Viscosity | 822 | 448 | cP |
| pH | 6.19 | 6.22 | |
| Density | 1.0684 | 1.0471 | g/mL |
| Refractive Index | 19.7 | 14.5 | % Brix |

The results in Table 16B show how using a higher mix ratio and a lower mass dilution factor results in an RTU fire retardant having a higher viscosity.

### Example 2E

LTFR Concentrate H was prepared by adding the ingredients in the amounts listed in Table 17A below. High Viscosity RTU Fire Retardant H (HV RTU H) and medium viscosity RTU Fire Retardant H (MV RTU H) were then prepared by adding water in the amounts listed in Table 17A using the mass dilution factors (MDF) and the mix ratios listed in Table 17B.

TABLE 17A

| Component | LTFR Conc H | HV RTU H | MV RTU H |
|---|---|---|---|
| MAP | 39.182% | 7.84% | 5.65% |
| DAP | 29.473% | 5.89% | 4.25% |
| Erythritol | 25.659% | 5.132% | 3.70% |
| Xanthan Gum | 2.913% | 0.583% | 0.420% |
| Pigment | 2.080% | 0.416% | 0.300% |
| Anti-foam | 0.347% | 0.069% | 0.050% |
| DSM | 0.208% | 0.042% | 0.030% |
| Benzotriazole | 0.139% | 0.028% | 0.020% |
| Dilution Water | 0% | 80.00% | 85.58% |
| Total | 100.0% | 100.0% | 100.0% |

TABLE 17B

| Parameter | HV RTU H | MV RTU H | |
|---|---|---|---|
| Mass Dilution Factor | 5.00 | 6.93 | lbs RTU/lb conc |
| Mix Ratio | 2.09 | 1.41 | lbs conc/gal water |
| N/P | 1.396 | 1.396 | |
| DAP Eq. | 14.89% | 10.74% | |
| Viscosity | 870 | 478 | cP |
| pH | 6.04 | 6.16 | |
| Density | 1.085 | 1.053 | g/mL |
| Refractive Index | 20.2 | 14.2 | % Brix |

The results in Table 17B show how using a higher mix ratio and a lower mass dilution factor results in an RTU fire retardant having a higher viscosity.

### Example 2F

LTFR Concentrate I was prepared by adding the ingredients in the amounts listed in Table 18A below. High Viscosity RTU Fire Retardant I (HV RTU I) and medium viscosity RTU Fire Retardant I (MV RTU I) were then prepared by adding water in the amounts listed in Table 18A using the mass dilution factors (MDF) and the mix ratios listed in Table 18B.

TABLE 18A

| Component | LTFR Conc I | HV RTU I | MV RTU I |
|---|---|---|---|
| APP | 92.421% | 13.20% | 10.00% |
| Xanthan Gum | 3.88% | 0.55% | 0.42% |
| Pigment | 2.77% | 0.40% | 0.30% |
| Anti-foam | 0.46% | 0.07% | 0.05% |
| BTA | 0.18% | 0.03% | 0.02% |
| DSM | 0.28% | 0.04% | 0.03% |
| Dilution Water | — | 85.71% | 89.18% |
| Total | 100.0% | 100.0% | 100.0% |

TABLE 18B

| Parameter | HV RTU I | MV RTU I | |
|---|---|---|---|
| Mass Dilution Factor | 7.00 | 9.24 | lbs RTU/lb conc |
| Mix Ratio | 1.39 | 1.01 | lbs conc/gal water |
| Viscosity | 838 | 478 | cP |
| pH | 5.49 | 5.57 | |
| Density | 1.0336 | 1.042 | g/mL |
| Refractive Index | 6.8 | 6.0 | % Brix |

The results in Table 18B show how using a higher mix ratio and a lower mass dilution factor results in an RTU fire retardant having a higher viscosity.

### Example 2G

LTFR Concentrate J was prepared by adding the ingredients in the amounts listed in Table 19A below. High Viscosity RTU Fire Retardant J (HV RTU J) and medium viscosity RTU Fire Retardant J (MV RTU J) were then prepared by adding water in the amounts listed in Table 19A using the mass dilution factors (MDF) and the mix ratios listed in Table 19B.

TABLE 19A

| Component | LTFR Conc J | HV RTU J | MV RTU J |
|---|---|---|---|
| MgO | 92.421% | 11.55% | 10.00% |
| Xanthan Gum | 3.88% | 0.49% | 0.42% |
| Pigment | 2.77% | 0.35% | 0.30% |
| Anti-foam | 0.46% | 0.06% | 0.05% |
| BTA | 0.18% | 0.02% | 0.02% |
| DSM | 0.28% | 0.03% | 0.03% |
| Dilution Water | — | 87.50% | 89.18% |
| Total | 100.0% | 100.0% | 100.0% |

TABLE 19B

| Parameter | HV RTU J | MV RTU J | |
|---|---|---|---|
| Mass Dilution Factor | 8.00 | 9.24 | lbs RTU/lb conc |
| Mix Ratio | 1.19 | 1.01 | lbs conc/gal water |

### Example 2H

LTFR Concentrate K was prepared by adding the ingredients in the amounts listed in Table 20A below. High Viscosity RTU Fire Retardant K (HV RTU K) and medium viscosity RTU Fire Retardant K (MV RTU K) was then prepared by adding water in the amounts listed in Table 20A using the mass dilution factors (MDF) and the mix ratios listed in Table 20B.

TABLE 20A

| | LTFR | HV | MV |
|---|---|---|---|
| Component | Conc K | RTU K | RTU K |
| CaCl2 | 95.087% | 12.68% | 12.00% |
| Xanthan Gum | 3.33% | 0.44% | 0.42% |
| Dye | 0.79% | 0.11% | 0.10% |
| Anti-foam | 0.40% | 0.05% | 0.05% |
| BTA | 0.16% | 0.02% | 0.02% |
| DSM | 0.24% | 0.03% | 0.03% |
| Dilution Water | — | 86.67% | 87.38% |
| Total | 100.0% | 100.0% | 100.0% |

TABLE 20B

| | HV | MV | |
|---|---|---|---|
| Parameter | RTU K | RTU K | |
| Mass Dilution Factor | 7.50 | 7.92 | lbs RTU/lb conc |
| Mix Ratio | 1.28 | 1.21 | lbs conc/gal water |
| Viscosity | 560 | 472 | cP |
| pH | 6.79 | 6.03 | |
| Density | 14.7 | 1.0645 | g/mL |
| Refractive Index | 14.7 | 14.2 | % Brix |

The results in Table 20B show how using a higher mix ratio and a lower mass dilution factor results in an RTU fire retardant having a higher viscosity.

### Example 2I

LTFR Concentrate L was prepared by adding the ingredients in the amounts listed in Table 21A below. High Viscosity RTU Fire Retardant L (HV RTU L) and medium viscosity RTU Fire Retardant L (MV RTU L) was then prepared by adding water in the amounts listed in Table 21A using the mass dilution factors (MDF) and the mix ratios listed in Table 21B.

TABLE 21A

| | LTFR | HV | MV |
|---|---|---|---|
| Component | Conc L | RTU L | RTU L |
| NaHCO3 | 93.063% | 12.41% | 11.00% |
| Xanthan Gum | 3.55% | 0.47% | 0.42% |
| Pigment | 2.54% | 0.34% | 0.30% |
| Anti-foam | 0.42% | 0.06% | 0.05% |
| BTA | 0.17% | 0.02% | 0.02% |
| DSM | 0.25% | 0.03% | 0.03% |
| Dilution Water | — | 86.67% | 88.18% |
| Total | 100.0% | 100.0% | 100.0% |

TABLE 21B

| | HV | MV | |
|---|---|---|---|
| Parameter | RTU L | RTU L | |
| Mass Dilution Factor | 7.50 | 8.46 | lbs RTU/lb conc |
| Mix Ratio | 1.28 | 1.12 | lbs conc/gal water |
| Viscosity | 480 | 259 | cP |
| pH | 7.78 | 7.81 | |
| Density | 1.078 | 1.078 | g/mL |
| Refractive Index | 8.2 | 7.9 | % Brix |

The results in Table 21B show how using a higher mix ratio and a lower mass dilution factor results in an RTU fire retardant having a higher viscosity.

### Example 2J

LTFR Concentrate M was prepared by adding the ingredients in the amounts listed in Table 22A below. High Viscosity RTU Fire Retardant M (HV RTU M) and medium viscosity RTU Fire Retardant M (MV RTU M) was then prepared by adding water in the amounts listed in Table 22A using the mass dilution factors (MDF) and the mix ratios listed in Table 22B.

TABLE 22A

| | LTFR | HV | MV |
|---|---|---|---|
| Component | Conc M | RTU M | RTU M |
| Magnesium Sulfate Heptahydrate | 96.484% | 32.16% | 22.50% |
| Xanthan Gum | 1.80% | 0.60% | 0.42% |
| Pigment | 1.29% | 0.43% | 0.30% |
| Anti-foam | 0.21% | 0.07% | 0.05% |
| BTA | 0.09% | 0.03% | 0.02% |
| DSM | 0.13% | 0.04% | 0.03% |
| Dilution Water | — | 66.67% | 76.68% |
| Total | 100.0% | 100.0% | 100.0% |

TABLE 22B

| | HV | MV | |
|---|---|---|---|
| Parameter | RTU M | RTU M | |
| Mass Dilution Factor | 3.00 | 4.29 | lbs RTU/lb conc |
| Mix Ratio | 4.17 | 2.54 | lbs conc/gal water |
| Viscosity | 1132 | 582 | cP |
| pH | 6.08 | 6.45 | |
| Density | 1.1132 | 1.1138 | g/mL |
| Refractive Index | 21.4 | 15.1 | % Brix |

The results in Table 22B show how using a higher mix ratio and a lower mass dilution factor results in an RTU fire retardant having a higher viscosity.

### Example 2K

LTFR Concentrate VV was prepared by adding the ingredients in the amounts listed in Table 30A below. High Viscosity RTU Fire Retardant VV (HV RTU VV) and medium viscosity RTU Fire Retardant VV (MV RTU VV) were then prepared by adding water in the amounts listed in Table 30A using the mass dilution factors (MDF) and the mix ratios listed in Table 30B.

TABLE 30A

| | LTFR | HV | MV |
|---|---|---|---|
| Component | Conc VV | RTU VV | RTU VV |
| Potassium Citrate | 93.023% | 13.29% | 10.00% |
| Xanthan Gum | 3.26% | 0.47% | 0.35% |
| Pigment | 2.79% | 0.40% | 0.30% |
| Anti-foam | 0.47% | 0.07% | 0.05% |
| BTA | 0.19% | 0.03% | 0.02% |
| DSM | 0.28% | 0.04% | 0.03% |
| Dilution Water | 0% | 85.71% | 89.25% |
| Total | 100.0% | 100.0% | 100.0% |

TABLE 30B

| | HV | MV | |
|---|---|---|---|
| Parameter | RTU VV | RTU VV | |
| Mass Dilution Factor | 7.00 | 9.30 | lbs RTU/lb conc |
| Mix Ratio | 1.39 | 1.01 | lbs conc/gal water |
| Viscosity | 616 | 332 | cP |
| pH | 8.08 | 8.34 | |
| Density | 1.0786 | 1.0646 | g/mL |
| Refractive Index | 13.4% | 10.1% | % Brix |

The results in Table 30B show how using a higher mix ratio and a lower mass dilution factor results in an RTU fire retardant having a higher viscosity.

### Example 3: Preparation of RTU Fire Retardants From a Liquid Concentrate Using Mass Dilution Factors and Mix Ratios

### Example 3A

Liquid LTFR Concentrate N was prepared by adding the ingredients in the amounts listed in Table 23A below. RTU Fire Retardants were then prepared from LTFR Concentrate N by adding water and using four different dilution factors (DF) (RTU DF 2, RTU DF 3, RTU DF 3.5, and RTU DF 4) as listed in Table 23B. The amounts of the ingredients in each RTU fire retardant are listed in Table 23A.

TABLE 23A

| | Liquid | | | | |
|---|---|---|---|---|---|
| | LTFR | RTU | RTU | RTU | RTU |
| Component | Conc N | DF 2 | DF 3 | DF 3.5 | DF 4 |
| MAP | 15.750% | 7.88% | 5.25% | 4.50% | 3.94% |
| DAP | 19.18% | 9.59% | 6.39% | 5.48% | 4.80% |
| Xanthan | 1.05% | 0.53% | 0.35% | 0.30% | 0.26% |
| Gum | | | | | |
| Bentonite | 2.45% | 1.23% | 0.82% | 0.70% | 0.61% |
| Clay | | | | | |
| Pigment | 1.05% | 0.53% | 0.35% | 0.30% | 0.26% |
| TTA | 0.03% | 0.02% | 0.01% | 0.01% | 0.01% |
| BTA | 0.03% | 0.02% | 0.01% | 0.01% | 0.01% |
| DSM | 0.35% | 0.18% | 0.12% | 0.10% | 0.09% |
| Defoamer | 0.03% | 0.02% | 0.01% | 0.01% | 0.01% |
| Conc. Water | 60.08% | 20.03% | 20.03% | 17.17% | 15.02% |
| Dilution | — | 60.01% | 66.67% | 71.43% | 75.00% |
| Water | | | | | |
| Total | 100.0% | 100.0% | 100.0% | 100.0% | 100.0% |

TABLE 23B

| Parameter | Concentrate | DF 2 | DF 3 | DF 3.5 | DF4 | |
|---|---|---|---|---|---|---|
| Mass Dilution | N/A | 2.00 | 3.00 | 3.50 | 4.00 | lbs RTU/lb |
| Factor | | | | | | conc |
| Mix Ratio | N/A | 8.35 | 4.17 | 3.34 | 2.78 | lbs conc/gal |
| | | | | | | water |
| Volume Dilution | N/A | 2.2 | 3.4 | 4.0 | 4.6 | gal RTU/gal |
| Factor | | | | | | Conc |
| Viscosity | 24 | 732 | 351 | 252 | 197 | cP |
| pH | 6.18 | 6.20 | 6.23 | 6.27 | 6.29 | |
| Density | 1.19 | 1.0857 | 1.0576 | 1.0544 | 1.04 | g/mL |
| Refractive Index | 37.0 | 19.3 | 13.7 | 11.5 | 10.3 | % Brix |

The results in Table 23B show how using a lower dilution factor results in an RTU fire retardant having a higher viscosity.

### Example 4: Preparation of RTU Fire Retardants from a LTRF Concentrates Using Different Mass Dilution Factors and Mix Ratios

LTFR Concentrates were prepared by adding the ingredients in the amounts listed in Tables 24A and 24B below. Corresponding RTU Fire Retardants were then prepared by adding water in the respective amounts listed in Tables 24A and 24B using the respective mass dilution factors (MDF) and the mix ratios listed in Tables 24C and 24D.

TABLE 24A

| | LTFR | | LTFR | | LTFR | |
|---|---|---|---|---|---|---|
| Component | Conc P | RTU P | Conc Q | RTU Q | Conc R | RTU R |
| MAP | 32.288% | 3.50% | 43.471% | 4.71% | 60.119% | 6.52% |
| DAP | 61.993% | 6.72% | 49.396% | 5.35% | 30.287% | 3.28% |
| Xanthan Gum | 3.690% | 0.40% | 3.690% | 0.40% | 3.690% | 0.40% |
| Dye | 1.107% | 0.12% | 1.107% | 0.12% | 1.107% | 0.12% |
| Anti-Foam | 0.461% | 0.05% | 0.461% | 0.05% | 0.461% | 0.05% |
| Tolyltriazole | 0.185% | 0.02% | 0.185% | 0.02% | 0.185% | 0.02% |
| Disodium Molybate | 0.277% | 0.03% | 0.277% | 0.03% | 0.277% | 0.03% |
| Water | 0% | 89.160% | 0% | 89.313% | 0% | 89.580% |
| Total | 100.0% | 100.0% | 98.6% | 100.0% | 96.1% | 100.0% |

TABLE 24B

| | LTFR | | LTFR | |
|---|---|---|---|---|
| Component | Conc S | RTU S | Conc T | RTU T |
| MAP | 69.367% | 7.52% | 78.621% | 8.52% |
| DAP | 19.712% | 2.14% | 9.053% | 0.98% |
| Xanthan Gum | 3.690% | 0.40% | 3.690% | 0.40% |
| Dye | 1.107% | 0.12% | 1.107% | 0.12% |
| Anti-Foam | 0.461% | 0.05% | 0.461% | 0.05% |
| Tolyltriazole | 0.185% | 0.02% | 0.185% | 0.02% |
| Disodium Molybate | 0.277% | 0.03% | 0.277% | 0.03% |
| Water | 0% | 89.724% | 0% | 89.876% |
| Total | 94.8% | 100.0% | 93.4% | 100.0% |

TABLE 24C

| | LTFR | | LTFR | | LTFR | |
|---|---|---|---|---|---|---|
| Parameter | Conc P | RTU P | Conc Q | RTU Q | Conc R | RTU R |
| MDF | 9.23 | | 9.36 | | 9.60 | |
| (lbs RTU/lb conc) | | | | | | |
| MR | 1.01 | | 1.00 | | 0.97 | |
| (lbs conc/gal water) | | | | | | |
| N/P | 1.626 | | 1.497 | | 1.305 | |
| DAP Eq. | 10.74% | | 10.76% | | 10.76% | |
| Viscosity (cP) | | 418 | | 424 | | 432 |
| pH | | 6.7 | | 6.31 | | 5.98 |
| Density (g/mL) | | 1.0525 | | 1.0465 | | 1.0416 |
| Refractive Index | | 1230.0% | | 11.6% | | 10.6% |
| (% Brix) | | | | | | |

TABLE 24D

| | LTFR | | LTFR | |
|---|---|---|---|---|
| Parameter | Conc S | RTU S | Conc T | RTU T |
| MDF (lbs RTU/lb conc) | 9.73 | | 9.88 | |
| MR (lbs conc/gal water) | 0.96 | | 0.94 | |
| N/P | 1.198 | | 1.091 | |
| DAP Eq. | 10.77% | | 10.77% | |
| Viscosity (cP) | | 422 | | 418 |
| pH | | 5.66 | | 6.7 |
| Density (g/mL) | | 1.0427 | | 1.0525 |
| Refractive Index (% Brix) | | 10.1% | | 1230.0% |

### Example 5: Preparation of Additional RTU Fire Retardants from a LTRF Concentrates Using Different Mass Dilution Factors and Mix Ratios

LTFR Concentrates were prepared by adding the ingredients in the amounts listed in Table 25A below. Corresponding RTU Fire Retardants were then prepared by adding water in the respective amounts listed in Table 25B using the respective mass dilution factors (MDF) and the mix ratios listed in Table 25B.

TABLE 25A

| | LTFR | LTFR | LTFR | LTFR | LTFR | LTFR |
|---|---|---|---|---|---|---|
| | Conc | Conc | Conc | Conc | Conc | Conc |
| Sample | AA | BB | CC | DD | EE | FF |
| MAP | 39.50% | 51.25% | 53.91% | 48.52% | 54.07% | 40.62% |
| DAP | 45.41% | 38.37% | 40.36% | 36.49% | 40.67% | 30.55% |
| Pigment | 4.32% | 2.72% | | 2.60% | | 2.16% |
| Iron Oxide | | 0.27% | | | | |
| Anti-foam | 0.55% | 0.91% | 0.95% | 0.47% | | |
| AMO | | 0.18% | | | | |
| BTA | | | | | 0.19% | 0.04% |
| TTA | 0.54% | 0.18% | 0.19% | 0.19% | | 0.04% |
| DSM | 1.11% | | 0.29% | 0.30% | 0.29% | 0.72% |
| STS | | | | | | 4.31% |
| CMC | 8.57% | | | | | |
| Guar Gum | | 6.12% | | | | |
| Carboxymethyl Guar | | | 4.29% | | | |
| Gum | | | | | | |
| Locust Bean Gum | | | | 11.43% | | |
| Tara Gum | | | | | 4.78% | |
| PVP | | | | | | 21.57% |
| Water | 0% | 0% | 0% | 0% | 0% | 0% |
| Total | 100.0% | 100.0% | 100.0% | 100.0% | 100.0% | 100.0% |

TABLE 25B

| | LTFR | LTFR | LTFR | LTFR | LTFR | LTFR |
|---|---|---|---|---|---|---|
| | Conc | Conc | Conc | Conc | Conc | Conc |
| Sample | AA | BB | CC | DD | EE | FF |
| MAP | 4.61% | 5.65% | 5.65% | 5.60% | 5.65% | 5.65% |
| DAP | 5.30% | 4.23% | 4.23% | 4.22% | 4.25% | 4.25% |
| Pigment | 0.50% | 0.30% | | 0.30% | | 0.30% |
| Iron Oxide | | 0.03% | | | | |
| Anti-foam | 0.06% | 0.10% | 0.10% | 0.05% | | |
| AMO | | 0.02% | | | | |
| BTA | | | | | 0.020% | 0.005% |
| TTA | 0.063% | 0.020% | 0.020% | 0.022% | | 0.005% |
| DSM | 0.13% | | 0.03% | 0.03% | 0.03% | 0.10% |
| STS | | | | | | 0.60% |
| CMC | 1.00% | | | | | |
| Guar Gum | | 0.68% | | | | |
| Carboxymethyl | | | 0.45% | | | |
| Guar Gum | | | | | | |
| Locust Bean | | | | 1.32% | | |
| Gum | | | | | | |
| Tara Gum | | | | | 0.50% | |
| PVP | | | | | | 3.00% |
| Water | 88.33% | 88.98% | 89.52% | 88.45% | 89.55% | 86.09% |
| Total | 100.0% | 100.0% | 100.0% | 100.0% | 100.0% | 100.0% |
| Mass Dilution | 8.57 | 9.07 | 9.54 | 8.66 | 9.57 | 7.19 |
| Factor | | | | | | |
| (lbs RTU/lb | | | | | | |
| conc) | | | | | | |
| Mix Ratio | 1.10 | 1.03 | 0.98 | 1.09 | 0.97 | 1.35 |
| (lbs conc/gal | | | | | | |
| water) | | | | | | |
| N/P | 1.50 | 1.39 | 1.39 | 1.40 | 1.40 | 1.40 |
| DAP Eq. | 10.59% | 10.72% | 10.72% | 10.65% | 10.74% | 10.74% |
| Viscosity (cP) | | 830 | 316 | 1620 | 384 | 200 |
| pH | | 6.03 | 6.01 | | | 6.23 |
| Density (g/mL) | | 1.0589 | 1.0577 | | | |
| Refractive | | 10.5 | 11.1 | | | 14.8 |
| Index | | | | | | |
| (% Brix) | | | | | | |

### Example 6: Preparation of Additional RTU Fire Retardants from a LTRF Concentrates Using Different Mass Dilution Factors and Mix Ratios

LTFR Concentrates were prepared by adding the ingredients in the amounts listed in Tables 26A and 26B below. Corresponding RTU Fire Retardants were then prepared by adding water in the respective amounts listed in Tables 26C and 26D using the respective mass dilution factors (MDF) and the mix ratios listed in Tables 26C and 26D.

TABLE 26A

| | LTFR | LTFR | LTFR | LTFR | LTFR |
|---|---|---|---|---|---|
| Sample | Conc GG | Conc HH | Conc II | Conc JJ | Conc KK |
| MAP | 49.60% | 49.60% | 51.41% | 49.60% | 50.72% |
| DAP | 37.31% | 37.31% | 38.67% | 37.31% | 38.15% |
| Pigment | 2.63% | 2.63% | 2.73% | 2.63% | 2.69% |
| BTA | 0.18% | 0.18% | 0.18% | 0.18% | 0.18% |
| TTA | 0.18% | 0.18% | 0.18% | 0.18% | 0.18% |
| DSM | 0.44% | 0.44% | 0.45% | 0.44% | 0.45% |
| HPGG | 5.27% | 5.27% | 5.46% | 5.27% | 5.39% |
| Xanthan Gum | | | | | |
| Anti-Foam | | | | | |
| Methyl diethanolamine | 4.39% | | | | |
| Zn-Sulfate heptahydrate | | 4.39% | | | |
| Potassium Sorbate | | | 0.91% | | |
| sodium benzoate | | | | 4.39% | |
| Phenoxy Ethanol | | | | | |
| TEA | | | | | |
| MgO | | | | | |
| EDTA | | | | | |
| Tris | | | | | |
| SDBS | | | | | 2.24% |
| Water | 0% | 0% | 0% | 0% | 0% |
| Total | 100.0% | 100.0% | 100.0% | 100.0% | 100.0% |

TABLE 26B

| | LTFR | LTFR | LTFR | LTFR | LTFR |
|---|---|---|---|---|---|
| Sample | Conc LL | Conc MM | Conc NN | Conc PP | Conc QQ |
| MAP | 49.82% | 60.07% | 48.18% | 52.80% | 58.93% |
| DAP | 37.48% | 28.68% | 23.07% | 25.28% | 28.21% |
| Pigment | 2.65% | 2.62% | 2.19% | 2.40% | 2.68% |
| BTA | 0.04% | 0.04% | 0.04% | 0.04% | 0.04% |
| TTA | 0.04% | 0.04% | 0.04% | 0.04% | 0.04% |
| DSM | 0.88% | 0.87% | 0.73% | 0.80% | 0.89% |
| HPGG | | | | | |
| Xanthan Gum | 4.41% | 4.36% | 3.65% | 4.00% | 4.46% |
| Anti-Foam | 0.26% | 0.26% | 0.22% | 0.24% | 0.27% |
| Methyl diethanolamine | | | | | |
| Zn-Sulfate heptahydrate | | | | | |
| Potassium Sorbate | | | | | |
| sodium benzoate | | | | | |
| Phenoxy Ethanol | | | | | 4.46% |
| TEA | 4.41% | | | | |
| MgO | | 3.05% | | | |
| EDTA | | | 21.90% | | |
| Tris | | | | 14.40% | |
| SDBS | | | | | |
| Water | 0% | 0% | 0% | 0% | 0% |
| Total | 100.0% | 100.0% | 100.0% | 100.0% | 100.0% |

TABLE 26C

| | LTFR | LTFR | LTFR | LTFR | LTFR |
|---|---|---|---|---|---|
| Sample | Conc GG | Conc HH | Conc II | Conc JJ | Conc KK |
| MAP | 5.65% | 5.65% | 5.65% | 5.65% | 5.65% |
| DAP | 4.25% | 4.25% | 4.25% | 4.25% | 4.25% |
| Pigment | 0.30% | 0.30% | 0.30% | 0.30% | 0.30% |
| BTA | 0.02% | 0.02% | 0.02% | 0.02% | 0.02% |
| TTA | 0.02% | 0.02% | 0.02% | 0.02% | 0.02% |
| DSM | 0.05% | 0.05% | 0.05% | 0.05% | 0.05% |
| HPGG | 0.60% | 0.60% | 0.60% | 0.60% | 0.60% |
| Xanthan Gum | 0.00% | 0.00% | 0.00% | 0.00% | 0.00% |
| Anti-Foam | 0.00% | 0.00% | 0.00% | 0.00% | 0.00% |
| Methyl diethanolamine | 0.50% | | | | |
| Zn-Sulfate heptahydrate | | 0.50% | | | |
| Potassium Sorbate | | | 0.10% | | |
| sodium benzoate | | | | 0.50% | |
| Phenoxy Ethanol | | | | | |
| TEA | | | | | |
| MgO | | | | | |
| EDTA | | | | | |
| Tris | | | | | |
| SDBS | | | | | 0.25% |
| Water | 88.61% | 88.61% | 89.01% | 88.61% | 88.86% |
| Total | 100.0% | 100.0% | 100.0% | 100.0% | 100.0% |
| Mass Dilution Factor | 8.78 | 8.78 | 9.10 | 8.78 | 8.98 |
| (lbs RTU/lb conc) | | | | | |
| Mix Ratio | 1.07 | 1.07 | 1.03 | 1.07 | 1.05 |
| (lbs conc/gal water) | | | | | |
| N/P | 1.40 | 1.40 | 1.40 | 1.40 | 1.40 |
| DAP Eq. | 10.74% | 10.74% | 10.74% | 10.74% | 10.74% |
| Viscosity (cP) | 288 | 288 | 288 | 288 | 582 |
| pH | 6.36 | 5.95 | 6.13 | 6.12 | 6.20 |
| Density (g/mL) | 1.06 | 1.06 | 1.06 | 1.06 | 1.06 |

| | |
|---|---|
| Refractive Index (% Brix) | 11.0 |

TABLE 26D

| | LTFR | LTFR | LTFR | LTFR | LTFR |
|---|---|---|---|---|---|
| Sample | Conc LL | Conc MM | Conc NN | Conc PP | Conc QQ |
| MAP | 5.65% | 6.89% | 6.60% | 6.60% | 6.60% |
| DAP | 4.25% | 3.29% | 3.16% | 3.16% | 3.16% |
| Pigment | 0.30% | 0.30% | 0.30% | 0.30% | 0.30% |
| BTA | 0.01% | 0.01% | 0.01% | 0.01% | 0.01% |
| TTA | 0.01% | 0.01% | 0.01% | 0.01% | 0.01% |
| DSM | 0.10% | 0.10% | 0.10% | 0.10% | 0.10% |
| HPGG | 0.00% | 0.00% | 0.00% | 0.00% | 0.00% |
| Xanthan Gum | 0.50% | 0.50% | 0.50% | 0.50% | 0.50% |
| Anti-Foam | 0.03% | 0.03% | 0.03% | 0.03% | 0.03% |
| Methyl diethanolamine | | | | | |
| Zn-Sulfate heptahydrate | | | | | |
| Potassium Sorbate | | | | | |
| sodium benzoate | | | | | |
| Phenoxy Ethanol | | | | | 0.50% |
| TEA | 0.50% | | | | |
| MgO | | 0.35% | | | |
| EDTA | | | 3.00% | | |
| Tris | | | | 1.80% | |
| SDBS | | | | | |
| Water | 88.66% | 88.53% | 86.30% | 87.50% | 88.80% |
| Total | 100.0% | 100.0% | 100.0% | 100.0% | 100.0% |
| Mass Dilution Factor | 8.82 | 8.72 | 7.30 | 8.00 | 8.93 |
| (lbs RTU/lb conc) | | | | | |
| Mix Ratio | 1.07 | 1.08 | 1.32 | 1.19 | 1.05 |
| (lbs conc/gal water) | | | | | |
| N/P | 1.40 | 1.29 | 1.29 | 1.29 | 1.29 |
| DAP Eq. | 10.74% | 11.20% | 10.74% | 10.74% | 10.74% |
| Viscosity (cP) | 604 | 596 | 612 | 600 | 288 |
| pH | 6.23 | 5.95 | 4.66 | 6.20 | 6.23 |
| Density (g/mL) | | | | | 1.06 |
| Refractive Index | 11.7 | 10.3 | 13.3 | 13.3 | 11.0 |
| (% Brix) | | | | | |

It is to be appreciated that the Detailed Description section, and not the Summary section, is intended to be used to interpret the claims. The Summary section may set forth one or more but not all embodiments of the disclosure as contemplated by the inventor(s), and thus, are not intended to limit the disclosure or the claims in any way.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the claims should not be limited by any of the above-described exemplary embodiments, but should be defined only in accordance with the claims and their equivalents.

1.-16. (canceled)

17. A method of producing a ready-to-use (RTU) fire retardant, the method comprising:
determining, based on a parameter, a target property for the RTU fire retardant;
correlating the target property with a target mix ratio for a long term fire retardant (LTFR) concentrate; and
mixing the LTFR concentrate with water at the target mix ratio to obtain the RTU fire retardant.

18. The method of claim 17, further comprising verifying that the property of the RTU fire retardant is approximately the target property.

19. The method of claim 17, wherein the target property is selected from the group consisting of viscosity, density, refractive index, pH value, color, combustion-retarding effectiveness, salt content, corrosion rate, surface tension, and combinations thereof.

20. The method of claim 19, wherein the target property is viscosity.

21. The method of claim 17, wherein LTFR concentrate comprises:
one or more ammonium phosphates;
a thickener; and
a pigment.

22. The method of claim 21, wherein the LTFR concentrate further comprises one or more corrosion inhibitors, flow agents, anti-foaming agents, wetting agents, stability enhancers, surfactants, stabilizers, anti-spoilage additives, opacifiers, foaming agents, dedusters, biocide, buffers, or a combination thereof.

23. The method of claim 17, wherein the LTFR concentrate comprises:
one or more ammonium phosphates, present in the concentrate in an amount having a weight percent ranging from about 82% to about 95% relative to a total dry weight of the concentrate;
a thickener, present in the concentrate in an amount having a weight percent ranging from about 0.5% to about 15% relative to the total dry weight of the concentrate;
a corrosion inhibitor, present in the concentrate in an amount having a weight percent ranging from about 0.05% to about 5.0% relative to the total dry weight of the concentrate; and
a pigment, present in the concentrate in an amount having a weight percent ranging from about 0.5% to about 3.5% relative to the total dry weight of the concentrate.

24. The method of claim 23, further comprising adding water to the LTFR concentrate to prepare a liquid LTFR concentrate.

25. The method of claim 17, wherein the LTFR concentrate comprises:
one or more ammonium phosphates, present in the concentrate in an amount having a weight percent ranging from about 65% to about 80% relative to a total dry weight of the concentrate;
a thickener, present in the concentrate in an amount having a weight percent ranging from about 0.25% to about 25% relative to the total dry weight of the concentrate;
a corrosion inhibitor, present in the concentrate in an amount having a weight percent ranging from about 0.05% to about 5.0% relative to the total dry weight of the concentrate; and
a pigment, present in the concentrate in an amount having a weight percent ranging from about 0.5% to about 3.5% relative to the total dry weight of the concentrate.

26. The method of claim 25, wherein the LTFR concentrate further comprises an additional material selected from the groups consisting of urea, erythritol, and combinations thereof.

27. The method of claim 17, wherein the LTFR concentrate comprises:
one or more fire retardant salts, present in the concentrate in an amount having a weight percent ranging from about 85% to about 98% relative to a total dry weight of the concentrate;
a thickener, present in the concentrate in an amount having a weight percent ranging from about 0.05% to about 5% relative to the total dry weight of the concentrate;
a corrosion inhibitor, present in the concentrate in an amount having a weight percent ranging from about 0.01% to about 5% relative to the total dry weight of the concentrate; and
a pigment, present in the concentrate in an amount having a weight percent ranging from about 0.5% to about 5.0% relative to the total dry weight of the concentrate.

28. The method of claim 27, wherein the one or more fire retardant salts are selected from the group consisting of magnesium oxide, calcium chloride, a bicarbonate, a magnesium sulfate, a potassium salt, and combinations thereof.

29. The method of claim 17, further comprising adding an additional material to the RTU fire retardant, wherein adding the additional material changes one or more properties of the RTU fire retardant.

30. The method of claim 29, wherein the added material is selected from thickeners, pigments, fire retardant salts, organic materials, and combinations thereof.

31. The method of claim 30, wherein the fire retardant salts comprise ammonium phosphates, the organic materials comprise erythritol, urea, dextrose, or combinations thereof, and the thickeners comprise attapulgite, bentonite, montmorillonite, algin, collagen, casein, albumin, castor oil, cornstarch, arrowroot, yuca starch, colloidal oatmeal, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, casein, cetearyl alcohol, polyethylene glycol (PEG), monoethylene glycol, acrylic microgel, acrylic amide wax, polyvinyl pyrrolidone, polyvinyl acetate, polyvinyl alcohol, polyacrylic acid, alkali swellable emulsion thickeners (ASE), hydrophobically modified alkali swellable emulsion thickeners (HASE), or a combination thereof.

32. The method of claim 29, wherein the one or more properties are selected from the group consisting of viscosity, density, refractive index, pH value, color, combustion-retarding effectiveness, salt content, corrosion rate, surface tension, and combinations thereof.

33. The method of claim 32, wherein the property is viscosity.

34. A method of producing a ready-to-use (RTU) fire retardant, the method comprising:
determining, based on a parameter, a target property for the RTU fire retardant; and
adding an additional material to a first RTU fire retardant to prepare the RTU fire retardant;
wherein adding the additional material changes one or more properties of the first RTU fire retardant.

35. The method of claim 34, further comprising verifying that the property of the RTU fire retardant is approximately the target property.

36. The method of claim 34, wherein the additional material is added to the first RTU fire retardant to prepare the RTU fire retardant and then the RTU fire retardant is loaded into an aircraft, or wherein the additional material is added to the first RTU fire retardant to prepare the RTU fire retardant while the RTU fire retardant is loaded into an aircraft.

37. The method of claim 34, wherein the added material is selected from thickeners, pigments, fire retardant salts, organic materials, or combinations thereof.

38. The method of claim 37, wherein the fire retardant salts comprise ammonium phosphates, the organic materials comprise erythritol, urea, dextrose, or combinations thereof, and the thickeners comprise attapulgite, bentonite, montmorillonite, algin, collagen, casein, albumin, castor oil, cornstarch, arrowroot, yuca starch, colloidal oatmeal, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, casein, cetearyl alcohol, polyethylene glycol (PEG), monoethylene glycol, acrylic microgel, acrylic amide wax, polyvinyl pyrrolidone, polyvinyl acetate, polyvinyl alcohol, polyacrylic acid, alkali swellable emulsion thickeners (ASE), hydrophobically modified alkali swellable emulsion thickeners (HASE), or combinations thereof.

39. The method of claim 34, wherein the one or more properties are selected from the group consisting of viscosity, density, refractive index, pH value, color, combustion-retarding effectiveness, salt content, corrosion rate, surface tension, and combinations thereof.

40. The method of claim 39, wherein the property is viscosity.

41. The method of claim 17, wherein:
the parameter comprises a fire parameter, a weather parameter, an aircraft parameter, a drop pattern parameter, a local environment parameter, a human feedback parameter, or combinations thereof;
the fire parameter comprises an intensity, a direction of spread, a growth rate, a size of the fire, or combinations thereof;
the weather parameter comprises a wind direction, a wind speed, a precipitation, a humidity, a fire weather index, a cloud coverage, a dew point, an ambient temperature at a site of the fire, a forecast, or combinations thereof;
the aircraft parameter comprises an aircraft type, an altitude, an aircraft speed that the RTU fire retardant is to be applied from, or combinations thereof;
the drop pattern parameter comprises a desired amount of the RTU fire retardant, a desired coverage level of the RTU fire retardant, or combinations thereof;
the local environment parameter comprises fuel moisture content, terrain, brush, foliage data, and combinations thereof, and
the human feedback parameter comprises feedback from an air attack, feedback from an incident command, feedback from observers, feedback from a pilot, feedback from a computer program or an algorithm, feedback from a radio operator, or combinations thereof.

42. A method of producing a first RTU fire retardant and a second RTU fire retardant, the method comprising:
mixing a first predetermined amount of an LTFR concentrate with a first predetermined amount of water at a first mix ratio to produce the first RTU fire retardant, wherein the first RTU fire retardant comprises a first property, and
mixing a second predetermined amount of the LTFR concentrate with a second predetermined amount of water at a second mix ratio to produce the second RTU fire retardant, wherein the second RTU fire retardant comprises a second property.

43. The method of claim 42, wherein the first mix ratio is less than the second mix ratio.

44. The method of claim 42, wherein the property is selected from the group consisting of viscosity, density, refractive index, pH value, color, combustion-retarding effectiveness, salt content, corrosion rate, surface tension, and combinations thereof.

45. The method of claim 42, wherein the first property is a first viscosity and the second property is a second viscosity, and wherein the first viscosity is lower than the second viscosity.

46. The method of claim 42, wherein the LTFR concentrate comprises:
one or more ammonium phosphates, present in the concentrate in an amount having a weight percent ranging from about 82% to about 95% relative to a total dry weight of the concentrate;
a thickener, present in the concentrate in an amount having a weight percent ranging from about 0.5% to about 15% relative to the total dry weight of the concentrate;
a corrosion inhibitor, present in the concentrate in an amount having a weight percent ranging from about 0.05% to about 5.0% relative to the total dry weight of the concentrate; and
a pigment, present in the concentrate in an amount having a weight percent ranging from about 0.5% to about 3.5% relative to the total dry weight of the concentrate.
